(19) United States
(12) Patent Application Publication
(10) Pub. No.: US 2025/0240460 A1
(43) Pub. Date: Jul. 24, 2025

(54) METHODS AND DEVICES FOR ADAPTIVE LOOP FILTER

(71) Applicant: BEIJING DAJIA INTERNET INFORMATION TECHNOLOGY CO., LTD., Beijing (CN)

(72) Inventors: Changyue MA, San Diego, CA (US); Xiaoyu XIU, San Diego, CA (US); Che-Wei KUO, San Diego, CA (US); Wei CHEN, San Diego, CA (US); Hong-Jheng JHU, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/056,074

(22) Filed: Feb. 18, 2025

Related U.S. Application Data
(63) Continuation of application No. PCT/US2023/030510, filed on Aug. 17, 2023.
(63) Continuation of application No. PCT/US2023/034318, filed on Oct. 2, 2023.
(63) Continuation of application No. PCT/US2024/020003, filed on Mar. 14, 2024.
(60) Provisional application No. 63/399,213, filed on Aug. 18, 2022.
(60) Provisional application No. 63/412,345, filed on Sep. 30, 2022.
(60) Provisional application No. 63/452,158, filed on Mar. 14, 2023.

(51) Int. Cl. H04N 19/82; H04N 19/117; H04N 19/132; H04N 19/159; H04N 19/176; H04N 19/186; H04N 19/46; H04N 19/86

(52) U.S. Cl. CPC H04N 19/82; H04N 19/117; H04N 19/132; H04N 19/159; H04N 19/176; H04N 19/186; H04N 19/46; H04N 19/86

(57) ABSTRACT

Methods for video decoding and encoding, apparatuses and non-transitory computer-readable storage media thereof are provided. In one method for video decoding, a decoder may obtain one or more spatial neighboring samples associated with a current sample. Furthermore, the decoder may obtain a filtered sample for the current sample based on the one or more spatial neighboring samples.

### CROSS-REFERENCE TO RELATED APPLICATION

The present application is based upon and claims priority to International Application No. PCT/US2023/030510, filed on Aug. 17, 2023, which claims priority to U.S. Provisional Application No. 63/399,213 filed on Aug. 18, 2022, and to International Application No. PCT/US2023/034318, filed on Oct. 2, 2023, which claims priority to U.S. Provisional Application No. 63/412,345 filed on Sep. 30, 2022 and to International Application No. PCT/US2024/020003, filed on Mar. 14, 2024, which claims priority to Provisional Application No. 63/452,158 filed on Mar. 14, 2023, all disclosures of which are incorporated herein by reference in their entireties for all purposes.

### FIELD

The present disclosure is related to video coding and compression, and in particular but not limited to, methods and apparatus on improving the coding efficiency of adaptive loop filter (ALF).

### BACKGROUND

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part2) and Advanced Video Coding (AVC, also known as H.264 or MPEG-4 Part 10), which are jointly developed by ISO/IEC MPEG and ITU-T VCEG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

### SUMMARY

The present disclosure provides examples of techniques relating to improving the coding efficiency of ALF.

According to a first aspect of the present disclosure, there is provided a method for video decoding. In the method, a decoder may obtain one or more spatial neighboring samples associated with a current sample. Furthermore, the decoder may obtain a filtered sample for the current sample based on the one or more spatial neighboring samples.

According to a second aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform operations including obtaining, by a decoder, one or more spatial neighboring samples associated with a current sample; and obtaining, by the decoder and based on the one or more spatial neighboring samples, a filtered sample for the current sample.

According to a third aspect of the present disclosure, there is provided a non-transitory computer-readable storage medium for storing a bitstream to be decoded by a decoding method including obtaining, by a decoder, one or more spatial neighboring samples associated with a current sample; and obtaining, by the decoder and based on the one or more spatial neighboring samples, a filtered sample for the current sample.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating a system for encoding and decoding video blocks in accordance with some examples of the present disclosure.

FIG. 1B is a block diagram of an encoder in accordance with some examples of the present disclosure.

FIGS. 1C-1F are block diagrams illustrating how a frame is recursively partitioned into multiple video blocks of different sizes and shapes in accordance with some examples of the present disclosure.

FIG. 1G is a block diagram illustrating an exemplary video encoder in accordance with some examples of the present disclosure

FIG. 2A is a block diagram of a decoder in accordance with some examples of the present disclosure.

FIG. 2B is a block diagram illustrating an exemplary video decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIG. 4A and FIG. 4B are showing two filter shapes 7×7 diamond shape and 5×5 diamond shape supported for luma and chroma components in accordance with some examples of the present disclosure.

FIG. 5 shows only gradient of every second sample in a 10×10 window is calculated in accordance with some examples of the present disclosure.

FIG. 6A shows 90-degree rotation that is applied to filter coefficients in accordance with some examples of the present disclosure.

FIG. 6B shows diagonal flip that is applied to filter coefficients in accordance with some examples of the present disclosure.

FIG. 6C shows vertical flip that is applied to filter coefficients in accordance with some examples of the present disclosure.

FIG. 7 shows the filter shape of a filter F₂ that is applied to R₀(x, y), R₁(x, y), neighboring samples, and samples before deblocking filter (DBF) to derive a filtered sample in accordance with some examples of the present disclosure.

FIG. 8 shows various filter shapes including 1×1, 3×3 or 5×5 used to extract information in prediction signal in accordance with some examples of the present disclosure.

FIG. 9 shows a long cross shape to which a chroma ALF filter shape is changed in accordance with some examples of the present disclosure.

FIG. 10 is a diagram illustrating a computing environment coupled with a user interface in accordance with some examples of the present disclosure.

FIG. 11 shows various online ALF filter inputs in accordance with some examples of the present disclosure.

FIG. 12 shows 1×1 and 3×3 filter shapes that are applied to the prediction samples of the ALF in accordance with some examples of the present disclosure.

FIG. 13 is a flow chart illustrating a method for video decoding in accordance with some examples of the present disclosure.

FIG. 14 is a flow chart illustrating a method for video encoding corresponding to the method for video decoding as shown in FIG. 13 in accordance with some examples of the present disclosure.

FIG. 15 is a flow chart illustrating a method for video decoding in accordance with some examples of the present disclosure.

FIG. 16 is a flow chart illustrating a method for video encoding corresponding to the method for video decoding as shown in FIG. 15 in accordance with some examples of the present disclosure.

FIG. 17 is a flow chart illustrating a method for video decoding in accordance with some examples of the present disclosure.

FIG. 18 is a flow chart illustrating a method for video encoding corresponding to the method for video decoding as shown in FIG. 17 in accordance with some examples of the present disclosure.

FIG. 19 is an illustration of a CCALF architecture, according to some examples of the present disclosure.

FIG. 20 is an illustration of a relative location of filtered chroma sample and its support in the luma plane for 4:2:0 chroma format with chroma location type 0.

FIG. 21 is an illustration of a 25-tap long filter according to some examples of the present disclosure.

FIG. 22 is a flowchart illustrating a method for video decoding in accordance with some examples of the present disclosure.

FIG. 23 is a flowchart illustrating a method for video encoding in accordance with some examples of the present disclosure.

FIG. 24 is a flowchart illustrating a method for video decoding in accordance with some examples of the present disclosure.

FIG. 25 is a flowchart illustrating a method for video encoding in accordance with some examples of the present disclosure.

FIG. 26 is a flowchart illustrating a method for video decoding in accordance with some examples of the present disclosure.

FIG. 27 is a flowchart illustrating a method for video encoding in accordance with some examples of the present disclosure.

FIG. 28 is an illustration of various online ALF filter inputs in accordance with some examples of the present disclosure.

FIGS. 29A through 29C are diagrams illustrating symmetrical sample padding of luma ALF filtering in accordance with examples of the present disclosure.

FIG. 30 is a flowchart illustrating a method for video decoding in accordance with some examples of the present disclosure.

FIG. 31 is a flowchart illustrating a method for video encoding in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

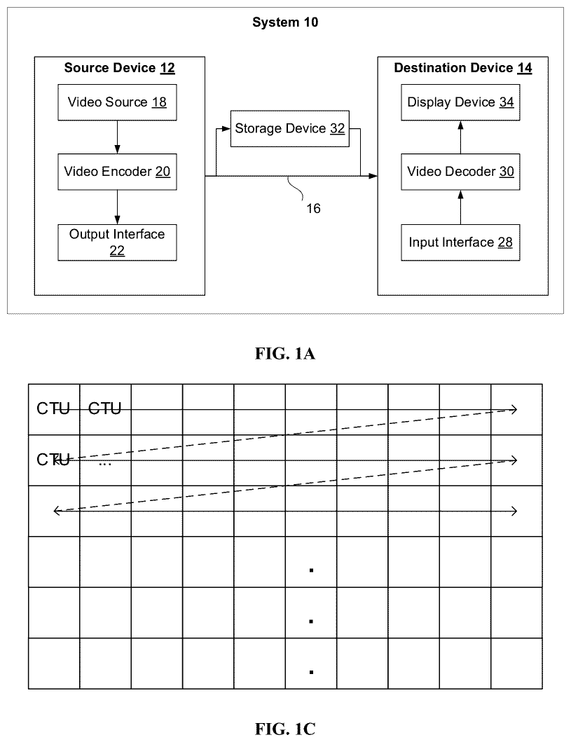

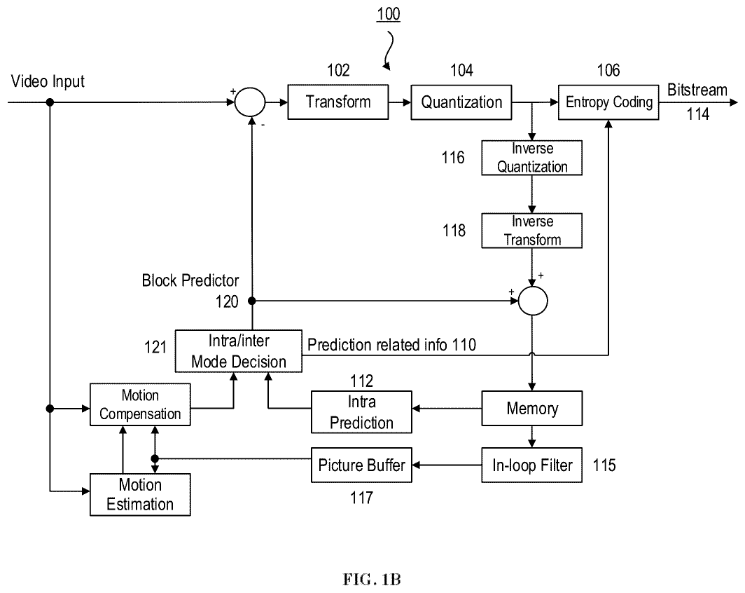

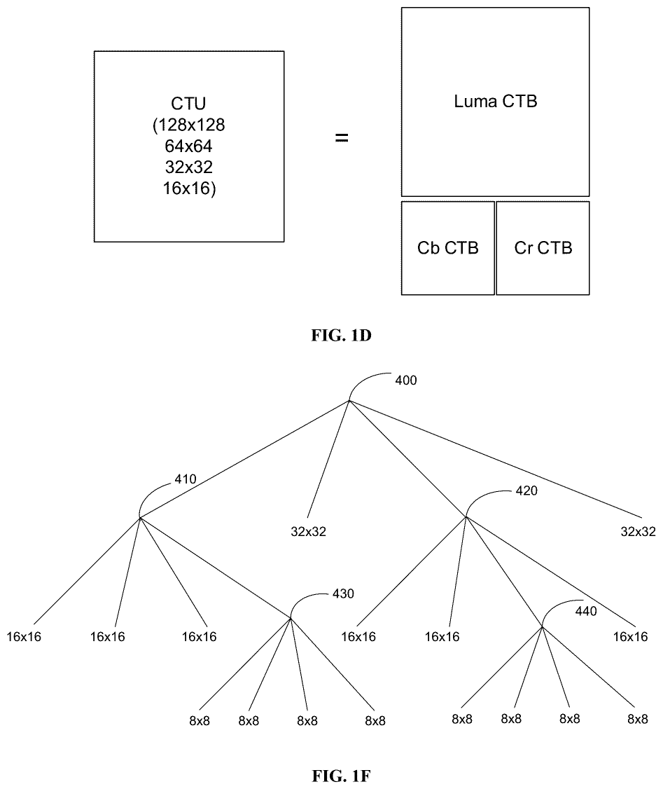

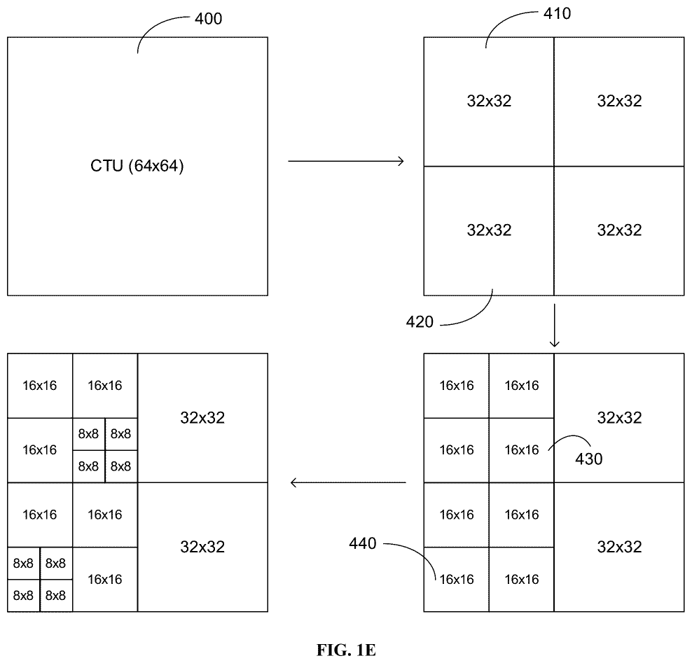

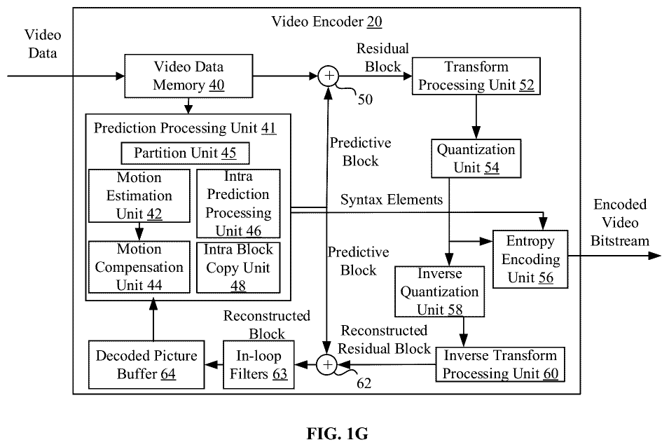

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

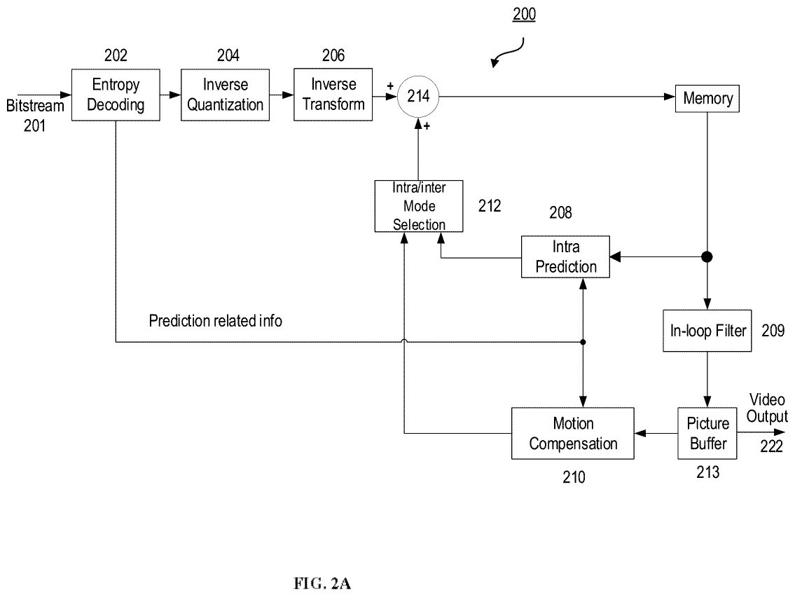

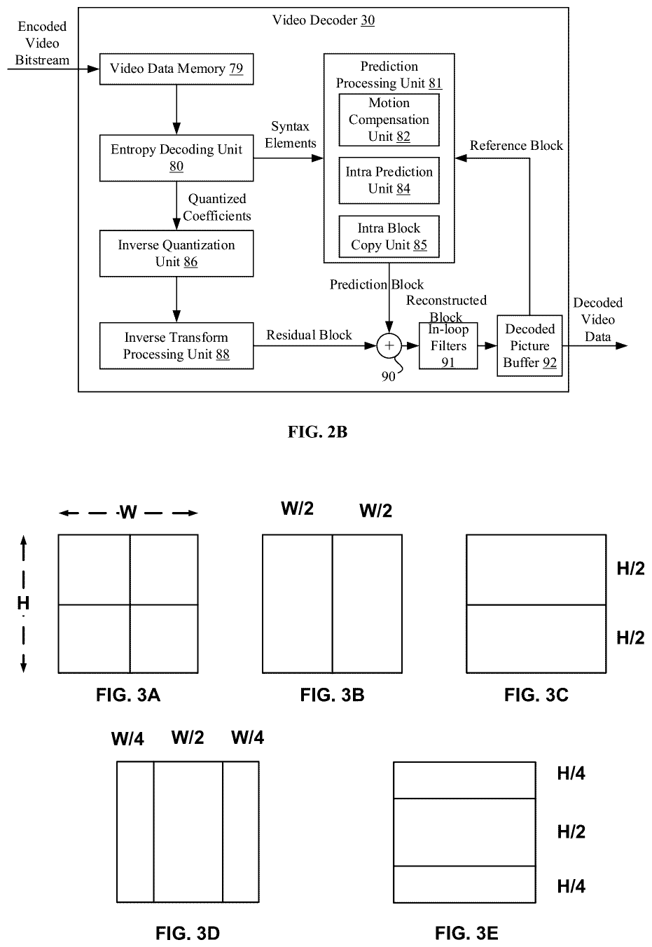

In some implementations, at least a part of components of the source device 12 (for example, the video source 18, the video encoder 20 or components included in the video encoder 20 as described below with reference to FIG. 1G, and the output interface 22) and/or at least a part of components of the destination device 14 (for example, the input interface 28, the video decoder 30 or components included in the video decoder 30 as described below with reference to FIG. 2B, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

Like HEVC, VVC is built upon the block-based hybrid video coding framework. FIG. 1B is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical ternary partitioning (FIG. 3D), and horizontal ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

FIG. 2A is a block diagram illustrating a block-based video decoder 200 which may be used in conjunction with many video coding standards. This decoder 200 is similar to the reconstruction-related section residing in the encoder 100 of FIG. 1B. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

FIG. 1G is a block diagram illustrating another exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 1G, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1A. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 1G, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1A, or archived in the storage device 32 as shown in FIG. 1A for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 2B is a block diagram illustrating another exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 1G. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 2B. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1A.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modern video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

As shown in FIG. 1C, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 1D, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 1E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 1F depicts a quad-tree data structure illustrating the end result of the partition process of the CTU 400 as depicted in FIG. 1E, each leaf node of the quad-tree corresponding to one CU of a respective size ranging from 32×32 to 8×8. Like the CTU depicted in FIG. 1D, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 1E-1F is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIGS. 3A-3E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 1E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit as described above in connection with FIG. 1B, the motion vector predictor of the current CU is subtracted from the actual motion vector of the current CU to produce a Motion Vector Difference (MVD) for the current CU. By doing so, there is no need to encode the motion vector determined by the motion estimation unit for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

This disclosure is related to video coding and compression. More specifically, this disclosure relates to methods and apparatus on improving the coding efficiency of adaptive loop filter (ALF) and cross-component adaptive loop filter (CCALF).

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part2) and Advanced Video Coding (AVC, also known as H.264 or MPEG-4 Part 10), which are jointly developed by ISO/IEC MPEG and ITU-T VCEG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

Like the HEVC, the AVS3 standard is built upon the block-based hybrid video coding framework. FIG. 1B gives the block diagram of a generic block-based hybrid video encoding system. The input video signal is processed block by block (called coding units (CUs)). Different from the HEVC which partitions blocks only based on quad-trees, in the AVS3, one coding tree unit (CTU) is split into CUs to adapt to varying local characteristics based on quad/binary/extended-quad-tree. Additionally, the concept of multiple partition unit type in the HEVC is removed, i.e., the separation of CU, prediction unit (PU) and transform unit (TU) does not exist in the AVS3; instead, each CU is always used as the basic unit for both prediction and transform without further partitions. In the tree partition structure of the AVS3, one CTU is firstly partitioned based on a quad-tree structure. Then, each quad-tree leaf node can be further partitioned based on a binary and extended-quad-tree structure. In FIG. 1B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and then quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used as reference to code future video blocks. To form the output video bit-stream, coding mode (inter or intra), prediction mode information, motion information, and quantized residual coefficients are all sent to the entropy coding unit to be further compressed and packed.

The first version of the HEVC standard was finalized in October 2013, which offers approximately 50% bit-rate saving or equivalent perceptual quality compared to the prior generation video coding standard H.264/MPEG AVC. Although the HEVC standard provides significant coding improvements than its predecessor, there is evidence that superior coding efficiency can be achieved with additional coding tools over HEVC. Based on that, both VCEG and MPEG started the exploration work of new coding technologies for future video coding standardization. One Joint Video Exploration Team (JVET) was formed in October 2015 by ITU-T VCEG and ISO/IEC MPEG to begin significant study of advanced technologies that could enable substantial enhancement of coding efficiency. One reference software called joint exploration model (JEM) was maintained by the JVET by integrating several additional coding tools on top of the HEVC test model (HM).

In October 2017, the joint call for proposals (CfP) on video compression with capability beyond HEVC was issued by ITU-T and ISO/IEC. In April 2018, 23 CfP responses were received and evaluated at the 10-th JVET meeting, which demonstrated compression efficiency gain over the HEVC around 40%. Based on such evaluation results, the JVET launched a new project to develop the new generation video coding standard that is named as Versatile Video Coding (VVC). In the same month, one reference software codebase, called VVC test model (VTM), was established for demonstrating a reference implementation of the VVC standard.

Like HEVC, the VVC is built upon the block-based hybrid video coding framework. FIG. 1B gives the block diagram of a generic block-based hybrid video encoding system. The input video signal is processed block by block (called coding units (CUs)). In VTM-1.0, a CU can be up to 128×128 pixels. However, different from the HEVC which partitions blocks only based on quad-trees, in the VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure. As shown in FIG. 3A-3E, there are five splitting types, quaternary partitioning, horizontal binary partitioning, vertical binary partitioning, horizontal ternary partitioning, and vertical ternary partitioning. In FIG. 1B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream.

FIG. 2A gives a general block diagram of a block-based video decoder. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out to drive a display device, as well as used to predict future video blocks.

The main focus of the disclosure is to improve the adaptive loop filter (ALF) and cross-component adaptive loop filter (CCALF). The related knowledge is elaborated in the following sections.

### ALF in VVC

### Filter Shapes, Linear Filtering and Adaptive Clipping

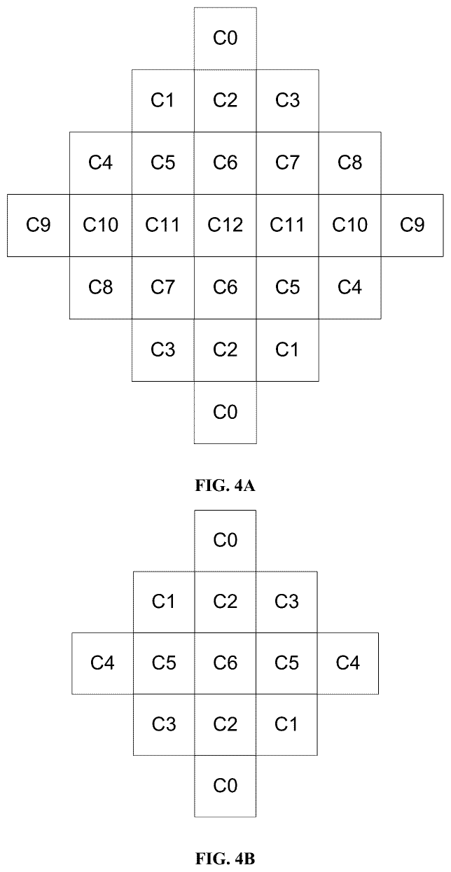

In VVC, ALF is applied to the output samples of SAO. Two filter shapes, 7×7 diamond shape and 5×5 diamond shape are supported for luma and chroma components, respectively, as shown in FIGS. 4A-4B. In FIGS. 4A-4B, each square corresponds to a luma or a chroma sample and the center square corresponds to a current to-be-filtered sample. The filter coefficients use point-symmetry and each integer filter coefficient is represented with 7-bit fractional precision. In addition, the sum of coefficients of one filter is equal to 128, which is the fixed-point representation of 1.0 with 7-bit fractional precision:

$$2 {\sum }_{i = 0}^{N - 2} {c}_{i} + {c}_{N - 1} = 128 \qquad ( 1 )$$

where the number of coefficients N is equal to 13 and 7 for 7×7 and 5×5 filter shape, respectively. A filtered sample value \tilde{R}(x,y) at coordinates (x,y) is derived by applying coefficient cᵢ to the reconstructed sample values R(x, y) as follows:

$$\tilde{R} ( x , y ) = [ {\sum }_{i = 0}^{N - 2} {c}_{i} ( R ( x + {x}_{i} , y + {y}_{i} ) + R ( x - {x}_{i} , y - {y}_{i} ) ) + {c}_{N - 1} R ( x , y ) + 64 ] ≫ 7 \qquad ( 2 )$$

where (x+xᵢ, y+yᵢ) and (x−xᵢ, y−yᵢ) are the coordinates of the reconstructed samples corresponding to i-th coefficient cᵢ. Due to the constraint in equation (1), equation (2) can be written as:

$$\tilde{R} ( x , y ) = R ( x , y ) + \{ [ {\sum }_{i = 0}^{N - 2} {c}_{i} ( ( R ( x + {x}_{i} , y + {y}_{i} ) - R ( x , y ) ) + ( R ( x - {x}_{i} , y - {y}_{i} ) - R ( x , y ) ) ) + 64 ] ≫ 7 \} \qquad ( 3 )$$

In VVC, the possibility to clip the difference between the neighboring sample value and the current to-be-filtered sample is added to equation (3) as follows:

$$\tilde{R} ( x , y ) = R ( x , y ) + \{ [ {\sum }_{i = 0}^{N - 2} {c}_{i} {f}_{i} + 64 ] ≫ 7 \} \qquad ( 4 )$$

$$where$$

$${f}_{i} = min ( {b}_{i} , max ( - {b}_{i} , R ( x + {x}_{i} , y + {y}_{i} ) - R ( x , y ) ) ) + min ( {b}_{i} , max ( - {b}_{i} , R ( x - {x}_{i} , y - {y}_{i} ) - R ( x , y ) ) ) \qquad ( 5 )$$

bᵢ is the clipping parameter for a coefficient cᵢ determined by a clipping index dᵢ. bᵢ is derived as follows:

$${b}_{i} = \{ \begin{matrix}{2}^{BD} , when {d}_{i} = 0 \\ {2}^{B D - 1 - 2 {d}_{i}} , otherwise\end{matrix} \qquad ( 6 )$$

where BD is the sample bit depth and dᵢ can be 0, 1, 2 or 3.

### Luma Sub-Block Level Filter Adaptation

In VVC, sub-block level filter adaption is only applied to luma component. Each 4×4 luma block is classified based on its directionality and 2D Laplacian activity. First, the values of sample gradients for horizontal, vertical and two diagonal directions are calculated:

$$\begin{matrix}{H}_{k , l} = \vert 2 R ( k , l ) - R ( k - 1 , l ) - R ( k + 1 , l ) \vert , \\ {V}_{k , l} = \vert 2 R ( k , l ) - R ( k , l - 1 ) - R ( k , l + 1 ) \vert , \\ D {0}_{k , l} = \vert 2 R ( k , l ) - R ( k - 1 , l - 1 ) - R ( k + 1 , l + 1 ) \vert , \\ D {1}_{k , l} = \vert 2 R ( k , l ) - R ( k - 1 , l + 1 ) - R ( k + 1 , l - 1 ) \vert .\end{matrix} \qquad ( 7 )$$

Based on the sample gradients, sub-block horizontal gradient, gₕ, vertical gradient, gᵥ, and two diagonal gradients, g_{d0} and g_{d1}, are calculated as

$$\begin{matrix}{g}_{h} = {\sum }_{k = i - 2}^{i + 5} {\sum }_{l = j - 2}^{j + 5} {H}_{k , l} , \\ {g}_{v} = {\sum }_{k = i - 2}^{i + 5} {\sum }_{l = j - 2}^{j + 5} {V}_{k , l} , \\ {g}_{d 0} = {\sum }_{k = i - 2}^{i + 5} {\sum }_{l = j - 2}^{j + 5} D {0}_{k , l} , \\ {g}_{d 1} = {\sum }_{k = i - 2}^{i + 5} {\sum }_{l = j - 2}^{j + 5} D {1}_{k , l}\end{matrix} \qquad ( 8 )$$

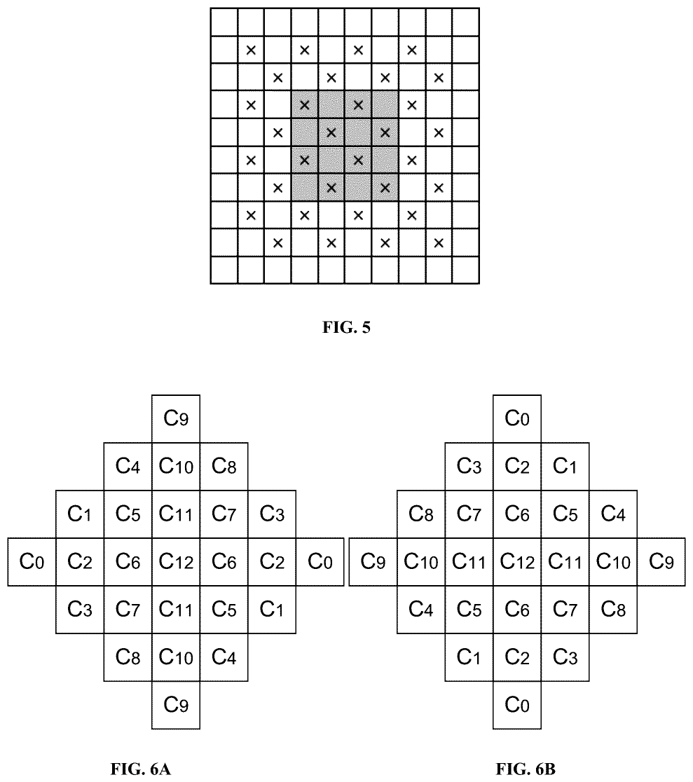

Indices i and j refer to the coordinates of the upper left sample in the 4×4 luma block. As it can be seen from equation (8), the sum of sample gradients within a 10×10 luma window that covers the target 4×4 block is used for classifying that block. To reduce the complexity, only gradient of every second sample in a 10×10 window is calculated as illustrated in FIG. 5. The values of other sample gradients are set to 0.

Second, to assign the directionality D, the ratio of the maximum and the minimum of the sub-block horizontal and vertical gradients

$${g}_{h , v}^{max} = max ( {g}_{h} , {g}_{v} ) , {g}_{h , v}^{min} = min ( {g}_{h} , {g}_{v} ) , \qquad ( 9 )$$

and the ratio of the maximum and the minimum of two sub-block diagonal gradients

$${g}_{d 0 , d 1}^{max} = max ( {g}_{d 0} , {g}_{d 1} ) , {g}_{d 0 , d 1}^{min} = min ( {g}_{d 0} , {g}_{d 1} ) , \qquad ( 10 )$$

are compared against each other with a set of thresholds tᵢ and t₂:
Step 1: If both g_{h,v}^{max}≤t₁·g_{h,v}^{min} and g_{d0,d1}^{max}≤t₁·g_{d0,d1}^{min}, D is set to 0.
Step 2: If g_{h,v}^{max}/g_{h,v}^{min}>g_{d0,d1}^{max}/g_{d0,d1}^{min}, the directionality D is calculated in Step 3, otherwise in Step 4.
Step 3: If g_{h,v}^{max}>t₂·g_{h,v}^{min}, D is set to 2, otherwise D is set to 1.
Step 4: If g_{d0,d1}^{max}>t₂·g_{d0,d1}^{min}, D is set to 4, otherwise D is set to 3.

Each subsequent step in the above calculation of D is only executed if there is no value assigned to D in the previous steps. Third, an activity value A is calculated as

$$A = ( {\sum }_{k = i - 2}^{i + 5} {\sum }_{l = j - 2}^{j + 5} ( {V}_{k , l} + {H}_{k , l} ) ) >> ( BD - 2 ) \qquad ( 11 )$$

A is further mapped to the range of 0 to 4: Â=Q_{min(A,15)}, where {Qₙ}={0,1,2,2,2,2,2,3,3,3,3,3,3,3,3,4}. Finally, each 4×4 luma block is categorized into one of the 25 classes:

$$C = 5 D + \hat{A} \qquad ( 12 )$$

Each class can have its own filter assigned.

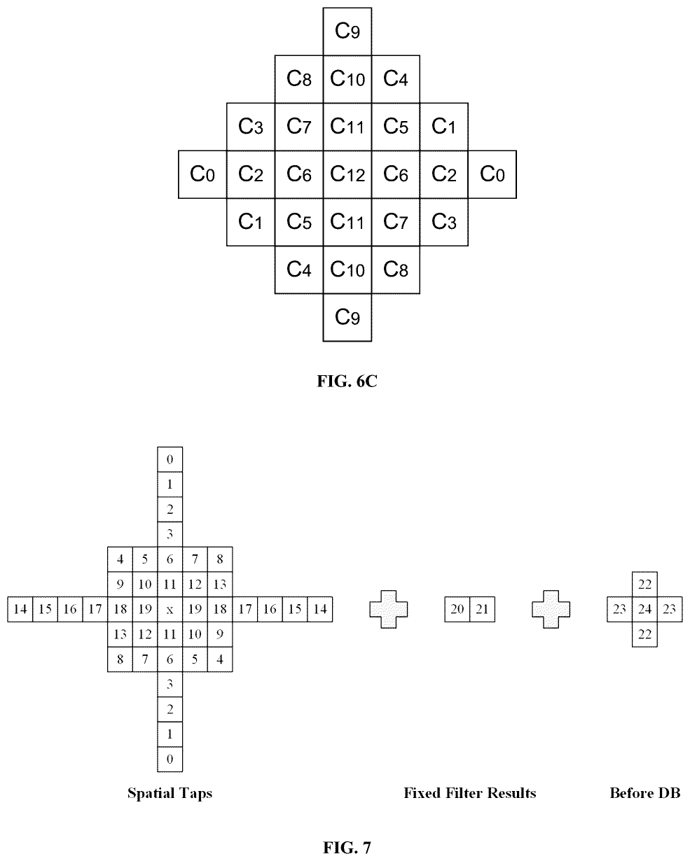

Before filtering each 4×4 luma block, a geometric transformation, such as 90-degree rotation, diagonal or vertical flip, is applied to the filter coefficients, as illustrated in FIGS. 6A-6C, depending on the sub-block gradient value as specified in Table 1.

TABLE 1
Geometric transformation based on sub-block gradient values

| Sub-block gradient values | Transformation |
|---|---|
| g_{d1} < g_{d0} and gₕ < gᵥ | No transformation |
| g_{d1} < g_{d0} and gᵥ ≤ gₕ | Diagonal flip |
| g_{do} ≤ g_{d1} and gₕ < gᵥ | Vertical flip |
| g_{do} ≤ g_{d1}and gᵥ ≤ gₕ | 90-degree rotation |

### Coding Tree Block Level Filter Adaptation

In addition to the luma 4×4 block-level filter adaptation, ALF supports CTB-level filter adaptation. A luma CTB can use a filter set calculated for the current slice or one of the filter sets calculated for the already coded slices. It can also use one of the 16 offline trained filter sets. Within each luma CTB, which filter from the chosen filter set should be applied to each 4×4 block, is determined by the class C calculated in equation (12) for this block.

Chroma uses only CTB-level filter adaptation. Up to 8 filters can be used for chroma components in a slice. Each CTB can select one of these filters.

### Syntax Design

Filter coefficients and clipping indices are carried in ALF APSs. An ALF APS can include up to 8 chroma filters and one luma filter set with up to 25 filters. An index i_{c} is also included for each of the 25 luma classes. Classes having the same index i_{c} share the same filter. By merging different classes, the number of bits required to represent the filter coefficients is reduced. The absolute value of a filter coefficient is represented using a 0th order Exp-Golomb code followed by a sign bit for a non-zero coefficient. When clipping is enabled, a clipping index is also signaled for each filter coefficient using a two-bit fixed-length code. The storage needed for ALF coefficients and clipping indices within an APS is at most 3480 bits. Up to 8 ALF APSs can be used by the decoder at the same time.

Filter control syntax elements include two types of information. First, ALF on/off flags are signaled at sequence, picture, slice and CTB levels. Chroma ALF can be enabled at picture and slice level only if luma ALF is enabled at the corresponding level. Second, filter usage information is signaled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signaled indicating which ALF APS or offline trained luma filter set is used. For a chroma CTB, the index indicates which filter in the referenced APS is used.

### Line Buffer Reduction

To reduce the storage requirement for ALF, VVC employs line buffer boundary processing. In VVC, line buffer boundaries are placed 4 luma samples and 2 chroma samples above horizontal CTU boundaries. When applying ALF to a sample on one side of a line buffer boundary, samples on the other side of the line buffer boundary cannot be used.

### ALF in ECM

### ALF Simplification Removal

ALF gradient subsampling and ALF virtual boundary processing are removed. Block size for classification is reduced from 4×4 to 2×2. Filter size for both luma and chroma, for which ALF coefficients are signaled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set F₁ is used for a given sample is decided by a class Cᵢ assigned to this sample using classifier Cᵢ.

### Filtering

At first, two 13×13 diamond shape fixed filters F₀ and F₁ are applied to derive two intermediate samples R₀(x,y) and R₁(x,y). After that, F₂ is applied to R₀(x,y), R₁(x,y), neighboring samples, and samples before deblocking filter (DBF) to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] + [ {\sum }_{i = 22}^{24} {c}_{i} ( {h}_{i , 0} + {h}_{i , 1} ) ] \qquad ( 13 )$$

where f_{i,j} is the clipped difference between a neighboring sample and current sample R(x,y), gᵢ is the clipped difference between Rᵢ₋₂₀(x, y) and current sample R(x, y), h_{i,j} is the clipped difference between a neighboring sample before DBF and current sample R(x, y). The filter coefficients cᵢ, i=0, . . . , 24, are signaled. The filter shape of F₂ is presented in FIG. 7.

### Classification

Based on directionality Dᵢ and activity Âᵢ, a class Cᵢ is assigned to each 2×2 block:

$${C}_{i} = {\hat{A}}_{i} * {M}_{D , i} + {D}_{i} \qquad ( 14 )$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as gₕⁱ, gᵥⁱ, g_{d1}ⁱ and g_{d2}ⁱ. The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad ( 15 )$$

with a set of thresholds. The directionality D₂ is derived as in VVC using thresholds 2 and 4.5. For D₀ and D₁, horizontal/vertical edge strength E_{HV}ⁱ and diagonal edge strength E_{D}ⁱ are calculated first. Thresholds Th=[1.25, 1.5, 2, 3, 4.5, 8] are used. Edge strength E_{HV}ⁱ is 0 if r_{h,v}ⁱ≤Th[0]; otherwise, E_{HV}ⁱ is the maximum integer such that r_{h,v}ⁱ>Th[E_{HV}ⁱ−1]. Edge strength E_{D}ⁱ is 0 if r_{d1d2}ⁱ≤Th[0]; otherwise, E_{D}ⁱ is the maximum integer such that r_{d1,d2}ⁱ>Th[E_{D}ⁱ−1]. When r_{h,v}ⁱ>r_{d1,d2}ⁱ, i.e., horizontal/vertical edges are dominant, the Dᵢ is derived by using Table 2 (a); otherwise, diagonal edges are dominant, the Dᵢ is derived by using Table 2 (b).

TABLE 2
Mapping of E_{D}ⁱ and E_{HV}ⁱ to Dᵢ

| | E_{D}ⁱ | | | | | | | | E_{HV}ⁱ | | | | | | |
|---|---|---|---|---|---|---|---|---|---|---|---|---|---|---|---|
| E_{HV}ⁱ | 0 | 1 | 2 | 3 | 4 | 5 | 6 | E_{D}ⁱ | 0 | 1 | 2 | 3 | 4 | 5 | 6 |
| 0 | 0 | 0 | 0 | 0 | 0 | 0 | 0 | 0 | 28 | 0 | 0 | 0 | 0 | 0 | 0 |
| 1 | 1 | 2 | 0 | 0 | 0 | 0 | 0 | 1 | 29 | 30 | 0 | 0 | 0 | 0 | 0 |
| 2 | 3 | 4 | 5 | 0 | 0 | 0 | 0 | 0 | 2 | 31 | 32 | 33 | 0 | 0 | 0 |
| 3 | 6 | 7 | 8 | 9 | 0 | 0 | 0 | 3 | 34 | 35 | 36 | 37 | 0 | 0 | 0 |
| 4 | 10 | 11 | 12 | 13 | 14 | 0 | 0 | 4 | 38 | 39 | 40 | 41 | 42 | 0 | 0 |
| 5 | 15 | 16 | 17 | 18 | 19 | 20 | 0 | 5 | 43 | 44 | 45 | 46 | 47 | 48 | 0 |
| 6 | 21 | 22 | 23 | 24 | 25 | 26 | 27 | 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

### Alternative 2×2 ALF Classifier

Classification in ALF is extended with an additional alternative classifier. For a signalled luma filter set, a flag is signalled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$$class\_index = ( sum * 25 ) >> ( sample bit depth + 2 ) . \qquad ( 16 )$$

Although ALF has been improved in ECM, there is room to further improve its performance.

First, online ALF filter in ECM takes spatial neighboring pixels, fixed ALF filter results and spatial neighboring pixels before deblocking filter as input. However, besides these information, other information such as spatial neighboring pixels in prediction signal, spatial neighboring pixels before SAO can also be used as online ALF filter equation input, which may benefit the coding performance.

Second, edge based classifier and band based classifier are used adaptively for online ALF filter in ECM. However, these two classifiers may be further combined to provide other classifiers, which may benefit the coding performance.

Third, the filter shape for chroma ALF is diamond in ECM, while the filter shape for luma ALF is long cross shape, such non-unified design may not be optimal from standardization point of view.

In this disclosure, to address the issues as pointed out above, methods are provided to further improve the existing design of the ALF. In general, the main features of the examples provided in this disclosure are summarized as follows.
1. Online ALF filter takes spatial neighboring pixels in prediction signal, spatial neighboring pixels before SAO as additional input.
2. The classifiers which combine the features of edge based classifier and band based classifier are used as additional classifier for online ALF filter.
3. The filter shape for chroma ALF is changed from diamond shape to long cross shape to unify with the filter shape for luma ALF.

It is noted that the disclosed methods may be applied independently or jointly.

### Information in Prediction and Before SAO Used as Additional ALF Input

According to the one or more embodiments of the disclosure, information in prediction and before SAO are used as additional ALF equation input. Different methods may be used to achieve this goal.

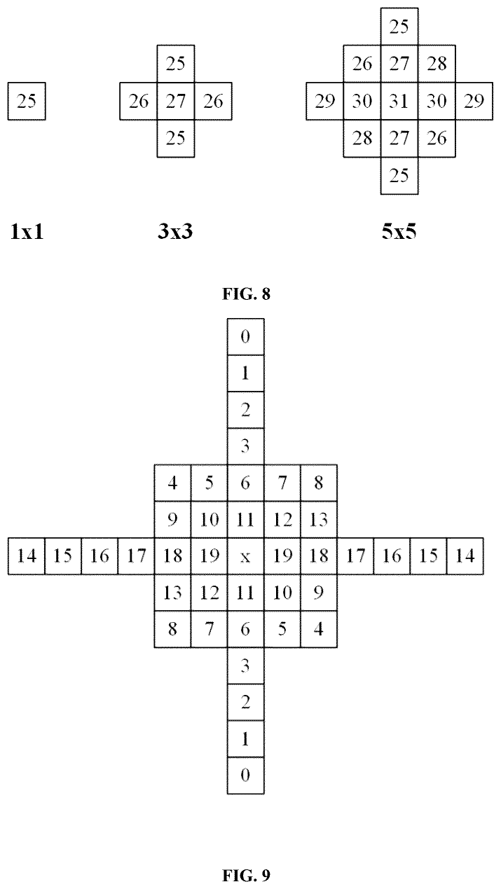

In the first method, it is proposed to take the spatial neighboring pixels in prediction signal as additional ALF equation input. Various filter shapes may be used to extract the information in prediction signal. For example, the filter shape can be 1×1, 3×3 or 5×5 as shown in FIG. 8. Various equation forms can be used to extract the information in prediction signal. In one example, the clipping differences between the surrounding pixels in prediction signal and current pixel are used as ALF equation input. In another example, the clipping differences between the surrounding pixels in prediction signal and the collocated pixel in prediction signal, the clipping difference between the collocated pixel in prediction signal and current pixel are used as ALF equation input.

In the second method, it is proposed to take the spatial neighboring pixels in before SAO signal as additional ALF equation input. Various filter shapes can be used to extract the information in before SAO signal. For example, the filter shape can be 1×1, 3×3 or 5×5 as shown in FIG. 8. Various equation forms can be used to extract the information in before SAO signal. In one example, the clipping differences between the surrounding pixels in before SAO signal and current pixel are used as ALF equation input. In another example, the clipping differences between the surrounding pixels in before SAO signal and the collocated pixel in before SAO signal, the clipping difference between the collocated pixel in before SAO signal and current pixel are used as ALF equation input.

In the third method, it is proposed to take both information in prediction and before SAO signal as ALF equation input. The utilization method proposed in the first and second method can be combined to achieve the third method.

### New Classifiers Combined the Features of Edge Based Classifier and Band Based Classifier

According to the one or more embodiments of the disclosure, the features of edge based classifier and band based classifier are combined to derive new classifiers for online ALF filter. Different methods may be used to achieve this goal.

In the first method, it is proposed to first compute the directionality D of the sub-block of luma component, then the sum of sample values of the sub-block is calculated and it is mapped to the index referring to the band based classifier, and the class index for the sub-block is calculated as

$$C = B * {M}_{D} + D \qquad ( 17 )$$

where B is the index calculated referring to the band based classifier, M_{D} represents the total number of directionalities D. In one example, for the 2×2 luma block, the directionality D is calculated in the same manner as D₂ in ECM, and B is calculated as

$$B = ( sum * 5 ) >> ( sample bit depth + 2 ) \qquad ( 18 )$$

In the second method, it is proposed to first compute the activity value A of the sub-block of luma component, then the sum of sample values of the sub-block is calculated and it is mapped to the index referring to the band based classifier, and the class index for the sub-block is calculated as

$$C = B * {M}_{A} + A \qquad ( 19 )$$

where B is the index calculated referring to the band based classifier, M_{A} represents the total number of the activity value A. In one example, for the 2×2 luma block, the activity value A is calculated in the same manner as Â₂ in ECM, and B is calculated as

$$B = ( sum * 5 ) >> ( sample bit depth + 2 ) \qquad ( 20 )$$

In the third method, it is proposed to first compute the index of the sub-block of luma component referring to the edge based classifier, then the sum of sample values of the sub-block is calculated and it is mapped to the index referring to the band based classifier, and the class index for the sub-block is calculated as

$$C = B * {M}_{E} + E \qquad ( 21 )$$

where B is the index calculated referring to the band based classifier, M_{E} represents the total number of the index calculated referring to the edge based classifier, E is the index calculated referring to the edge based classifier. In one example, for the 2×2 luma block, the index E is calculated in the same manner as C₂ in ECM, and B is calculated as

$$B = ( sum * 2 ) >> ( sample bit depth + 2 ) \qquad ( 22 )$$

Adjust the Chroma ALF Filter Shape to Unify with Luma ALF Filter Shape

In the third aspect of this disclosure, it is provided to change the chroma ALF filter shape from diamond shape to long cross shape as shown in FIG. 9, which is unified with the luma ALF filter shape.

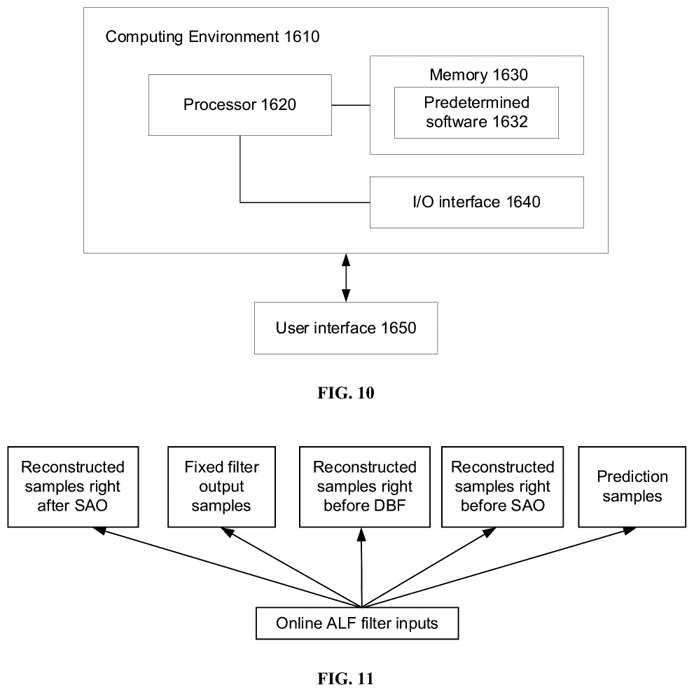

FIG. 10 shows a computing environment (or a computing device) 1610 coupled with a user interface 1660. The computing environment 1610 can be part of a data processing server. In some embodiments, the computing device 1610 can perform any of various methods or processes (such as encoding/decoding methods or processes) as described hereinbefore in accordance with various examples of the present disclosure. The computing environment 1610 may include a processor 1620, a memory 1640, and an I/O interface 1650.

The processor 1620 typically controls overall operations of the computing environment 1610, such as the operations associated with the display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a GPU, or the like.

The memory 1640 is configured to store various types of data to support the operation of the computing environment 1610. Memory 1640 may include predetermine software 1642. Examples of such data include instructions for any applications or methods operated on the computing environment 1610, video datasets, image data, etc. The memory 1640 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1650 provides an interface between the processor 1620 and peripheral interface modules, such as a keyboard, a click wheel, buttons, and the like. The buttons may include but are not limited to, a home button, a start scan button, and a stop scan button. The I/O interface 1650 can be coupled with an encoder and decoder.

In some embodiments, there is also provided a non-transitory computer-readable storage medium including a plurality of programs, such as included in the memory 1640, executable by the processor 1620 in the computing environment 1610, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 1610 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

FIG. 11 shows the online ALF filter inputs where the fixed filter output samples are obtained by feeding the reconstructed samples right after SAO into the offline trained fixed filters. Online ALF filter can take reconstructed samples right prior to SAO, i.e., right before SAO as additional inputs, or take prediction samples as additional inputs, or take both reconstructed samples right before SAO and prediction samples as additional inputs. As shown in FIG. 11, the various inputs of the online ALF filter may include reconstructed samples right before SAO and prediction samples, in addition to reconstructed samples right after SAO, fixed filter output samples, and reconstructed samples before DBF.

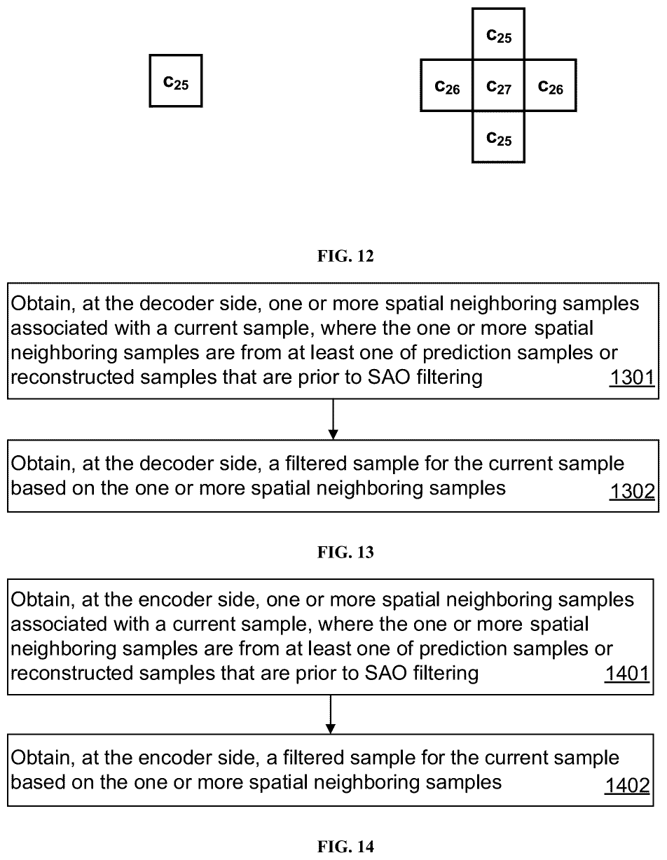

FIG. 12 shows 1×1 and 3×3 filter shapes that are applied to the prediction samples of the ALF in accordance with some examples of the present disclosure. In some examples, assuming that the prediction samples are used as additional inputs for online ALF filter, a filtered sample is derived as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] + [ {\sum }_{i = 22}^{24} {c}_{i} ( {h}_{i , 0} + {h}_{i , 1} ) ] + [ {\sum }_{i = 25}^{N} {c}_{i} ( {p}_{i , 0} + {p}_{i , 1} ) ] \qquad ( 23 )$$

where R(x, y) indicates the current sample; f_{i,j} indicates the clipped difference between a neighboring sample right after SAO and R(x, y); gᵢ indicates the clipped difference between a fixed filter output sample and R(x, y); h_{i,j} indicates the clipped difference between a neighboring sample right before DBF and R(x, y). p^{i,j} is the clipped difference between a neighboring prediction sample and current sample R(x, y). The filter coefficients cᵢ, i=0, . . . N, are signalled. Different filter shapes, for example, 1×1 and 3×3 diamond shapes as shown in FIG. 12, can be used.

When the reconstructed samples right before SAO are used as additional inputs for online ALF filter, the prediction samples in above equation can be directly replaced with the reconstructed samples right before SAO.

FIG. 13 is a flow chart illustrating a method for video decoding in accordance with some examples of the present disclosure.

In Step 1301, the processor 1620, at the side of a decoder, may obtain one or more spatial neighboring samples associated with a current sample, where the one or more spatial neighboring samples are from at least one of prediction samples or reconstructed samples, and the reconstructed samples are samples prior to SAO filtering.

In some examples, as shown in FIG. 11, in addition to the reconstructed samples right after SAO, fixed filter output samples, and the reconstructed samples right before DBF, the one or more spatial neighboring samples may further include prediction samples and reconstructed samples right prior to SAO.

In Step 1302, the processor 1620, at the side of the decoder, may obtain a filtered sample for the current sample based on the one or more spatial neighboring samples.

In some examples, the processor 1620 may obtain the filtered sample in Step 1302 based on the one or more spatial neighboring samples and one or more filter coefficients, where the one or more filter coefficients are associated with different filter shapes. For example, various filter shapes can be used to extract the information in before SAO signal or prediction signal. The filter shape may be 1×1, 3×3 or 5×5 as shown in FIG. 8 or FIG. 12.

In some examples, the processor 1620 may obtain clipped difference based on the one or more spatial neighboring samples and the current sample, where the clipped difference may be shown as in equation (13) or equation (23) above.

For example, the clipped difference may include one of the following differences: clipped difference between one or more surrounding samples and the current sample, or clipped difference between the one or more surrounding samples and a collocated sample, where the one or more surrounding samples and the collocated sample are from the one or more spatial neighboring samples.

In some examples, the one or more coefficients may be signaled in a bitstream by an encoder and received by the decoder.

In some examples, the processor 1620 may obtain the one or more spatial neighboring samples including: one or more neighboring output samples after the SAO filtering, one or more fixed filter output samples, one or more neighboring samples prior to DBF, prediction samples and/or reconstructed samples, and then derive the filtered sample based on the one or more spatial neighboring samples obtained above, as represented in equation (23).

FIG. 14 is a flow chart illustrating a method for video encoding corresponding to the method for video decoding as shown in FIG. 13 in accordance with some examples of the present disclosure.

In Step 1401, the processor 1620, at the side of an encoder, may obtain one or more spatial neighboring samples associated with a current sample, where the one or more spatial neighboring samples are from at least one of prediction samples or reconstructed samples, and the reconstructed samples are samples prior to SAO filtering.

In some examples, as shown in FIG. 11, in addition to the reconstructed samples right after SAO, fixed filter output samples, and the reconstructed samples right before DBF, the one or more spatial neighboring samples may further include prediction samples and reconstructed samples right prior to SAO.

In Step 1302, the processor 1620, at the side of the encoder, may obtain a filtered sample for the current sample based on the one or more spatial neighboring samples.

In some examples, the processor 1620 may obtain the filtered sample in Step 1302 based on the one or more spatial neighboring samples and one or more filter coefficients, where the one or more filter coefficients are associated with different filter shapes. For example, various filter shapes can be used to extract the information in before SAO signal or prediction signal. The filter shape may be 1×1, 3×3 or 5×5 as shown in FIG. 8 or FIG. 12.

In some examples, the processor 1620 may obtain clipped difference based on the one or more spatial neighboring samples and the current sample, where the clipped difference may be shown as in equation (13) or equation (23) above.

For example, the clipped difference may include one of the following differences: clipped difference between one or more surrounding samples and the current sample, or clipped difference between the one or more surrounding samples and a collocated sample, where the one or more surrounding samples and the collocated sample are from the one or more spatial neighboring samples.

In some examples, the one or more coefficients may be signaled in a bitstream by an encoder and received by the decoder.

In some examples, the processor 1620 may obtain the one or more spatial neighboring samples including: one or more neighboring output samples after the SAO filtering, one or more fixed filter output samples, one or more neighboring samples prior to DBF, prediction samples and/or reconstructed samples, and then derive the filtered sample based on the one or more spatial neighboring samples obtained above, as represented in equation (23).

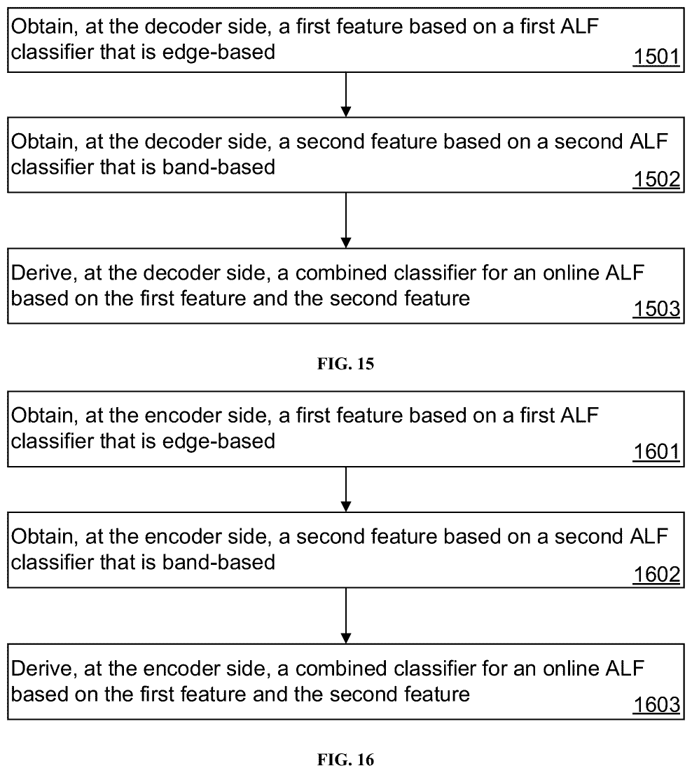

FIG. 15 is a flow chart illustrating a method for video decoding in accordance with some examples of the present disclosure.

In Step 1501, the processor 1620, at the side of a decoder, may obtain a first feature based on a first ALF classifier that is edge-based.

In Step 1502, the processor 1620, at the side of the decoder, may obtain a second feature based on a first ALF classifier that is band-based.

In Step 1503, the processor 1620, at the side of the decoder, may derive a combined classifier for an online ALF based on the first feature and the second feature.

In some examples, the features of edge-based classifier and band-based classifier are combined to derive new classifiers for online ALF filter, so that features from different aspects preserved by different classifiers (e.g., the edge-based classifier and the band-based classifier) can be maintained. In some examples, the first ALF classifier may be the edge-based classifier and the second ALF classifier may be the band-based classifier, or the first ALF classifier may be the band-based classifier and the second ALF classifier may be the edge-based classifier.

In some examples, the processor 1620 may obtain the first feature based on the first ALF classifier by computing directionality of a sub-block of a luma component and obtaining a total number of the directionality and obtain the second feature based on the second ALF classifier by calculating a sum of sample values of the sub-block and calculating an index referring to the second ALF classifier. For example, as discussed above, it is proposed to first compute the directionality D of the sub-block of luma component, then the sum of sample values of the sub-block is calculated and it is mapped to the index referring to the band-based classifier, and the class index for the sub-block is calculated as C=B*M_{D}+D, where B is the index calculated referring to the band based classifier, M_{D} represents the total number of directionalities D. In one example, for the 2×2 luma block, the directionality D is calculated in the same manner as D₂ in ECM, and B is calculated as B=(sum*5)>>(sample bit depth+2).

In some examples, the processor 1620 may obtain the first feature based on the first ALF classifier by computing an activity value of a sub-block of a luma component and obtaining a total number of the activity value and obtain the second feature based on the second ALF classifier by calculating a sum of sample values of the sub-block and calculating an index referring to the second ALF classifier. For example, as discussed above, it is proposed to first compute the activity value A of the sub-block of luma component, then the sum of sample values of the sub-block is calculated and it is mapped to the index referring to the band-based classifier, and the class index for the sub-block is calculated as C=B*M_{A}+A, where B is the index calculated referring to the band based classifier, M_{A} represents the total number of the activity value A. In one example, for the 2×2 luma block, the activity value A is calculated in the same manner as Â₂ in ECM, and B is calculated as B=(sum*5)>>(sample bit depth+2).

In some examples, the processor 1620 may obtain the first feature based on the first ALF classifier by computing an index of a sub-block of a luma component referring to the first ALF classifier and obtaining a total number of the index and obtain the second feature based on the second ALF classifier by calculating a sum of sample values of the sub-block and calculating an index referring to the second ALF classifier. For example, as discussed above, it is proposed to first compute the index of the sub-block of luma component referring to the edge based classifier, then the sum of sample values of the sub-block is calculated and it is mapped to the index referring to the band based classifier, and the class index for the sub-block is calculated as C=B*M_{E}+E, where B is the index calculated referring to the band based classifier, M_{E} represents the total number of the index calculated referring to the edge based classifier, E is the index calculated referring to the edge based classifier. In one example, for the 2×2 luma block, the index E is calculated in the same manner as C₂ in ECM, and B is calculated as B=(sum*2)>>(sample bit depth+2).

FIG. 16 is a flow chart illustrating a method for video encoding corresponding to the method for video decoding as shown in FIG. 15 in accordance with some examples of the present disclosure.

In Step 1601, the processor 1620, at the side of an encoder, may obtain a first feature based on a first ALF classifier that is edge-based.

In Step 1602, the processor 1620, at the side of the encoder, may obtain a second feature based on a first ALF classifier that is band-based.

In Step 1603, the processor 1620, at the side of the encoder, may derive a combined classifier for an online ALF based on the first feature and the second feature.

In some examples, the features of edge-based classifier and band-based classifier are combined to derive new classifiers for online ALF filter, so that features from different aspects preserved by different classifiers (e.g., the edge-based classifier and the band-based classifier) can be maintained. In some examples, the first ALF classifier may be the edge-based classifier and the second ALF classifier may be the band-based classifier, or the first ALF classifier may be the band-based classifier and the second ALF classifier may be the edge-based classifier.

In some examples, the processor 1620 may obtain the first feature based on the first ALF classifier by computing directionality of a sub-block of a luma component and obtaining a total number of the directionality and obtain the second feature based on the second ALF classifier by calculating a sum of sample values of the sub-block and calculating an index referring to the second ALF classifier. For example, as discussed above, it is proposed to first compute the directionality D of the sub-block of luma component, then the sum of sample values of the sub-block is calculated and it is mapped to the index referring to the band-based classifier, and the class index for the sub-block is calculated as C=B*M_{D}+D, where B is the index calculated referring to the band based classifier, M_{D} represents the total number of directionalities D. In one example, for the 2×2 luma block, the directionality D is calculated in the same manner as D₂ in ECM, and B is calculated as B=(sum*5)>>(sample bit depth+2).

In some examples, the processor 1620 may obtain the first feature based on the first ALF classifier by computing an activity value of a sub-block of a luma component and obtaining a total number of the activity value and obtain the second feature based on the second ALF classifier by calculating a sum of sample values of the sub-block and calculating an index referring to the second ALF classifier. For example, as discussed above, it is proposed to first compute the activity value A of the sub-block of luma component, then the sum of sample values of the sub-block is calculated and it is mapped to the index referring to the band-based classifier, and the class index for the sub-block is calculated as C=B*M_{A}+A, where B is the index calculated referring to the band based classifier, M_{A} represents the total number of the activity value A. In one example, for the 2×2 luma block, the activity value A is calculated in the same manner as Â₂ in ECM, and B is calculated as B=(sum*5)>>(sample bit depth+2).

In some examples, the processor 1620 may obtain the first feature based on the first ALF classifier by computing an index of a sub-block of a luma component referring to the first ALF classifier and obtaining a total number of the index and obtain the second feature based on the second ALF classifier by calculating a sum of sample values of the sub-block and calculating an index referring to the second ALF classifier. For example, as discussed above, it is proposed to first compute the index of the sub-block of luma component referring to the edge based classifier, then the sum of sample values of the sub-block is calculated and it is mapped to the index referring to the band based classifier, and the class index for the sub-block is calculated as C=B*M_{E}+E, where B is the index calculated referring to the band based classifier, M_{E} represents the total number of the index calculated referring to the edge based classifier, E is the index calculated referring to the edge based classifier. In one example, for the 2×2 luma block, the index E is calculated in the same manner as C₂ in ECM, and B is calculated as B=(sum*2)>>(sample bit depth+2).

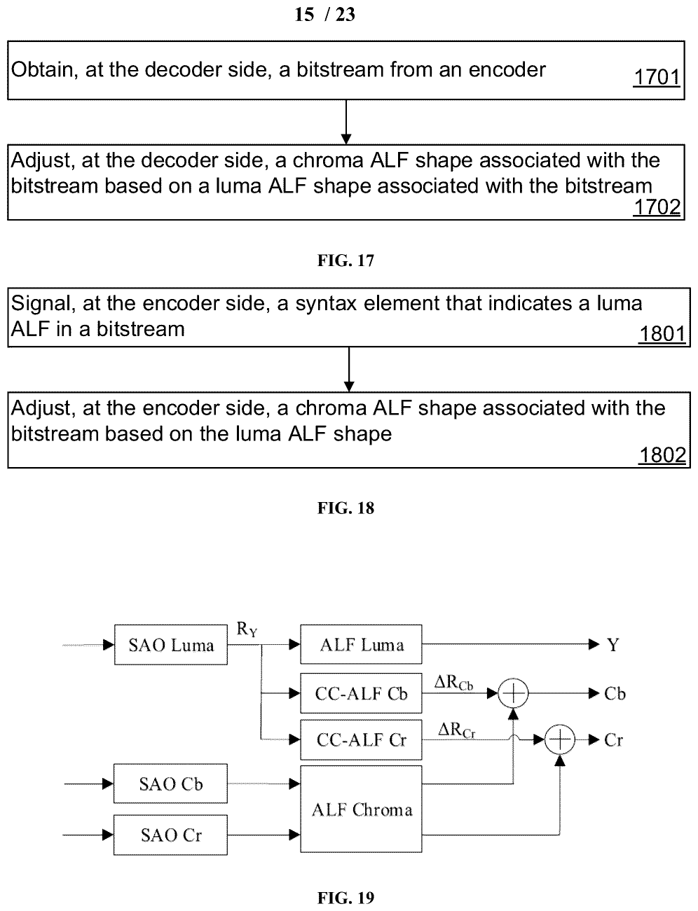

FIG. 17 is a flow chart illustrating a method for video decoding in accordance with some examples of the present disclosure.

In Step 1701, the processor 1620, at the side of a decoder, may obtain a bitstream from an encoder.

In Step 1702, the processor 1620, at the side of the decoder, may adjust a chroma ALF shape associated with the bitstream based on a luma ALF shape associated with the bitstream.

In some examples, the processor 1620, at the side of the decoder, may adjust the chroma ALF shape associated with the bitstream by changing the chroma ALF shape from a diamond shape to a long cross shape, where the luma ALF shape is the long cross shape as shown in FIG. 9, so as to be unified with the luma ALF filter shape.

FIG. 18 is a flow chart illustrating a method for video encoding corresponding to the method for video decoding as shown in FIG. 17 in accordance with some examples of the present disclosure.

In Step 1801, the processor 1620, at the side of an encoder, may signal a syntax element that indicates a luma ALF in a bitstream.

In Step 1802, the processor 1620, at the side of the encoder, may adjust a chroma ALF shape associated with the bitstream based on the luma ALF shape.

In some examples, only one luma filter shape may be enabled in encoder and a flag which identifies the luma filters shape and is transmitted into bitstream is always set to true. Correspondingly, only one chroma filter shape is enabled in encoder and it is aligned with the luma filter shape.

In some examples, the processor 1620, at the side of the encoder, may adjust the chroma ALF shape associated with the bitstream by changing the chroma ALF shape from a diamond shape to a long cross shape, where the luma ALF shape is the long cross shape as shown in FIG. 9, so as to be unified with the luma ALF filter shape.

In some examples, there is provided an apparatus for video coding. The apparatus includes a processor 1620 and a memory 1640 configured to store instructions executable by the processor; where the processor, upon execution of the instructions, is configured to perform any method as illustrated in FIGS. 13-18.

In some other examples, there is provided a non-transitory computer readable storage medium, having instructions stored therein. When the instructions are executed by a processor 1620, the instructions cause the processor to perform any method as illustrated in FIGS. 13-18. In one example, the plurality of programs may be executed by the processor 1620 in the computing environment 1610 to receive (for example, from the video encoder 20 in FIG. 1G) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 2B). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

### CCALF in VVC

### Filter Shapes and Precision

CCALF uses the luma sample values to refine the chroma sample values within the ALF process. As shown in FIG. 19, a linear filtering operation takes the luma sample values as input and generates the correction values for the chroma sample values. The correction is generated independently for each chroma component i, i∈{Cb, Cr} and can be represented by:

$$Δ {R}_{i} ( x , y ) = {\sum }_{( {x}_{0} , {y}_{0} ) ∈ {S}_{i}} {R}_{Y} ( {x}_{C} + {x}_{0} , {y}_{C} + {y}_{0} ) {c}_{i} ( {x}_{0} , {y}_{0} ) ,$$

where (x, y) is the sample location of the chroma component i, (x_{c}, y_{c}) is the luma sample location derived from (x, y), (x₀, y₀) are the filter support offset around (x_{c}, y_{c}), Si is the filter support region in luma for the chroma component i. The luma location (x_{c}, y_{c}) is determined based on the spatial scaling factor between the luma and chroma planes. The sample values in the luma support region are also inputs to the ALF luma stage and correspond to the output of the SAO stage.

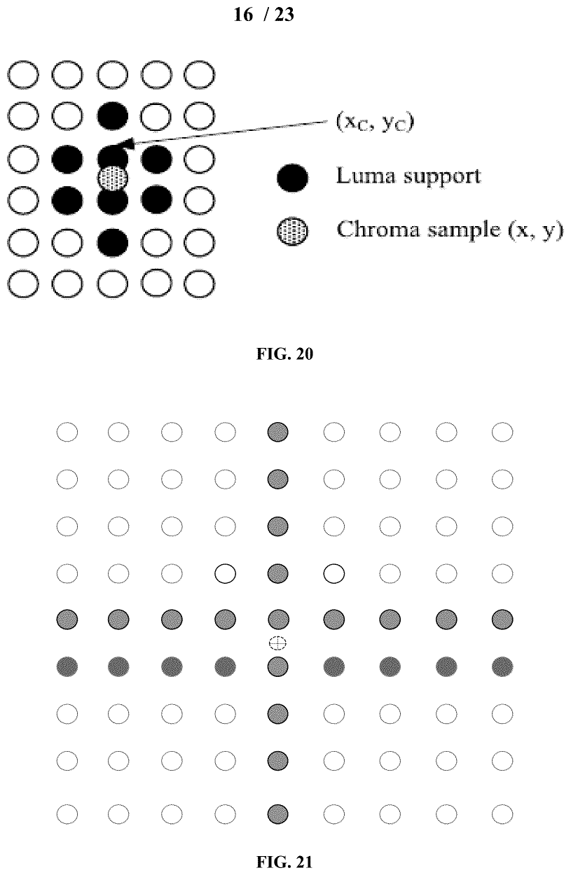

As shown in FIG. 20, the CCALF filter has a diamond shape. As seen in FIG. 20, for a 4:2:0 video sequence, with chroma location type 0, i.e., when the chroma samples are horizontally co-sited with the even numbered columns of the luma samples and vertically interstitial between the rows of the luma samples, the center of the diamond is aligned with a chroma sample location.

CCALF coefficients have a greater degree of flexibility compared to regular ALF coefficients, since no symmetry constraints are enforced. However, two limitations are enforced: (1) To preserve DC neutrality, the sum of CCALF coefficient values is required to be zero. As a result, only seven of the eight CCALF coefficients need to be signalled in the bitstream, and the coefficient at location (x_{c},y_{c}) is derived at the decoder; (2) The absolute values of CCALF coefficients are restricted to be either zero or an integer power of two, specifically {0, 1, 2, 4, 8, 16, 32, 64}. This enables implementations to use variable bit-shift operations in place of multiplications for CCALF, if desired.

### Syntax Design

The maximum number of filters per chroma component of a picture was four in the final design of VVC. A different set of CCALF coefficients can be selected for each CTU of a chroma component. As is the case for the regular ALF coefficients, CCALF coefficients are signalled within an ALF APS. Each ALF APS contains up to four CCALF filters for each chroma component. While CCALF can be enabled at a sequence level, it can only be enabled if ALF is also enabled for the sequence. Similarly, CCALF can be enabled at picture and slice level only if luma ALF is enabled at the corresponding level.

### Line Buffer Reduction

The luma and the chroma line buffer boundaries are four and two samples, respectively, above the CTU boundary. For the 4:2:0 chroma format, this results in line buffer boundaries that are aligned for chroma and luma. However, for 4:2:2 and 4:4:4 chroma formats, the chroma and the luma line buffer boundaries are not aligned with each other. As a result of this misalignment, for 4:2:2 and 4:4:4 chroma formats, CC-ALF is not applied to the rows three and four samples above the CTU boundary.

### CCALF in ECM

The CCALF process uses a linear filter to filter luma sample values and generate a residual correction for the chroma samples. A 25-tap large filter is used in CCALF process, which is illustrated in FIG. 20. For a given slice, the encoder can collect the statistics of the slice, analyze them and can signal up to 16 filters through APS.

Although ALF and CCALF have been improved in ECM, there is room to further improve its performance. First, an online ALF filter in ECM takes spatial neighboring pixels, fixed ALF filter results and spatial neighboring pixels before deblocking filter as input. Other information such as spatial neighboring pixels in prediction signal, spatial neighboring pixels in residual signal, or spatial neighboring pixels before SAO can also be used as an input to the online ALF filter equation, which may benefit the coding performance.

Second, edge based classifiers and band based classifiers are used adaptively for the online ALF filter in ECM. However, these two classifiers may be further combined to provide other classifiers, which may benefit the coding performance.

Third, the filter shape for the chroma ALF is a diamond filter shape in ECM, while the filter shape for luma ALF is long cross shape, such non-unified design may not be optimal from standardization point of view.

Fourth, the edge based classifier and the band based classifier in the ECM only consider the pixel values after SAO. However, after the pixel values before the deblocking filter, prediction signal, residual signal, or before SAO are saved as inputs to the online ALF filter equation, these pixel values can also be utilized to design new classifiers, which may benefit the coding performance.

Fifth, the edge based classifier and band based classifier in ECM only considers luma pixel values after SAO. However, the chroma pixel values can also be utilized to design a new classifier, which may benefit the coding performance.

Sixth, similar to the luma pixel values in before deblocking filter, prediction signal, residual signal, or before SAO are saved as additional online luma ALF filter equation input, the chroma pixel values in before deblocking filter, prediction signal, residual signal, or before SAO can also be saved as additional online chroma ALF filter equation input, which may benefit the coding performance.

Seventh, similar to the luma pixel values in before deblocking filter, prediction signal, residual signal, or before SAO are saved as additional online luma ALF filter equation input, the luma pixel values in before deblocking filter, prediction signal, residual signal, or before SAO can also be saved as additional CCALF filter equation input, which may benefit the coding performance.

Eighth, the classifiers design in ECM only considers the reconstruction pixel values. However, the coding mode information such as whether a coding block is coded with skip mode, whether the coding block is coded with intra, inter P or inter B mode can also be utilized to design classifier, which may benefit the coding performance.

To address the issues, the following methods are provided to further improve the existing design of the ALF. In general, the main features of the proposed technologies in this disclosure are summarized as follows: (1) Online ALF filter takes spatial neighboring pixels in prediction signal, spatial neighboring pixels in residual signal, or spatial neighboring pixels before SAO as additional input; (2) The classifiers which combine the features of edge based classifier and band based classifier are used as additional classifier for online ALF filter; (3) The filter shape for chroma ALF is changed from diamond shape to long cross shape to unify with the filter shape for luma ALF; (4) The classifiers which utilize the pixel values in before deblocking filter, prediction signal, residual signal or before SAO are used as additional classifier for online ALF filter; (5) The classifiers which utilize the chroma pixel values are used as additional classifier for online ALF filter; (6) Online chroma ALF filter takes spatial neighboring pixels in chroma prediction signal, spatial neighboring pixels in chroma residual signal, spatial neighboring pixels before chroma SAO, or spatial neighboring pixels before chroma deblocking as additional input; (7) CCALF filter takes spatial neighboring pixels in luma prediction signal, spatial neighboring pixels in luma residual signal, spatial neighboring pixels before luma SAO, or spatial neighboring pixels before luma deblocking as additional input; and (8) the classifiers which utilize the coding mode information such as whether a coding block is coded with skip mode, whether the coding block is coded with intra, inter P or inter B mode are used as additional classifiers for online ALF filter. It is noted that the disclosed methods may be applied independently or jointly.

### Information in Prediction, Residual or Before SAO Used as Additional ALF Input

According to the one or more embodiments of the disclosure, information in prediction, residual or before SAO are used as additional ALF equation input. Different methods may be used to achieve this goal.

In the first method, it is proposed to take the spatial neighboring pixels in prediction signal as additional ALF equation input. Various filter shapes can be used to extract the information in prediction signal. For example, the filter shape can be 1×1, 3×3 or 5×5 as shown in FIG. 8. Various equation forms can be used to extract the information in prediction signal. In one example, the clipping differences between the surrounding pixels in prediction signal and current pixel are used as ALF equation input. In another example, the clipping differences between the surrounding pixels in prediction signal and the collocated pixel in prediction signal, the clipping difference between the collocated pixel in prediction signal and current pixel are used as ALF equation input.

In the second method, it is proposed to take the spatial neighboring pixels in residual signal as additional ALF equation input. Various filter shapes can be used to extract the information in residual signal. For example, the filter shape can be 1×1, 3×3 or 5×5 as shown in FIG. 8. Various equation forms can be used to extract the information in residual signal. In one example, the clipping results of the collocated pixel in residual signal are used as ALF equation input.

In the third method, it is proposed to take the spatial neighboring pixels in before SAO signal as additional ALF equation input. Various filter shapes can be used to extract the information in before SAO signal. For example, the filter shape can be 1×1, 3×3 or 5×5 as shown in FIG. 8. Various equation forms can be used to extract the information in before SAO signal. In one example, the clipping differences between the surrounding pixels in before SAO signal and current pixel are used as ALF equation input. In another example, the clipping differences between the surrounding pixels in before SAO signal and the collocated pixel in before SAO signal, the clipping difference between the collocated pixel in before SAO signal and current pixel are used as ALF equation input.

In the fourth method, it is proposed to take the information in prediction, residual or before SAO signal as ALF equation input. The utilization method proposed in the first, second and third method can be combined to achieve the fourth method.

### New Classifiers Combined the Features of Edge Based Classifier and Band Based Classifier

According to the one or more embodiments of the disclosure, the features of edge based classifier and band based classifier are combined to derive new classifiers for online ALF filter. Different methods may be used to achieve this goal.

In the first method, it is proposed to first compute the directionality D of the sub-block of luma component, then the sum of sample values of the sub-block is calculated and it is mapped to the index referring to the band based classifier, and the class index for the sub-block is calculated as

$$C = B * {M}_{D} + D \qquad ( 24 )$$

where B is the index calculated referring to the band based classifier, M_{D} represents the total number of directionalities D. In one example, for the 2×2 luma block, the directionality D is calculated the same to D₂ in ECM, and B is calculated as

$$B = ( sum * 5 ) >> ( sample bit depth + 2 ) \qquad ( 25 )$$

In the second method, it is proposed to first compute the activity value A of the sub-block of luma component, then the sum of sample values of the sub-block is calculated and it is mapped to the index referring to the band based classifier, and the class index for the sub-block is calculated as

$$C = B * {M}_{A} + A \qquad ( 26 )$$

where B is the index calculated referring to the band based classifier, M_{A} represents the total number of the activity value A. In one example, for the 2×2 luma block, the activity value A is calculated the same to Â₂ in ECM, and B is calculated as

$$B = ( sum * 5 ) >> ( sample bit depth + 2 ) \qquad ( 27 )$$

In the third method, it is proposed to first compute the index of the sub-block of luma component referring to the edge based classifier, then the sum of sample values of the sub-block is calculated and it is mapped to the index referring to the band based classifier, and the class index for the sub-block is calculated as

$$C = B * {M}_{E} + E \qquad ( 28 )$$

where B is the index calculated referring to the band based classifier, M_{E} represents the total number of the index calculated referring to the edge based classifier, E is the index calculated referring to the edge based classifier. In one example, for the 2×2 luma block, the index E is calculated the same to C₂ in ECM, and B is calculated as

$$B = ( sum * 2 ) >> ( sample bit depth + 2 ) \qquad ( 29 )$$

Adjust the Chroma ALF Filter Shape to Unify with Luma ALF Filter Shape

In the third aspect of this disclosure, it is proposed to change the chroma ALF filter shape from diamond shape to long cross shape as shown in FIG. 9, which is unified with the luma ALF filter shape.

### Online ALF Filter Inputs

FIG. 11 shows the online ALF filter inputs where the fixed filter output samples are obtained by feeding the reconstructed samples right after SAO into the offline trained fixed filters. Online ALF filter can take reconstructed samples right prior to SAO, i.e., right before SAO as additional inputs, or take prediction samples as additional inputs, or take both reconstructed samples right before SAO and prediction samples as additional inputs. As shown in FIG. 11, the various inputs of the online ALF filter may include reconstructed samples right before SAO and prediction samples, in addition to reconstructed samples right after SAO, fixed filter output samples, and reconstructed samples before DBF.

### Filter Shapes Applied to Prediction Samples

FIG. 12 shows 1×1 and 3×3 filter shapes that are applied to the prediction samples of the ALF in accordance with some examples of the present disclosure. In some examples, assuming that the prediction samples are used as additional inputs for online ALF filter, a filtered sample is derived as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] + [ {\sum }_{i = 22}^{24} {c}_{i} ( {h}_{i , 0} + {h}_{i , 1} ) ] + [ {\sum }_{i = 25}^{N} {c}_{i} ( {p}_{i , 0} + {p}_{i , 1} ) ] \qquad ( 30 )$$

where R(x,y) indicates the current sample; f^{i,j} indicates the clipped difference between a neighboring chroma sample, associated with a chroma signal, right after SAO and R(x,y); gᵢ indicates the clipped difference between a fixed filter output sample and R(x, y); h_{i,j} indicates the clipped difference between a neighboring chroma sample right, associated with a chroma signal, before DBF and R(x, y). p_{i,j} is the clipped difference between a neighboring chroma sample, associated with a chroma signal (e.g., a chroma prediction signal), and a current sample R(x, y). The filter coefficients cᵢ, i=0, . . . N, are signalled. Different filter shapes, for example, 1×1 and 3×3 diamond shapes as shown in FIG. 12, can be used.

When the reconstructed samples right before SAO are used as additional inputs for online ALF filter, the prediction samples in above equation can be directly replaced with the reconstructed samples right before SAO.

### New Classifiers Utilized the Pixel Values in Before Deblocking Filter

According to the one or more embodiments of the disclosure, the pixel values in before deblocking filter are utilized to derive new classifiers for online ALF filter. Different methods may be used to achieve this goal.

In the first method, it is proposed to first compute the directionality D of the sub-block of luma component, then the sum of difference values between sample in after SAO and collocated sample in before deblocking filter of the sub-block is calculated and it is mapped to the difference index, and the class index for the sub-block is calculated as

$$C = D i f * {M}_{D} + D \qquad ( 30 a )$$

where Dif is the difference index, M_{D} represents the total number of directionalities D. In one example, for the 2×2 luma block, the directionality D is calculated the same to D₂ in ECM, and Dif is calculated as

$$Dif = {sum}_{D i f} > 0 ? 2 : ( {sum}_{D i f} < 0 ? 0 : 1 ) \qquad ( 31 )$$

In the second method, it is proposed to first compute the activity value A of the sub-block of luma component, then the sum of difference values between sample in after SAO and collocated sample in before deblocking filter of the sub-block is calculated and it is mapped to the difference index, and the class index for the sub-block is calculated as

$$C = D i f * {M}_{A} + A \qquad ( 32 )$$

where Dif is the difference index, M_{A} represents the total number of the activity value A. In one example, for the 2×2 luma block, the activity value A is calculated the same to Â₂ in ECM, and Dif is calculated as in equation (31).

In the third method, it is proposed to first compute the index of the sub-block of luma component referring to the edge based classifier, then the sum of difference values between sample in after SAO and collocated sample in before deblocking filter of the sub-block is calculated and it is mapped to the difference index, and the class index for the sub-block is calculated as

$$C = D i f * {M}_{E} + E \qquad ( 33 )$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as in equation (31).

In the fourth method, it is proposed to first compute the band index B of the sub-block of luma component, then the sum of difference values between sample in after SAO and collocated sample in before deblocking filter of the sub-block is calculated and it is mapped to the difference index, and the class index for the sub-block is calculated as

$$C = D i f * {M}_{B} + B \qquad ( 34 )$$

where Dif is the difference index, M_{B} represents the total number of the band value. In one example, for the 2×2 luma block, the band index B is calculated as

$$B = ( sum * 8 ) >> ( sample bit depth + 2 ) \qquad ( 35 )$$

and Dif is calculated as in equation (31).

In the fifth method, it is proposed to compute the sum of difference values between sample in after SAO and collocated sample in before deblocking filter of the sub-block, then the sum of difference values is mapped to the difference index and the difference index is used as the class index.

In the sixth method, it is proposed to calculate the edged based classifier or band based classifier based on the sample values in before deblocking filter, where the calculation method is same to original edge based classifier or band based classifier calculated based on the sample values after SAO.

### New Classifiers Utilized the Pixel Values in Prediction Signal

According to the one or more embodiments of the disclosure, the pixel values in prediction signal are utilized to derive new classifiers for online ALF filter. Different methods may be used to achieve this goal.

In the first method, it is proposed to first compute the directionality D of the sub-block of luma component, then the sum of difference values between sample in after SAO and collocated sample in prediction signal of the sub-block is calculated and it is mapped to the difference index, and the class index for the sub-block is calculated as

$$C = D i f * {M}_{D} + D \qquad ( 36 )$$

where Dif is the difference index, M_{D} represents the total number of directionalities D. In one example, for the 2×2 luma block, the directionality D is calculated the same to D₂ in ECM, and Dif is calculated as

$$Dif = {sum}_{D i f} > 0 ? 2 : ( {sum}_{D i f} < 0 ? 0 : 1 ) \qquad ( 37 )$$

In the second method, it is proposed to first compute the activity value A of the sub-block of luma component, then the sum of difference values between sample in after SAO and collocated sample in prediction signal of the sub-block is calculated and it is mapped to the difference index, and the class index for the sub-block is calculated as

$$C = D i f * {M}_{A} + A \qquad ( 38 )$$

where Dif is the difference index, M_{A} represents the total number of the activity value A. In one example, for the 2×2 luma block, the activity value A is calculated the same to Â₂ in ECM, and Dif is calculated as in equation (37).

In the third method, it is proposed to first compute the index of the sub-block of luma component referring to the edge based classifier, then the sum of difference values between sample in after SAO and collocated sample in prediction signal of the sub-block is calculated and it is mapped to the difference index, and the class index for the sub-block is calculated as

$$C = D i f * {M}_{E} + E \qquad ( 39 )$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as in equation (37).

In the fourth method, it is proposed to first compute the band index B of the sub-block of luma component, then the sum of difference values between sample in after SAO and collocated sample in prediction signal of the sub-block is calculated and it is mapped to the difference index, and the class index for the sub-block is calculated as

$$C = D i f * {M}_{B} + B \qquad ( 40 )$$

where Dif is the difference index, M_{B} represents the total number of the band value.

In one example, for the 2×2 luma block, the band index B is calculated as

$$B = ( sum * 8 ) >> ( sample bit depth + 2 ) \qquad ( 41 )$$

and Dif is calculated as in equation (37).

In the fifth method, it is proposed to compute the sum of difference values between sample in after SAO and collocated sample in prediction signal of the sub-block, then the sum of difference values is mapped to the difference index and the difference index is used as the class index.

In the sixth method, it is proposed to calculate the edged based classifier or band based classifier based on the sample values in prediction signal, where the calculation method is same to original edge based classifier or band based classifier calculated based on the sample values after SAO.

### New Classifiers Utilized the Pixel Values in Residual Signal

According to the one or more embodiments of the disclosure, the pixel values in residual signal are utilized to derive new classifiers for online ALF filter. Different methods may be used to achieve this goal.

In the first method, it is proposed to first compute the directionality D of the sub-block of luma component, then the sum of pixel values in residual signal of the sub-block is calculated and it is mapped to the residual index, and the class index for the sub-block is calculated as

$$C = R e s i * {M}_{D} + D \qquad ( 42 )$$

where Resi is the residual index, M_{D} represents the total number of directionalities D. In one example, for the 2×2 luma block, the directionality D is calculated the same to D₂ in ECM, and Resi is calculated as

$$Resi = {sum}_{Resi} > 0 ? 2 : ( {sum}_{Res i} < 0 ? 0 : 1 ) \qquad ( 43 )$$

In the second method, it is proposed to first compute the activity value A of the sub-block of luma component, then the sum of pixel values in residual signal of the sub-block is calculated and it is mapped to the residual index, and the class index for the sub-block is calculated as

$$C = R e s i * {M}_{A} + A \qquad ( 44 )$$

where Resi is the residual index, M_{A} represents the total number of the activity value A. In one example, for the 2×2 luma block, the activity value A is calculated the same to Â₂ in ECM, and Resi is calculated as in equation (43).

In the third method, it is proposed to first compute the index of the sub-block of luma component referring to the edge based classifier, then the sum of pixel values in residual signal of the sub-block is calculated and it is mapped to the residual index, and the class index for the sub-block is calculated as

$$C = Resi * {M}_{E} + E \qquad ( 45 )$$

where Resi is the residual index, M_{E} represents the total number of the index calculated referring to the edge based classifier, E is the index calculated referring to the edge based classifier. In one example, for the 2×2 luma block, the index E is calculated the same to C₂ in ECM, and Resi is calculated as in equation (43).

In the fourth method, it is proposed to first compute the band index B of the sub-block of luma component, then the sum of pixel values in residual signal of the sub-block is calculated and it is mapped to the residual index, and the class index for the sub-block is calculated as

$$C = Resi * {M}_{B} + B \qquad ( 46 )$$

where Resi is the residual index, M_{B} represents the total number of the band value. In one example, for the 2×2 luma block, the band index B is calculated as

$$B = ( sum * 8 ) >> ( sample bit Depth + 2 ) \qquad ( 47 )$$

and Resi is calculated as in equation (43).

In the fifth method, it is proposed to compute the sum of pixel values in residual signal of the sub-block, then the sum of residual values is mapped to the residual index and the residual index is used as the class index.

### New Classifiers Utilized the Pixel Values in Before SAO

According to the one or more embodiments of the disclosure, the pixel values in before SAO are utilized to derive new classifiers for online ALF filter. Different methods may be used to achieve this goal.

In the first method, it is proposed to first compute the directionality D of the sub-block of luma component, then the sum of difference values between sample in after SAO and collocated sample in before SAO of the sub-block is calculated and it is mapped to the difference index, and the class index for the sub-block is calculated as

$$C = Dif * {M}_{D} + D \qquad ( 48 )$$

where Dif is the difference index, M_{D} represents the total number of directionalities D. In one example, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) \qquad ( 49 )$$

In the second method, it is proposed to first compute the activity value A of the sub-block of luma component, then the sum of difference values between sample in after SAO and collocated sample in before SAO of the sub-block is calculated and it is mapped to the difference index, and the class index for the sub-block is calculated as

$$C = Dif * {M}_{A} + A \qquad ( 50 )$$

where Dif is the difference index, M_{A} represents the total number of the activity value A. In one example, for the 2×2 luma block, the activity value A is calculated the same to Â₂ in ECM, and Dif is calculated as in equation (49).

In the third method, it is proposed to first compute the index of the sub-block of luma component referring to the edge based classifier, then the sum of difference values between sample in after SAO and collocated sample in before SAO of the sub-block is calculated and it is mapped to the difference index, and the class index for the sub-block is calculated as

$$C = Dif * {M}_{E} + E \qquad ( 51 )$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as in equation (49).

In the fourth method, it is proposed to first compute the band index B of the sub-block of luma component, then the sum of difference values between sample in after SAO and collocated sample in before SAO of the sub-block is calculated and it is mapped to the difference index, and the class index for the sub-block is calculated as

$$C = Dif * {M}_{B} + B \qquad ( 52 )$$

where Dif is the difference index, M_{B} represents the total number of the band value. In one example, for the 2×2 luma block, the band index B is calculated as

$$B = ( sum * 8 ) >> ( sample bit depth + 2 ) \qquad ( 53 )$$

and Dif is calculated as in equation (49).

In the fifth method, it is proposed to compute the sum of difference values between sample in after SAO and collocated sample in before SAO of the sub-block, then the sum of difference values is mapped to the difference index and the difference index is used as the class index.

In the sixth method, it is proposed to calculate the edged based classifier or band based classifier based on the sample values in before SAO, where the calculation method is same to original edge based classifier or band based classifier calculated based on the sample values after SAO.

### New Classifiers Utilized Chroma Pixel Values

According to the one or more embodiments of the disclosure, the chroma pixel values are utilized to derive new classifiers for online ALF filter. Different methods may be used to achieve this goal.

In the first method, it is proposed to first compute the band index B_{Y} of the sub-block of luma component, then the band index B_{U} and B_{V} of the corresponding U and V components are computed, and the class index for the sub-block is calculated as

$$C = {B}_{Y} * {M}_{U} * {M}_{V} + {B}_{U} * {M}_{V} + {B}_{V} \qquad ( 54 )$$

where B_{Y}, B_{U} and B_{V} are the Y, U and V index calculated referring to the band based classifier, M_{U} and M_{V} represent the total number of the U and V band index value. In one example, for the 2×2 luma block, the B_{Y}, B_{U} and B_{V} are calculated as

$${B}_{Y} = ( sum Y * 6 ) >> ( sample bit depth + 2 ) \qquad ( 55 )$$

$${B}_{U} = ( sum U * 2 ) >> ( sample bit depth + 2 ) \qquad ( 56 )$$

$${B}_{V} = ( sum V * 2 ) >> ( sample bit depth + 2 ) \qquad ( 57 )$$

### Chroma Information in Before Deblocking, Prediction, Residual or Before SAO Used as Additional Chroma ALF Input

According to the one or more embodiments of the disclosure, chroma information in before deblocking, prediction, residual or before SAO are used as additional chroma ALF equation inputs. Different methods may be used to achieve this goal.

In the first method, it is proposed to take the spatial neighboring pixels in chroma prediction signal as additional chroma ALF equation inputs. Various filter shapes can be used to extract the information in chroma prediction signal. For example, the filter shape can be 1×1, 3×3 or 5×5 as shown in FIG. 8. Various equation forms can be used to extract the information in chroma prediction signal. In one example, the clipping differences between the surrounding pixels in chroma prediction signal and current chroma pixel are used as chroma ALF equation inputs. In another example, the clipping differences between the surrounding pixels in chroma prediction signal and the collocated pixel in chroma prediction signal, the clipping difference between the collocated pixel in chroma prediction signal and current chroma pixel are used as chroma ALF equation inputs.

In the second method, it is proposed to take the spatial neighboring pixels in chroma residual signal as additional chroma ALF equation inputs. Various filter shapes can be used to extract the information in chroma residual signal. For example, the filter shape can be 1×1, 3×3 or 5×5 as shown in FIG. 8. Various equation forms can be used to extract the information in chroma residual signal. In one example, the clipping results of the collocated pixel in chroma residual signal are used as chroma ALF equation inputs.

In the third method, it is proposed to take the spatial neighboring pixels in before chroma SAO signal as additional chroma ALF equation inputs. Various filter shapes can be used to extract the information in before chroma SAO signal. For example, the filter shape can be 1×1, 3×3 or 5×5 as shown in FIG. 8. Various equation forms can be used to extract the information in before chroma SAO signal. In one example, the clipping differences between the surrounding pixels in before chroma SAO signal and current chroma pixel are used as chroma ALF equation inputs. In another example, the clipping differences between the surrounding pixels in before chroma SAO signal and the collocated pixel in before chroma SAO signal, the clipping difference between the collocated pixel in before chroma SAO signal and current chroma pixel are used as chroma ALF equation inputs.

In the fourth method, it is proposed to take the spatial neighboring pixels in before chroma deblocking signal as additional chroma ALF equation inputs. Various filter shapes can be used to extract the information in before chroma deblocking signal. For example, the filter shape can be 1×1, 3×3 or 5×5 as shown in FIG. 8. Various equation forms can be used to extract the information in before chroma deblocking signal. In one example, the clipping differences between the surrounding pixels in before chroma deblocking signal and current chroma pixel are used as chroma ALF equation inputs. In another example, the clipping differences between the surrounding pixels in before chroma deblocking signal and the collocated pixel in before chroma deblocking signal, the clipping difference between the collocated pixel in before chroma deblocking signal and current chroma pixel are used as chroma ALF equation inputs.

In the fifth method, it is proposed to take the information in chroma prediction, residual, before SAO or before deblocking signal as chroma ALF equation inputs. The utilization method proposed in the first, second third, fourth method can be combined to achieve the fifth method.

### Luma Information in Before Deblocking, Prediction, Residual or Before SAO Used as Additional CCALF Input

According to the one or more embodiments of the disclosure, luma information in before deblocking, prediction, residual or before SAO are used as additional CCALF equation inputs. Different methods may be used to achieve this goal.

In the first method, it is proposed to take the spatial neighboring pixels in luma prediction signal as additional CCALF equation inputs. Various filter shapes can be used to extract the information in luma prediction signal. For example, the filter shape can be 3×4 as shown in FIG. 20. Various equation forms can be used to extract the information in luma prediction signal. In one example, the differences between the surrounding pixels in luma prediction signal and current corresponding luma pixel are used as CCALF equation inputs. In another example, the differences between the surrounding pixels in luma prediction signal and the collocated pixel in current corresponding luma prediction signal, the difference between the collocated pixel in current corresponding luma prediction signal and current corresponding luma pixel are used as CCALF equation inputs.

In the second method, it is proposed to take the spatial neighboring pixels in luma residual signal as additional CCALF equation inputs. Various filter shapes can be used to extract the information in luma residual signal. For example, the filter shape can be 3×4 as shown in FIG. 20. Various equation forms can be used to extract the information in luma residual signal. In one or more examples, the collocated pixels in luma residual signal are used as CCALF equation inputs.

In the third method, it is proposed to take the spatial neighboring pixels in before luma SAO signal as additional CCALF equation inputs. Various filter shapes can be used to extract the information in before luma SAO signal. For example, the filter shape can be 3×4 as shown in FIG. 20. Various equation forms can be used to extract the information in before luma SAO signal. In one example, the differences between the surrounding pixels in before luma SAO signal and current corresponding luma pixel are used as CCALF equation inputs. In another example, the differences between the surrounding pixels in before luma SAO signal and the collocated pixel in current corresponding before luma SAO signal, the difference between the collocated pixel in current corresponding before luma SAO signal and current corresponding luma pixel are used as CCALF equation inputs.

In the fourth method, it is proposed to take the spatial neighboring pixels in before luma deblocking signal as additional CCALF equation inputs. Various filter shapes can be used to extract the information in before luma deblocking signal. For example, the filter shape can be 3×4 as shown in FIG. 20. Various equation forms can be used to extract the information in before luma deblocking signal. In one example, the differences between the surrounding pixels in before luma deblocking signal and current corresponding luma pixel are used as CCALF equation inputs. In another example, the differences between the surrounding pixels in before luma deblocking signal and the collocated pixel in current corresponding before luma deblocking signal, the difference between the collocated pixel in current corresponding before luma deblocking signal and current corresponding luma pixel are used as CCALF equation inputs.

In the fifth method, it is proposed to take the information in luma prediction, residual, before SAO or before deblocking signal as CCALF equation inputs. The utilization method proposed in the first, second third, fourth method can be combined to achieve the fifth method.

### New Classifiers Utilized the Coding Mode Information

According to the one or more embodiments of the disclosure, the coding mode information such as whether the coding block is coded with skip mode, whether the coding block is coded with intra, inter P or inter B mode, is utilized to derive new classifiers for online ALF filter. Different methods may be used to achieve this goal.

In the first method, it is proposed to record whether the coding block is coded with skip mode during the encoding and decoding process, then this information is utilized to design a new classifier. In one example, the classifier which has 2 classes corresponding to the skip mode is true or false is added as a new classifier. In another example, the classifier which combines the skip mode information with EO or BO is added as a new classifier.

In the second method, it is proposed to record whether the coding block is coded with intra mode, inter P mode, or inter B mode during the encoding and decoding process, then this information is utilized to design a new classifier. In one example, the classifier which has 3 classes corresponding to the intra mode, inter P mode or inter B mode is added as a new classifier. In another example, the classifier which combines the intra, inter P or inter B mode information with EO or BO is added as a new classifier.

In the third method, it is proposed to take both the coding mode information whether the coding block is coded with skip mode, whether the coding block is coded with intra, inter P or inter B mode to design the new classifier. The utilization method proposed in the first and second method can be combined to achieve the third method.

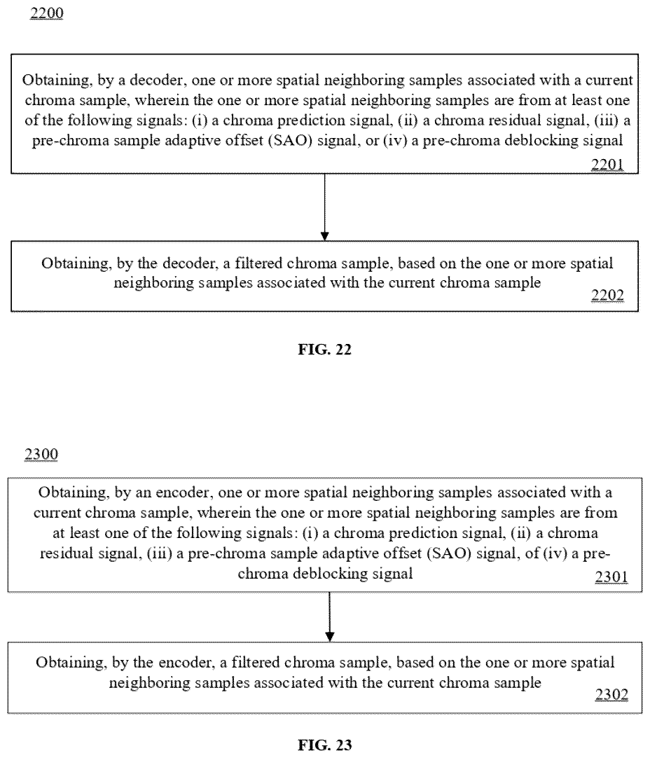

FIG. 22 is a flowchart illustrating a method 2200 for video decoding in accordance with some examples of the present disclosure. At step 2201, the method 2200 includes obtaining, by a decoder, one or more spatial neighboring samples associated with a current chroma sample, wherein the one or more spatial neighboring samples are from at least one of the following signals: (i) a chroma prediction signal, (ii) a chroma residual signal, (iii) a pre-chroma sample adaptive offset (SAO) signal, or (iv) a pre-chroma deblocking signal. At step 2202, the method 2200 includes obtaining, by the decoder, a filtered chroma sample, based on the one or more spatial neighboring samples associated with the current chroma sample.

In one example, the method 2200 further includes obtaining, by the decoder, an adaptive loop filter (ALF) filtered chroma sample based on the one or more spatial neighboring samples associated with the chroma prediction signal and one or more filter coefficients, wherein the one or more filter coefficients are associated with different filter shapes.

In one example, the method 2200 further includes obtaining, by the decoder, clipped results based on differences between one or more spatial neighboring samples from the chroma prediction signal and the current chroma sample; and deriving, by the decoder, a chroma ALF input based on the clipped results.

In one example, the method 2200 further includes: obtaining, by the decoder, clipped results based on differences between surrounding samples in the chroma prediction signal and collocated samples in the chroma prediction signal, and clipped results based on differences between collocated samples in chroma prediction signal and current chroma sample; and deriving, by the decoder, a chroma ALF input based on the clipped results.

In one example, the method 2200 further includes: obtaining, by the decoder, an adaptive loop filter (ALF) filtered chroma sample based on the one or more spatial neighboring samples associated with the chroma residual signal and one or more filter coefficients, wherein the one or more filter coefficients are associated with different filter shapes.

In one example, the method 2200 further includes: obtaining, by the decoder, clipped results of one or more spatial neighboring samples in the chroma residual signal; and deriving, by the decoder, a chroma ALF input based on the clipped results.

In one example, the method 2200 further includes: obtaining, by the decoder, an adaptive loop filter (ALF) filtered chroma sample based on the one or more spatial neighboring samples associated with the pre-chroma SAO signal and one or more filter coefficients, wherein the one or more filter coefficients are associated with different filter shapes.

In one example, the method 2200 further includes: obtaining, by the decoder, clipped results based on differences between one or more spatial neighboring samples from the pre-chroma SAO signal and the current chroma sample; and deriving, by the decoder, a chroma ALF input based on the clipped results.

In one example, the method 2200 further includes: obtaining, by the decoder, clipped results based on differences between surrounding samples from the pre-chroma SAO signal and collocated samples from the pre-chroma SAO signal, and clipped results based on differences between collocated samples in pre-chroma SAO signal and current chroma sample; and deriving, by the decoder, a chroma ALF input based on the clipped results.

In one example, the method 2200 further includes: obtaining, by the decoder, an adaptive loop filter (ALF) filtered chroma sample based on the one or more spatial neighboring samples associated with the pre-chroma deblocking signal and one or more filter coefficients, wherein the one or more filter coefficients are associated with different filter shapes.

In one example, the method 2200 further includes: obtaining, by the decoder, clipped results based on differences between one or more spatial neighboring samples in the pre-chroma deblocking signal and the current chroma sample; and deriving, by the decoder, a chroma ALF input based on the clipped results.

In one example, the method 2200 further includes: obtaining, by the decoder, clipped results based on differences between one or more spatial neighboring samples from the pre-chroma deblocking signal and collocated samples from the pre-chroma deblocking signal, and clipped results based on differences between collocated samples in pre-chroma deblocking signal and current chroma sample; and deriving, by the decoder, a chroma ALF input based on the clipped results.

In one example, the one or more surrounding samples are from a combination of following signals: (i) the chroma prediction signal, (ii) the chroma residual signal, (iii) the pre-chroma sample adaptive offset (SAO) signal, or (iv) the pre-chroma deblocking signal.

FIG. 23 is a flowchart illustrating a method 2300 for video encoding in accordance with some examples of the present disclosure. At step 2301, the method 2300 includes obtaining, by an encoder, one or more spatial neighboring samples associated with a current chroma sample, wherein the one or more spatial neighboring samples are from at least one of the following signals: (i) a chroma prediction signal, (ii) a chroma residual signal, (iii) a pre-chroma sample adaptive offset (SAO) signal, of (iv) a pre-chroma deblocking signal. At step 2302, the method 2300 includes obtaining, by the encoder, a filtered chroma sample, based on the one or more spatial neighboring samples associated with the current chroma sample.

In one example, the method 2300 further includes: obtaining, by the encoder, an adaptive loop filter (ALF) filtered chroma sample based on the one or more spatial neighboring samples associated with the chroma prediction signal and one or more filter coefficients, wherein the one or more filter coefficients are associated with different filter shapes.

In one example, the method 2300 further includes: obtaining, by the encoder, clipped results based on differences between one or more spatial neighboring samples in the chroma prediction signal and the current chroma sample; and deriving, by the encoder, a chroma ALF input based on the clipped results.

In one example, the method 2300 further includes: obtaining, by the encoder, clipped results based on differences between surrounding samples in the chroma prediction signal and collocated samples in the chroma prediction signal, and clipped results based on differences between collocated samples in chroma prediction signal and current chroma sample; and deriving, by the encoder, a chroma ALFinput based on the clipped results.

In one example, the method 2300 further includes: obtaining, by the encoder, an adaptive loop filter (ALF) filtered chroma sample based on the one or more spatial neighboring samples associated with the chroma residual signal and one or more filter coefficients, wherein the one or more filter coefficients are associated with different filter shapes.

In one example, the method 2300 further includes: obtaining, by the encoder, clipped results of one or more spatial neighboring samples from the chroma residual signal; and deriving, by the encoder, a chroma ALF input based on the clipped results.

In one example, the method 2300 further includes: obtaining, by the encoder, an adaptive loop filter (ALF) filtered chroma sample based on the one or more spatial neighboring samples associated with the pre-chroma SAO signal and one or more filter coefficients, wherein the one or more filter coefficients are associated with different filter shapes.

In one example, the method 2300 further includes: obtaining, by the encoder, clipped results based on differences between one or more spatial neighboring samples from the pre-chroma SAO signal and the current chroma sample; and deriving, by the encoder, a chroma ALF input based on the clipped results.

In one example, the method 2300 further includes: obtaining, by the encoder, clipped results based on differences between surrounding samples from the pre-chroma SAO signal and collocated samples from the pre-chroma SAO signal, and clipped results based on differences between collocated samples in pre-chroma SAO signal and current chroma sample; and deriving, by the encoder, a chroma ALF input based on the clipped results.

In one example, the method 2300 further includes: obtaining, by the encoder, an adaptive loop filter (ALF) filtered chroma sample based on the one or more spatial neighboring samples associated with the pre-chroma deblocking signal and one or more filter coefficients, wherein the one or more filter coefficients are associated with different filter shapes.

In one example, the method 2300 further includes: obtaining, by the encoder, clipped results based on differences between one or more spatial neighboring samples in the pre-chroma deblocking signal and the current chroma sample; and deriving, by the encoder, a chroma ALF input based on the clipped results.

In one example, the method 2300 further includes: obtaining, by the encoder, clipped results based on differences between one or more spatial neighboring samples in the pre-chroma deblocking signal and collocated samples in pre-chroma deblocking signal, and clipped results based on differences between collocated samples in pre-chroma deblocking signal and current chroma sample; and deriving, by the encoder, a chroma ALF input based on the clipped results.

In one example, the one or more surrounding samples are from a combination of following signals: (i) the chroma prediction signal, (ii) the chroma residual signal, (iii) the pre-chroma SAO signal, or (iv) the pre-chroma deblocking signal.

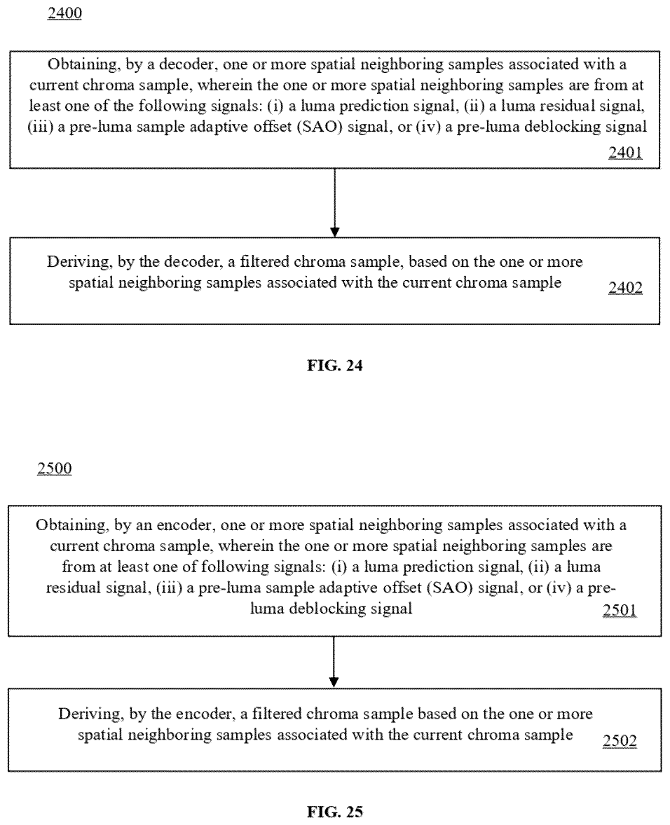

FIG. 24 is a flowchart illustrating a method 2400 for video decoding in accordance with some examples of the present disclosure. At step 2401, the method 2400 includes obtaining, by a decoder, one or more spatial neighboring samples associated with a current chroma sample, wherein the one or more spatial neighboring samples are from at least one of following signals: (i) a luma prediction signal, (ii) a luma residual signal, (iii) a pre-luma sample adaptive offset (SAO) signal, or (iv) a pre-luma deblocking signal. At step 2402, the method 2400 includes obtaining, by the decoder, a filtered chroma sample, based on the one or more spatial neighboring samples associated with the current chroma sample.

In one example, the method 2400 further includes: obtaining, by the decoder, a cross-component adaptive loop filter (CCALF) filtered chroma sample based on the one or more spatial neighboring samples associated with the luma prediction signal and one or more filter coefficients, wherein the one or more filter coefficients are associated with different filter shapes.

In one example, the method 2400 further includes: obtaining, by the decoder, clipped results based on differences between one or more spatial neighboring samples from the luma prediction signal and the current corresponding luma sample; and deriving, by the decoder, the CCALF input based on the clipped results.

In one example, the method 2400 further includes: obtaining, by the decoder, clipped results based on differences between surrounding samples in the luma prediction signal and collocated samples in the luma prediction signal, and clipped results based on differences between collocated samples in the luma prediction signal and current corresponding luma sample; and deriving, by the decoder, the CCALF input based on the clipped results.

In one example, the method 2400 further includes: obtaining, by the decoder, a cross-component adaptive loop filter (CCALF) filtered chroma sample based on the one or more spatial neighboring samples associated with the luma residual signal and one or more filter coefficients, wherein the one or more filter coefficients are associated with different filter shapes.

In one example, the method 2400 further includes: obtaining, by the decoder, clipped results of one or more spatial neighboring samples in the luma residual signal; and deriving, by the decoder, the CCALF input based on the clipped results.

In one example, the method 2400 further includes: obtaining, by the decoder, a cross-component adaptive loop filter (CCALF) filtered chroma sample based on the one or more spatial neighboring samples associated with the pre-luma SAO signal and one or more filter coefficients, wherein the one or more filter coefficients are associated with different filter shapes.

In one example, the method 2400 further includes: obtaining, by the decoder, clipped results based on differences between one or more spatial neighboring samples in the pre-luma SAO signal and the current corresponding luma sample; and deriving, by the decoder, the CCALF input based on the clipped results.

In one example, the method 2400 further includes: obtaining, by the decoder, clipped results based on differences between surrounding samples from the pre-luma SAO signal and collocated samples from the pre-luma SAO signal, and clipped results based on differences between collocated samples in the pre-luma SAO signal and current corresponding luma sample; and deriving, by the decoder, the CCALF input based on the clipped results.

In one example, the method 2400 further includes: obtaining, by the decoder, a cross-component adaptive loop filter (CCALF) filtered chroma sample based on the one or more spatial neighboring samples associated with the pre-luma deblocking signal and one or more filter coefficients, wherein the one or more filter coefficients are associated with different filter shapes.

In one example, the method 2400 further includes: obtaining, by the decoder, clipped results based on differences between one or more spatial neighboring samples from the pre-luma deblocking signal and the current corresponding luma sample; and deriving, by the decoder, the CCALF input based on the clipped results.

In one example, the method 2400 further includes: obtaining, by the decoder, clipped results based on differences between one or more spatial neighboring samples from the pre-luma deblocking signal and collocated samples from the pre-luma deblocking signal, and clipped results based on differences between collocated samples in the pre-luma deblocking signal and current corresponding luma sample; and deriving, by the decoder, the CCALF input based on the clipped results.

In one example, the neighboring samples are from a combination of following signals: (i) the luma prediction signal; (ii) the luma residual signal; (iii) the pre-luma SAO signal; or (iv) the pre-luma deblocking signal.

FIG. 25 is a flowchart illustrating a method 2500 for video encoding in accordance with some examples of the present disclosure. At step 2501, the method 2500 includes obtaining, by an encoder, one or more spatial neighboring samples associated with a current chroma sample, wherein the one or more spatial neighboring samples are from at least one of following signals: (i) a luma prediction signal, (ii) a luma residual signal, (iii) a pre-luma sample adaptive offset (SAO) signal, or (iv) a pre-luma deblocking signal. At step 2502, the method 2500 includes obtaining, by the encoder, a filtered chroma sample, based on the one or more spatial neighboring samples associated with the current chroma sample.

In one example, the method 2500 further includes: obtaining, by the encoder, a cross-component adaptive loop filter (CCALF) filtered chroma sample based on the one or more spatial neighboring samples associated with the luma prediction signal and one or more filter coefficients, wherein the one or more filter coefficients are associated with different filter shapes.

In one example, the method 2500 further includes: obtaining, by the encoder, clipped results based on differences between one or more spatial neighboring samples from the luma prediction signal and the current corresponding luma sample; and deriving, by the encoder, the CCALF input based on the clipped results.

In one example, the method 2500 further includes: obtaining, by the encoder, clipped results based on differences between surrounding samples the luma prediction signal and collocated samples in the luma prediction signal, and clipped results based on differences between collocated samples in the luma prediction signal and current corresponding luma sample; and deriving, by the encoder, the CCALF input based on the clipped results.

In one example, the method 2500 further includes: obtaining, by the encoder, a cross-component adaptive loop filter (CCALF) filtered chroma sample based on the one or more spatial neighboring samples associated with the luma residual signal and one or more filter coefficients, wherein the one or more filter coefficients are associated with different filter shapes.

In one example, the method 2500 further includes: obtaining, by the encoder, clipped results of one or more spatial neighboring samples from the luma residual signal; and deriving, by the encoder, the CCALF input based on the clipped results.

In one example, the method 2500 further includes: obtaining, by the encoder, a cross-component adaptive loop filter (CCALF) filtered chroma sample based on the one or more spatial neighboring samples associated with the pre-luma SAO signal and one or more filter coefficients, wherein the one or more filter coefficients are associated with different filter shapes.

In one example, the method 2500 further includes: obtaining, by the encoder, clipped results based on differences between one or more spatial neighboring samples from the pre-luma SAO signal and the current corresponding luma sample; and deriving, by the encoder, the CCALF input based on the clipped results.

In one example, the method 2500 further includes: obtaining, by the encoder, clipped results based on differences between surrounding samples from the pre-luma SAO signal and collocated samples from the pre-luma SAO signal, and clipped results based on differences between collocated samples in the pre-luma SAO signal and current corresponding luma sample; and deriving, by the encoder, the CCALF input based on the clipped results.

In one example, the method 2500 further includes: obtaining, by the encoder, a cross-component adaptive loop filter (CCALF) filtered chroma sample based on the one or more spatial neighboring samples associated with the pre-luma deblocking signal and one or more filter coefficients, wherein the one or more filter coefficients are associated with different filter shapes.

In one example, the method 2500 further includes: obtaining, by the encoder, clipped results based on differences between one or more spatial neighboring samples from the pre-luma deblocking signal and the current corresponding luma sample; and deriving, by the encoder, the CCALF input based on the clipped results.

In one example, the method 2500 further includes: obtaining, by the encoder, clipped results based on differences between one or more spatial neighboring samples from the pre-luma deblocking signal and collocated samples from the pre-luma deblocking signal, and clipped results based on differences between collocated samples in the pre-luma deblocking signal and current corresponding luma sample; and deriving, by the encoder, the CCALF input based on the clipped results.

In one example, the one or more spatial neighboring samples are from a combination of following signals: (i) the luma prediction signal; (ii) the luma residual signal; (iii) the pre-luma SAO signal; or (iv) the pre-luma deblocking signal.

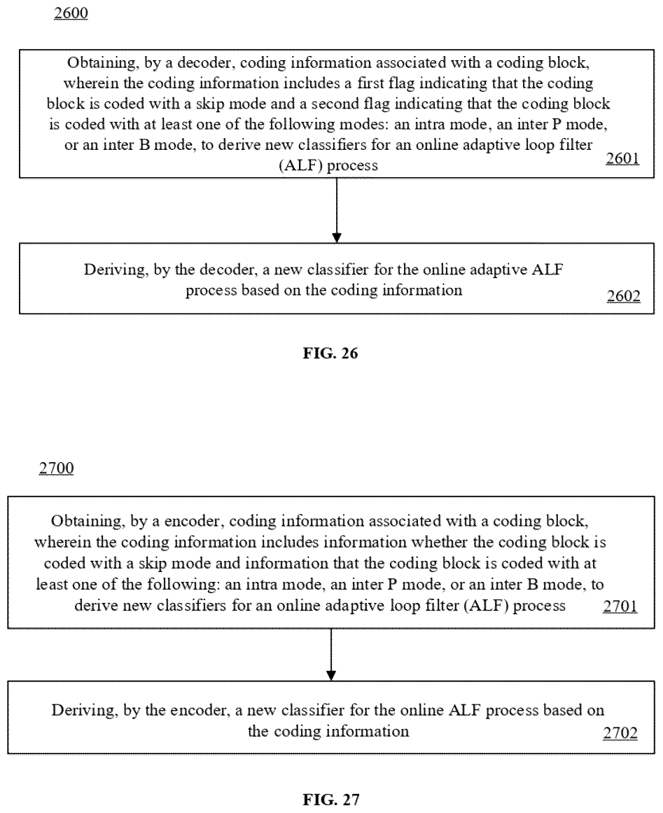

FIG. 26 is a flowchart illustrating a method 2600 for video decoding in accordance with some examples of the present disclosure. At step 2601, the method 2600 includes obtaining, by a decoder, coding information associated with a coding block, wherein the coding information includes a first flag indicating that the coding block is coded with a skip mode and a second flag indicating that the coding block is coded with at least one of the following modes: an intra mode, an inter P mode, or an inter B mode, to derive new classifiers for an online adaptive loop filter (ALF) process. At step 2602, the method 2600 includes generating, by the decoder, a new classifier for the online adaptive ALF process based on the coding information.

In one example, the method 2600 further includes using the first flag to derive the new classifier for the online ALF process.

In one example, the new classifier includes two classes corresponding to whether the coding block is coded with the skip mode.

In one example, the new classifier combines skip mode information with at least one of: edge offset(EO) (edge-based classifier) information, or band offset (BO) (band-based classifier) information.

In one example, the method 2600 further includes: recording, at the decoder, that the coding block is coded with at least one of following modes: (i) intra mode, (ii) inter P mode, or (iii) inter B mode; and generating, at the decoder, the new classifier for the online ALF process based on the recording.

In one example, the new classifier includes three classes corresponding to the coding block is coded with intra mode, inter P mode, or inter B mode.

In one example, the new classifier combines: information that the coding block is coded with at least one of: intra mode, inter P mode, or inter B mode, with at least one of: edge offset (EO) (edge based classifier) information, or band offset(BO) (band based classifier) information.

In one example, the method 2600 further includes: determining, at the decoder, that whether the coding block is coded with skip mode; determining, at the decoder, that the coding block is coded with one of the following modes: (i) intra mode; (ii) inter P mode; or (iii) inter B mode; and generating, at the decoder, the new classifier based on the determined modes.

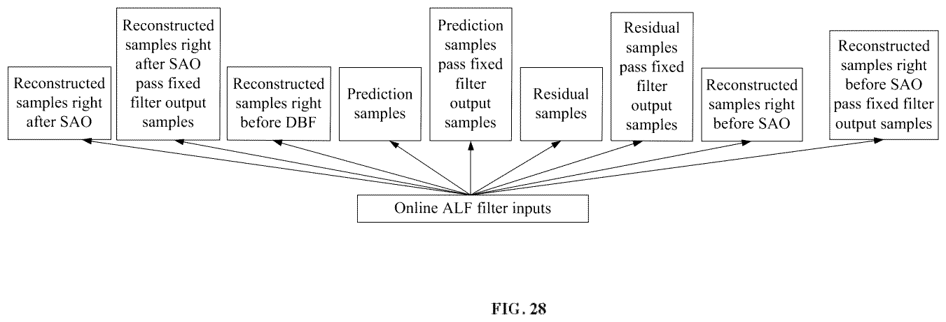

FIG. 27 is a flowchart illustrating a method 2700 for video encoding in accordance with some examples of the present disclosure. At step 2701, the method 2700 includes obtaining, by an encoder, coding information associated with a coding block, wherein the coding information includes information whether the coding block is coded with a skip mode and information that the coding block is coded with at least one of the following: an intra mode, an inter P mode, or an inter B mode, to derive new classifiers for an online adaptive loop filter (ALF) process. At step 2702, the method 2700 includes generating, by the encoder, a new classifier for the online ALF process based on the coding information.

In one example, the coding block is coded with the skip mode during an encoding process is utilized to derive the new classifier for the online ALF process.

In one example, the new classifier includes two classes corresponding to whether the coding block is coded with the skip mode.

In one example, the new classifier combines skip mode information with edge offset (EO) (edge based classifier) information or band offset(BO) (band based classifier) information.

In one example, the method 2700 includes recording, at the encoder, that the coding block is coded with at least one of: (i) intra mode, (ii) inter P mode, or (iii) inter B mode; and generating, by the encoder, the new classifier for the online ALF process based on the recording.

In one example, the new classifier includes three classes corresponding to the coding block is coded with intra mode, inter P mode, or inter B mode.

In one example, the new classifier combines: information that the coding block is coded with at least one of: intra mode, inter P mode, or inter B mode, with at least one of: edge offset (EO) (edge based classifier) information, or (BO) (band based classifier) information.

In one example, the method 2700 further includes: determining, at the encoder, whether the coding block is coded with skip mode; determining, at the encoder, that the coding block is coded with one of the following modes: (i) intra mode; (ii) inter P mode; or (iv) inter B mode; and generating the new classifier based on the modes.

In accordance with some examples of the present disclosure, the embodiments in the following sections may be implemented.

### CCALF in ECM

The CCALF process uses a linear filter to filter luma sample values and generate a residual correction for the chroma samples. A 25-tap large filter is used in CCALF process, which is illustrated in FIG. 21. For a given slice, the encoder can collect the statistics of the slice, analyze them and can signal up to 16 filters through APS.

Although ALF and CCALF have been improved in ECM, there is room to further improve the performance.

First, online ALF filter in ECM takes spatial neighboring pixels, fixed ALF filter results and spatial neighboring pixels before deblocking filter as input. However, besides these information, other information such as spatial neighboring pixels in prediction signal, spatial neighboring pixels in residual signal, or spatial neighboring pixels before SAO can also be used as online ALF filter equation input, which may benefit the coding performance.

Second, edge based classifier and band based classifier are used adaptively for online ALF filter in ECM. However, these two classifiers may be further combined to provide other classifiers, which may benefit the coding performance.

Third, the filter shape for chroma ALF is diamond in ECM, while the filter shape for luma ALF is long cross shape, such non-unified design may not be optimal from standardization point of view.

Fourth, the edge based classifier and band based classifier in ECM only consider the pixel values after SAO. However, after the pixel values from the stages: 1) right before deblocking filter 2) prediction signal 3) residual signal 4) right before SAO are saved as online ALF filter equation input, these pixel values can also be utilized to design new classifiers, which may benefit the coding performance.

Fifth, the edge based classifier and band based classifier in ECM only consider luma pixel values after SAO. However, the chroma pixel values can also be utilized to design new classifier, which may benefit the coding performance.

Sixth, similar to the luma pixel values from the stages: 1) right before deblocking filter 2) prediction signal 3) residual signal 4) right before SAO are saved as additional online luma ALF filter equation input, the chroma pixel values from the stages: 1) before deblocking filter 2) prediction signal 3) residual signal 4) right before SAO can also be saved as additional online chroma ALF filter equation input, which may benefit the coding performance.

Seventh, similar to the luma pixel values from the stages: 1) right before deblocking filter 2) prediction signal 3) residual signal 4) right before SAO are saved as additional online luma ALF filter equation input, the luma pixel values from the stages: 1) right before deblocking filter 2) prediction signal 3) residual signal 4) right before SAO can also be saved as additional CCALF filter equation input, which may benefit the coding performance.

Eighth, the classifiers design in ECM only considers the reconstruction pixel values. However, the coding mode information such as whether a coding block is coded with skip mode, whether the coding block is coded with intra, inter P or inter B mode can also be utilized to design classifier, which may benefit the coding performance.

Ninth, after online ALF filter takes samples as additional input from the stages: 1) samples right before deblocking 2) prediction samples 3) residual samples 4) samples right before SAO, etc., according to current line buffer settings in VVC, additional line buffers are needed to save 4 rows of corresponding luma samples and 2 rows of corresponding chroma samples above horizontal CTU boundaries, which increases the implementation complexity.

Tenth, after CCALF filter takes samples as additional input from the stages: 1) samples right before deblocking 2) prediction samples 3) residual samples 4) samples right before SAO, etc., according to current line buffer settings in VVC, additional line buffers are needed to save 4 rows of corresponding luma samples above horizontal CTU boundaries, which increases the implementation complexity.

Eleventh, after online ALF filter takes samples as additional input from the stages: 1) samples right before deblocking 2) prediction samples 3) residual samples 4) samples right before SAO, etc., sample padding is needed when the filter shape of the additional input with its central position aligned with the to be filtered sample crosses a boundary. In some embodiments, the boundary may be a borderline of an area that includes the to be filtered samples. For example, the boundary may be a virtual boundary (line buffer boundary) or picture (slice, tile) boundary.

In this disclosure, to address the issues as pointed out in the “problem statement” section, methods are provided to further improve the existing design of the ALF. In general, the main features of the proposed technologies in this disclosure are summarized as follows.

Online ALF filter takes spatial neighboring pixels in prediction signal, spatial neighboring pixels in residual signal, or spatial neighboring pixels before SAO as additional input.

The classifiers which combine the features of edge based classifier and band based classifier are used as additional classifier for online ALF filter.

The filter shape for chroma ALF is changed from diamond shape to long cross shape to unify with the filter shape for luma ALF.

The classifiers which utilize the pixel values from the stages: 1) right before deblocking filter 2) prediction signal 3) residual signal 4) right before SAO are used as additional classifier for online ALF filter.

The classifiers which utilize the chroma pixel values are used as additional classifier for online ALF filter.

Online chroma ALF filter takes spatial neighboring pixels in chroma prediction signal, spatial neighboring pixels in chroma residual signal, spatial neighboring pixels from the stage right before chroma SAO, or spatial neighboring pixels from the stage right before chroma deblocking as additional input.

CCALF filter takes spatial neighboring pixels in luma prediction signal, spatial neighboring pixels in luma residual signal, spatial neighboring pixels from the stage right before luma SAO, or spatial neighboring pixels from the stage right before luma deblocking as additional input.

The classifiers which utilize the coding mode information such as whether a coding block is coded with skip mode, whether the coding block is coded with intra, inter P or inter B mode are used as additional classifiers for online ALF filter.

When online ALF filter takes samples as additional input from the stages: 1) samples right before deblocking 2) prediction samples 3) residual samples 4) samples right before SAO, etc., according to current line buffer settings in VVC, 4 rows of corresponding luma samples and 2 rows of corresponding chroma samples above horizontal CTU boundaries are assumed to default values, which may save these line buffers.

When CCALF filter takes samples as additional input from the stages: 1) samples right before deblocking 2) prediction samples 3) residual samples, 4) samples right before SAO, etc., according to current line buffer settings in VVC, 4 rows of corresponding luma samples above horizontal CTU boundaries are assumed to default values, which may save these line buffers.

When online ALF filter takes samples as additional input from the stages: 1) samples right before deblocking 2) prediction samples 3) residual samples 4) samples right before SAO, etc., sample padding is conducted when the filter shape of the additional input with its central position aligned with the to be filtered sample crosses the virtual boundary (line buffer boundary) or picture (slice, tile) boundary.

In some embodiments of the present disclosure, the disclosed methods may be applied independently or jointly.

### Information in Prediction, Residual or Before SAO Used as Additional ALF Input

According to the one or more embodiments of the disclosure, information in prediction, residual or before SAO are used as additional ALF equation input. Different methods may be used to achieve this goal.

FIG. 28 presents the online ALF filter inputs. Online ALF filter can take all or a subset of prediction samples, output samples which are obtained by feeding prediction samples into the offline trained fixed filters, residual samples, output samples which are obtained by feeding residual samples into the offline trained fixed filters, reconstructed samples right before SAO, and output samples which are obtained by feeding reconstructed samples right before SAO into the offline trained fixed filters, as additional inputs.

In the first method, it is proposed to take the spatial neighboring pixels in prediction signal as additional ALF equation input. Various filter shapes may be used to extract the information in prediction signal. For example, the filter shape may be 1×1, 3×3 or 5×5 as shown in FIG. 8. Various equation forms may be used to extract the information in prediction signal. In an embodiment, the clipping differences between the surrounding pixels in prediction signal and current pixel are used as ALF equation input. In another example, the clipping differences between the surrounding pixels in prediction signal and the collocated pixel in prediction signal, the clipping difference between the collocated pixel in prediction signal and current pixel are used as ALF equation input.

Besides applying additional online ALF filter taps directly to prediction signal, additional online ALF filter taps may also be applied to the midterm results which are obtained by feeding prediction signal to fixed filters. Various fixed filters may be applied to filter prediction signal to obtain the midterm results, which may gather the prediction signal information in a large receptive field. For example, the two 13×13 diamond shape fixed filters utilized in ALF in ECM may be utilized to filter prediction signal to obtain the midterm results. When applying fixed filters to prediction signal, the block level classification results may directly utilize the block level classification results computed for right after SAO signal, or recomputed based on prediction signal. When applying fixed filters to prediction signal, one fixed filter trained based on one block level classifier may be utilized to obtain one midterm result, or two or more fixed filters trained based on two or more block level classifiers may be utilized to obtain two or more midterm results. In video coding standards, there are usually several groups fixed filters prepared, and one group fixed filter may be chosen from them by a rate distortion optimization (RDO) process. For example, in ECM, one group fixed filter (contains two 13×13 diamond shape fixed filters) is chosen from two groups by RDO process, and the group index is transmitted to decoder. When applying fixed filters to prediction signal, the group index for prediction signal may be same to the group index for right after SAO signal, or different from the group index for right after SAO signal based on a predefined criterion (In ECM, there are two groups, so if the group index for right after SAO signal is 0, then the group index for prediction signal is 1; if the group index for right after SAO signal is 1, then the group index for prediction signal is 0), or decided for prediction signal by RDO process, where no group index for prediction signal is needed to transmitted to decoder in the first and second cases and the group index for prediction signal needed to transmitted to decoder in the third case.

When applying additional online filter taps to the midterm results which are obtained by feeding prediction signal to fixed filters, various filter shapes may be used to extract the information in the midterm results. For example, the filter shape may be 1×1, 3×3 or 5×5 as shown in FIG. 8. Various equation forms may be used to extract the information in the midterm results. In an embodiment, the clipping differences between the surrounding pixels in the midterm results and current pixel are used as ALF equation input. In another example, the clipping differences between the surrounding pixels in the midterm results and the collocated pixel in the midterm results, the clipping difference between the collocated pixel in the midterm results and current pixel are used as ALF equation input.

It should be noted that the additional online ALF filter taps may be applied to only prediction signal, or only the midterm results which are obtained by feeding prediction signal to fixed filters, or both prediction signal and the midterm results which are obtained by feeding prediction signal to fixed filters. For example, in AI (all intra) test, the additional online ALF filter taps are applied to only prediction signal; in RA (random access) test, the additional online ALF filter taps are applied to both prediction signal and the midterm results which are obtained by feeding prediction signal to fixed filters.

In the second method, it is proposed to take the spatial neighboring pixels in residual signal as additional ALF equation input. Various filter shapes may be used to extract the information in residual signal. For example, the filter shape may be 1×1, 3×3 or 5×5 as shown in FIG. 8. Various equation forms may be used to extract the information in residual signal. In an embodiment, the clipping results of the collocated pixel in residual signal are used as ALF equation input.

Besides applying additional online ALF filter taps directly to residual signal, additional online ALF filter taps may also be applied to the midterm results which are obtained by feeding residual signal to fixed filters. Various fixed filters may be applied to filter residual signal to obtain the midterm results, which may gather the residual signal information in a large receptive field. For example, the two 13×13 diamond shape fixed filters utilized in ALF in ECM may be utilized to filter residual signal to obtain the midterm results. In one or more examples, considering that for prediction and before SAO signals, the ranges are just same to range after SAO signal, i.e. (0, 1024), which are positive, but for residual signals, the range may be positive or negative. Thus, when applying fixed filters to residual signal, the filtering results may be clipped to different range such as (−1024, 1024), (−512, 512), (−256, 256), (−128, 128), and so on. When applying fixed filters to residual signal, the block level classification results may directly utilize the block level classification results computed for right after SAO signal, or recomputed based on residual signal. When applying fixed filters to residual signal, one fixed filter trained based on one block level classifier may be utilized to obtain one midterm result, or two or more fixed filters trained based on two or more block level classifiers may be utilized to obtain two or more midterm results. When applying fixed filters to residual signal, the group index for residual signal may be same to the group index for right after SAO signal, or different from the group index for right after SAO signal based on a predefined criterion (In ECM, there are two groups, so if the group index for right after SAO signal is 0, then the group index for residual signal is 1; if the group index for right after SAO signal is 1, then the group index for residual signal is 0), or decided for residual signal by the RDO process, where no group index for residual signal is needed to transmitted to decoder in the first and second cases and the group index for residual signal needed to transmitted to decoder in the third case.

When applying additional online filter taps to the midterm results which are obtained by feeding residual signal to fixed filters, various filter shapes may be used to extract the information in the midterm results. For example, the filter shape may be 1×1, 3×3 or 5×5 as shown in FIG. 8. Various equation forms may be used to extract the information in the midterm results. In an embodiment, the clipping results of the collocated pixel in the midterm results are used as ALF equation input.

It should be noted that the additional online ALF filter taps may be applied to only residual signal, or only the midterm results which are obtained by feeding residual signal to fixed filters, or both residual signal and the midterm results which are obtained by feeding residual signal to fixed filters. For example, in AI (all intra) test, the additional online ALF filter taps are applied to only residual signal; in RA (random access) test, the additional online ALF filter taps are applied to both residual signal and the midterm results which are obtained by feeding residual signal to fixed filters.

In the third method, it is proposed to take the spatial neighboring pixels from the stage right before SAO signal as additional ALF equation input. Various filter shapes may be used to extract the information in before SAO signal. For example, the filter shape may be lxI, 3×3 or 5×5 as shown in FIG. 8. Various equation forms may be used to extract the information in before SAO signal. In an embodiment, the clipping differences between the surrounding pixels in before SAO signal and current pixel are used as ALF equation input. In another example, the clipping differences between the surrounding pixels in before SAO signal and the collocated pixel in before SAO signal, the clipping difference between the collocated pixel in before SAO signal and current pixel are used as ALF equation input.

Besides applying additional online ALF filter taps directly to right before SAO signal, additional online ALF filter taps may also be applied to the midterm results which are obtained by feeding right before SAO signal to fixed filters. Various fixed filters may be applied to filter right before SAO signal to obtain the midterm results, which may gather the right before SAO signal information in a large receptive field. For example, the two 13×13 diamond shape fixed filters utilized in ALF in ECM may be utilized to filter right before SAO signal to obtain the midterm results. When applying fixed filters to right before SAO signal, the block level classification results may directly utilize the block level classification results computed for right after SAO signal, or recomputed based on right before SAO signal. When applying fixed filters to right before SAO signal, one fixed filter trained based on one block level classifier may be utilized to obtain one midterm result, or two or more fixed filters trained based on two or more block level classifiers may be utilized to obtain two or more midterm results. When applying fixed filters to right before SAO signal, the group index for right before SAO signal may be same to the group index for right after SAO signal, or different from the group index for right after SAO signal based on a predefined criterion (In ECM, there are two groups, so if the group index for right after SAO signal is 0, then the group index for right before SAO signal is 1; if the group index for right after SAO signal is 1, then the group index for right before SAO signal is 0), or decided for right before SAO signal by a RDO process, where no group index for right before SAO signal is needed to transmitted to decoder in the first and second cases and the group index for right before SAO signal needed to transmitted to decoder in the third case.

When applying additional online filter taps to the midterm results which are obtained by feeding right before SAO signal to fixed filters, various filter shapes may be used to extract the information in the midterm results. For example, the filter shape may be 1×1, 3×3 or 5×5 as shown in FIG. 8. Various equation forms may be used to extract the information in the midterm results. In an embodiment, the clipping differences between the surrounding pixels in the midterm results and current pixel are used as ALF equation input. In another example, the clipping differences between the surrounding pixels in the midterm results and the collocated pixel in the midterm results, the clipping difference between the collocated pixel in the midterm results and current pixel are used as ALF equation input.

It should be noted that the additional online ALF filter taps may be applied to only right before SAO signal, or only the midterm results which are obtained by feeding right before SAO signal to fixed filters, or both right before SAO signal and the midterm results which are obtained by feeding right before SAO signal to fixed filters. For example, in AI (all intra) test, the additional online ALF filter taps are applied to only right before SAO signal; in RA (random access) test, the additional online ALF filter taps are applied to both right before SAO signal and the midterm results which are obtained by feeding right before SAO signal to fixed filters.

In the fourth method, it is proposed to take the information in prediction, residual or before SAO signal as ALF equation input. The utilization method proposed in the first, second and third method may be combined to achieve the fourth method.

### New Classifiers Combined the Features of Edge Based Classifier and Band Based Classifier

According to the one or more embodiments of the disclosure, the features of edge based classifier and band based classifier are combined to derive new classifiers for online ALF filter. Different methods may be used to achieve this goal.

In the first method, it is proposed to first compute the directionality D of the sub-block of luma component, then the sum of sample values of the sub-block is calculated and it is mapped to the index referring to the band based classifier, and the class index for the sub-block is calculated as

$$C = B * {M}_{D} + D , \qquad ( 58 )$$

where B is the index calculated referring to the band based classifier, M_{D} represents the total number of directionalities D. In an embodiment, for the 2×2 luma block, the directionality D is calculated the same to D₂ in ECM, and B is calculated as

$$B = ( sum * 5 ) >> ( sample bit depth + 2 ) . \qquad ( 59 )$$

In the second method, it is proposed to first compute the activity value A of the sub-block of luma component, then the sum of sample values of the sub-block is calculated and it is mapped to the index referring to the band based classifier, and the class index for the sub-block is calculated as

$$C = B * {M}_{A} + A , \qquad ( 60 )$$

where B is the index calculated referring to the band based classifier, M_{A} represents the total number of the activity value A. In an embodiment, for the 2×2 luma block, the activity value A is calculated the same to Â₂ in ECM, and B is calculated as

$$B = ( sum * 5 ) >> ( sample bit depth + 2 ) . \qquad ( 61 )$$

In the third method, it is proposed to first compute the index of the sub-block of luma component referring to the edge based classifier, then the sum of sample values of the sub-block is calculated and it is mapped to the index referring to the band based classifier, and the class index for the sub-block is calculated as

$$C = B * {M}_{E} + E , \qquad ( 62 )$$

where B is the index calculated referring to the band based classifier, M_{E} represents the total number of the index calculated referring to the edge based classifier, E is the index calculated referring to the edge based classifier. In an embodiment, for the 2×2 luma block, the index E is calculated the same to C₂ in ECM, and B is calculated as

$$B = ( sum * 2 ) >> ( sample bit depth + 2 ) . \qquad ( 63 )$$

Adjust the Chroma ALF Filter Shape to Unify with Luma ALF Filter Shape

In the third aspect of this disclosure, it is proposed to change the chroma ALF filter shape from diamond shape to long cross shape as shown in FIG. 9, which is unified with the luma ALF filter shape.

New Classifiers Utilized the Pixel Values from the Stage Right Before Deblocking Filter

According to the one or more embodiments of the disclosure, the pixel values from the stage right before deblocking filter are utilized to derive new classifiers for online ALF filter. Different methods may be used to achieve this goal.

In the first method, it is proposed to first compute the directionality D of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{D} + D , \qquad ( 64 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) . \qquad ( 65 )$$

In the second method, it is proposed to first compute the activity value A of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{A} + A , \qquad ( 66 )$$

where Dif is the difference index, M_{A} represents the total number of the activity value A. In an embodiment, for the 2×2 luma block, the activity value A is calculated the same to Â₂ in ECM, and Dif is calculated as in equation (65).

In the third method, it is proposed to first compute the index of the sub-block of luma component referring to the edge based classifier, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{E} + E , \qquad ( 67 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (65).

In the fourth method, it is proposed to first compute the band index B of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{B} + B , \qquad ( 68 )$$

where Dif is the difference index, M_{B} represents the total number of the band value. In an embodiment, for the 2×2 luma block, the band index B is calculated as

$$B = ( sum * 2 ) >> ( sample bit depth + 2 ) , \qquad ( 69 )$$

and Dif is calculated as in equation (65).

In the fifth method, it is proposed to compute the sum of difference values between sample from the stage right after SAO and collocated sample from the stage right before deblocking filter of the sub-block, then the sum of difference values is mapped to the difference index and the difference index is used as the class index.

In the sixth method, it is proposed to calculate the edged based classifier or band based classifier based on the sample values from the stage right before deblocking filter, where the calculation method is same to original edge based classifier or band based classifier calculated based on the sample values after SAO.

### New Classifiers Utilized the Pixel Values in Prediction Signal

According to the one or more embodiments of the disclosure, the pixel values in prediction signal are utilized to derive new classifiers for online ALF filter. Different methods may be used to achieve this goal.

In the first method, it is proposed to first compute the directionality D of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{D} + D , \qquad ( 70 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) . \qquad ( 71 )$$

In the second method, it is proposed to first compute the activity value A of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{A} + A , \qquad ( 72 )$$

where Dif is the difference index, M_{A} represents the total number of the activity value A. In an embodiment, for the 2×2 luma block, the activity value A is calculated the same to Â₂ in ECM, and Dif is calculated as in equation (71).

In the third method, it is proposed to first compute the index of the sub-block of luma component referring to the edge based classifier, then the sum of difference values between sample in after SAO and collocated sample in prediction signal of the sub-block is calculated and it is mapped to the difference index, and the class index for the sub-block is calculated as

$$C = Dif * {M}_{E} + E , \qquad ( 73 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (71).

In the fourth method, it is proposed to first compute the band index B of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{B} + B , \qquad ( 74 )$$

where Dif is the difference index, M_{B} represents the total number of the band value.

In an embodiment, for the 2×2 luma block, the band index B is calculated as

$$B = ( sum * 2 ) >> ( sample bit depth + 2 ) , \qquad ( 75 )$$

and Dif is calculated as in equation (71).

In the fifth method, it is proposed to compute the sum of difference values between sample in after SAO and collocated sample in prediction signal of the sub-block, then the sum of difference values is mapped to the difference index and the difference index is used as the class index.

In the sixth method, it is proposed to calculate the edged based classifier or band based classifier based on the sample values in prediction signal, where the calculation method is same to original edge based classifier or band based classifier calculated based on the sample values after SAO.

### New Classifiers Utilized the Pixel Values in Residual Signal

According to the one or more embodiments of the disclosure, the pixel values in residual signal are utilized to derive new classifiers for online ALF filter. Different methods may be used to achieve this goal.

In the first method, it is proposed to first compute the directionality D of the sub-block of luma component, then the sum of pixel values in residual signal of the sub-block is calculated and it is mapped to the residual index, and the class index for the sub-block is calculated as

$$C = Resi * {M}_{D} + D , \qquad ( 76 )$$

where Resi is the residual index, M_{D} represents the total number of directionalities D. In an embodiment, for the 2×2 luma block, the directionality D is calculated the same to D₂ in ECM, and Resi is calculated as

$$Resi = {sum}_{Res i} > 0 ? 2 : ( {sum}_{Res i} < 0 ? 0 : 1 ) . \qquad ( 77 )$$

In the second method, it is proposed to first compute the activity value A of the sub-block of luma component, then the sum of pixel values in residual signal of the sub-block is calculated and it is mapped to the residual index, and the class index for the sub-block is calculated as

$$C = R e s i * {M}_{A} + A , \qquad ( 78 )$$

where Resi is the residual index, M_{A} represents the total number of the activity value A. In an embodiment, for the 2×2 luma block, the activity value A is calculated the same to A₂ in ECM, and Resi is calculated as in equation (77).

In the third method, it is proposed to first compute the index of the sub-block of luma component referring to the edge based classifier, then the sum of pixel values in residual signal of the sub-block is calculated and it is mapped to the residual index, and the class index for the sub-block is calculated as

$$C = R e s i * {M}_{E} + E , \qquad ( 79 )$$

where Resi is the residual index, M_{E} represents the total number of the index calculated referring to the edge based classifier, E is the index calculated referring to the edge based classifier. In an embodiment, for the 2×2 luma block, the index E is calculated the same to C₂ in ECM, and Resi is calculated as in equation (77).

In the fourth method, it is proposed to first compute the band index B of the sub-block of luma component, then the sum of pixel values in residual signal of the sub-block is calculated and it is mapped to the residual index, and the class index for the sub-block is calculated as

$$C = R e s i * {M}_{B} + B , \qquad ( 80 )$$

where Resi is the residual index, M_{B} represents the total number of the band value. In an embodiment, for the 2×2 luma block, the band index B is calculated as

$$B = ( sum * 8 ) >> ( sample bit depth + 2 ) , \qquad ( 81 )$$

and Resi is calculated as in equation (77).

In the fifth method, it is proposed to compute the sum of pixel values in residual signal of the sub-block, then the sum of residual values is mapped to the residual index and the residual index is used as the class index.

In the sixth method, it is proposed to first compute the sum of absolute value of the pixel values in residual signal of the sub block and it is mapped to the absolute value of residual index Resi_{Abso}, then the sum of pixel values in residual signal of the sub-block is calculated and it is mapped to the sign of residual index Resi_{sign}, and the class index for the sub-block is calculated as

$$C = R e s {i}_{S i g n} * {M}_{A b s o} + R e s {i}_{A b s o} \qquad ( 82 )$$

where M_{Abso} represents the total number of the absolute value of residual index. In one example, for the 2×2 luma block, the absolute value of residual index Resi_{Abso} is calculated as

$$R e s {i}_{A b s o} = ( S u {m}_{A b s o} * 8 ) >> ( sample bit depth + 2 ) \qquad ( 83 )$$

and Resi_{sign} is calculated as in equation (77).

In the seventh method, it is proposed to compute the index of the sub-block based on the pixel values in residual signal referring to the edge based classifier, then the index is used as the class index.

In the eighth method, it is proposed to compute the index of the sub-block based on the absolute value of the pixel values in residual signal referring to the edge based classifier, then the index is used as the class index.

New Classifiers Utilized the Pixel Values from the Stage Right Before SAO

According to the one or more embodiments of the disclosure, the pixel values from the stage right before SAO are utilized to derive new classifiers for online ALF filter. Different methods may be used to achieve this goal.

In the first method, it is proposed to first compute the directionality D of the sub-block of luma component, then the sum of difference values between sample from the stage right after SAO and collocated sample from the stage right before SAO of the sub-block is calculated and it is mapped to the difference index, and the class index for the sub-block is calculated as

$$C = D i f * {M}_{D} + D , \qquad ( 84 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{D i f} > 0 ? 2 : ( {sum}_{D i f} < 0 ? 0 : 1 ) . \qquad ( 85 )$$

In the second method, it is proposed to first compute the activity value A of the sub-block of luma component, then the sum of difference values between sample from the stage right after SAO and collocated sample from the stage right before SAO of the sub-block is calculated and it is mapped to the difference index, and the class index for the sub-block is calculated as

$$C = Dif * {M}_{A} + A , \qquad ( 86 )$$

where Dif is the difference index, M_{A} represents the total number of the activity value A. In an embodiment, for the 2×2 luma block, the activity value A is calculated the same to Â₂ in ECM, and Dif is calculated as in equation (85).

In the third method, it is proposed to first compute the index of the sub-block of luma component referring to the edge based classifier, then the sum of difference values between sample from the stage right after SAO and collocated sample from the stage right before SAO of the sub-block is calculated and it is mapped to the difference index, and the class index for the sub-block is calculated as

$$C = D i f * {M}_{E} + E , \qquad ( 87 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (85).

In the fourth method, it is proposed to first compute the band index B of the sub-block of luma component, then the sum of difference values between sample from the stage right after SAO and collocated sample from the stage right before SAO of the sub-block is calculated and it is mapped to the difference index, and the class index for the sub-block is calculated as

$$C = D i f * {M}_{B} + B , \qquad ( 88 )$$

where Dif is the difference index, M_{B} represents the total number of the band value.

In an embodiment, for the 2×2 luma block, the band index B is calculated as

$$B = ( sum * 8 ) >> ( sample bit depth + 2 ) , \qquad ( 89 )$$

and Dif is calculated as in equation (85).

In the fifth method, it is proposed to compute the sum of difference values between sample from the stage right after SAO and collocated sample from the stage right before SAO of the sub-block, then the sum of difference values is mapped to the difference index and the difference index is used as the class index.

In the sixth method, it is proposed to calculate the edged based classifier or band based classifier based on the sample values from the stage right before SAO, where the calculation method is same to original edge based classifier or band based classifier calculated based on the sample values after SAO.

### New Classifiers Utilized Chroma Pixel Values

According to the one or more embodiments of the disclosure, the chroma pixel values are utilized to derive new classifiers for online ALF filter. Different methods may be used to achieve this goal.

In the first method, it is proposed to first compute the band index B_{Y} of the sub-block of luma component, then the band index B_{U} and B_{V} of the corresponding U and V components are computed, and the class index for the sub-block is calculated as

$$C = {B}_{Y} * {M}_{U} * {M}_{V} + {B}_{U} * {M}_{V} + {B}_{V} , \qquad ( 90 )$$

where B_{Y}, B_{U} and B_{V} are the Y, U and V index calculated referring to the band based classifier, M_{U} and M_{V} represent the total number of the U and V band index value. In an embodiment, for the 2×2 luma block, the B_{Y}, B_{U} and B_{V} are calculated as

$${B}_{Y} = ( sumY * 6 ) >> ( sample bit depth + 2 ) , \qquad ( 91 )$$

$${B}_{U} = ( sumU * 2 ) >> ( sample bit depth + 2 ) , \qquad ( 92 )$$

$${B}_{V} = ( sumV * 2 ) >> ( sample bit depth + 2 ) . \qquad ( 93 )$$

Chroma Information from the Stages Right Before Deblocking, Prediction, Residual or Right Before SAO Used as Additional Chroma ALF Input

According to the one or more embodiments of the disclosure, chroma information from the stages right before deblocking, prediction, residual or right before SAO are used as additional chroma ALF equation input. Different methods may be used to achieve this goal.

In the first method, it is proposed to take the spatial neighboring pixels in chroma prediction signal as additional chroma ALF equation input. Various filter shapes may be used to extract the information in chroma prediction signal. For example, the filter shape may be 1×1, 3×3 or 5×5 as shown in FIG. 8. Various equation forms may be used to extract the information in chroma prediction signal. In an embodiment, the clipping differences between the surrounding pixels in chroma prediction signal and current chroma pixel are used as chroma ALF equation input. In another example, the clipping differences between the surrounding pixels in chroma prediction signal and the collocated pixel in chroma prediction signal, the clipping difference between the collocated pixel in chroma prediction signal and current chroma pixel are used as chroma ALF equation input.

In the second method, it is proposed to take the spatial neighboring pixels in chroma residual signal as additional chroma ALF equation input. Various filter shapes may be used to extract the information in chroma residual signal. For example, the filter shape may be 1×1, 3×3 or 5×5 as shown in FIG. 8. Various equation forms may be used to extract the information in chroma residual signal. In an embodiment, the clipping results of the collocated pixel in chroma residual signal are used as chroma ALF equation input.

In the third method, it is proposed to take the spatial neighboring pixels from the stage right before chroma SAO signal as additional chroma ALF equation input. Various filter shapes may be used to extract the information from the stage right before chroma SAO signal. For example, the filter shape may be 1×1, 3×3 or 5×5 as shown in FIG. 8. Various equation forms may be used to extract the information from the stage right before chroma SAO signal. In an embodiment, the clipping differences between the surrounding pixels from the stage right before chroma SAO signal and current chroma pixel are used as chroma ALF equation input. In another example, the clipping differences between the surrounding pixels from the stage right before chroma SAO signal and the collocated pixel from the stage right before chroma SAO signal, the clipping difference between the collocated pixel from the stage right before chroma SAO signal and current chroma pixel are used as chroma ALF equation input.

In the fourth method, it is proposed to take the spatial neighboring pixels from the stage right before chroma deblocking signal as additional chroma ALF equation input. Various filter shapes may be used to extract the information from the stage right before chroma deblocking signal. For example, the filter shape may be 1×1, 3×3 or 5×5 as shown in FIG. 8. Various equation forms may be used to extract the information from the stage right before chroma deblocking signal. In an embodiment, the clipping differences between the surrounding pixels from the stage right before chroma deblocking signal and current chroma pixel are used as chroma ALF equation input. In another example, the clipping differences between the surrounding pixels from the stage right before chroma deblocking signal and the collocated pixel from the stage right before chroma deblocking signal, the clipping difference between the collocated pixel from the stage right before chroma deblocking signal and current chroma pixel are used as chroma ALF equation input.

In the fifth method, it is proposed to take the information in chroma prediction, residual, before SAO or before deblocking signal as chroma ALF equation input. The utilization method proposed in the first, second third, fourth method may be combined to achieve the fifth method.

Luma Information from the Stages Right Before Deblocking, Prediction, Residual or Right Before SAO Used as Additional CCALF Input

According to the one or more embodiments of the disclosure, luma information from the stages right before deblocking, prediction, residual or right before SAO are used as additional CCALF equation input. Different methods may be used to achieve this goal.

In the first method, it is proposed to take the spatial neighboring pixels in luma prediction signal as additional CCALF equation input. Various filter shapes may be used to extract the information in luma prediction signal. For example, the filter shape may be 3×4 as shown in FIG. 20. Various equation forms may be used to extract the information in luma prediction signal. In an embodiment, the differences between the surrounding pixels in luma prediction signal and current corresponding luma pixel are used as CCALF equation input. In another example, the differences between the surrounding pixels in luma prediction signal and the collocated pixel in current corresponding luma prediction signal, the difference between the collocated pixel in current corresponding luma prediction signal and current corresponding luma pixel are used as CCALF equation input.

In the second method, it is proposed to take the spatial neighboring pixels in luma residual signal as additional CCALF equation input. Various filter shapes may be used to extract the information in luma residual signal. For example, the filter shape may be 3×4 as shown in FIG. 20. Various equation forms may be used to extract the information in luma residual signal. In an embodiment, the collocated pixel in luma residual signal are used as CCALF equation input.

In the third method, it is proposed to take the spatial neighboring pixels from the stage right before luma SAO signal as additional CCALF equation input. Various filter shapes may be used to extract the information from the stage right before luma SAO signal. For example, the filter shape may be 3×4 as shown in FIG. 20. Various equation forms may be used to extract the information from the stage right before luma SAO signal. In an embodiment, the differences between the surrounding pixels from the stage right before luma SAO signal and current corresponding luma pixel are used as CCALF equation input. In another example, the differences between the surrounding pixels from the stage right before luma SAO signal and the collocated pixel in current corresponding before luma SAO signal, the difference between the collocated pixel in current corresponding before luma SAO signal and current corresponding luma pixel are used as CCALF equation input.

In the fourth method, it is proposed to take the spatial neighboring pixels from the stage right before luma deblocking signal as additional CCALF equation input. Various filter shapes may be used to extract the information from the stage right before luma deblocking signal. For example, the filter shape may be 3×4 as shown in FIG. 20. Various equation forms may be used to extract the information from the stage right before luma deblocking signal. In an embodiment, the differences between the surrounding pixels from the stage right before luma deblocking signal and current corresponding luma pixel are used as CCALF equation input. In another example, the differences between the surrounding pixels from the stage right before luma deblocking signal and the collocated pixel in current corresponding before luma deblocking signal, the difference between the collocated pixel in current corresponding before luma deblocking signal and current corresponding luma pixel are used as CCALF equation input.

In the fifth method, it is proposed to take the information in luma prediction, residual, before SAO or before deblocking signal as CCALF equation input. The utilization method proposed in the first, second third, fourth method may be combined to achieve the fifth method.

### New Classifiers Utilized the Coding Mode Information

According to the one or more embodiments of the disclosure, the coding mode information such as whether the coding block is coded with skip mode, whether the coding block is coded with intra, inter P or inter B mode, is utilized to derive new classifiers for online ALF filter. Different methods may be used to achieve this goal.

In the first method, it is proposed to record whether the coding block is coded with skip mode during the encoding and decoding process, then this information is utilized to design a new classifier. In an embodiment, the classifier which has 2 classes corresponding to the skip mode is true or false is added as a new classifier. In another example, the classifier which combines the skip mode information with EO or BO is added as a new classifier.

In the second method, it is proposed to record whether the coding block is coded with intra mode, inter P mode, or inter B mode during the encoding and decoding process, then this information is utilized to design a new classifier. In an embodiment, the classifier which has 3 classes corresponding to the intra mode, inter P mode or inter B mode is added as a new classifier. In another example, the classifier which combines the intra, inter P or inter B mode information with EO or BO is added as a new classifier.

In the third method, it is proposed to take both the coding mode information whether the coding block is coded with skip mode, whether the coding block is coded with intra, inter P or inter B mode to design the new classifier. The utilization method proposed in the first and second method may be combined to achieve the third method.

### Line Buffer Reduction for Additional ALF Input

According to the one or more embodiments of the disclosure, when online ALF filter takes samples as additional input from the stages: 1) samples right before deblocking 2) prediction samples 3) residual samples 4) samples right before SAO, etc., there would be line buffers to save these samples, to reduce the line buffer requirements for these additional inputs, according to current line buffer settings in VVC, 4 rows of corresponding luma samples and 2 rows of corresponding chroma samples above horizontal CTU boundaries are assumed to default values, which may save these line buffers. Different methods may be used to achieve this goal.

In the first method, according to current line buffer settings in VVC, it is proposed to assume 4 rows of luma residual samples and 2 rows of chroma residual samples above horizontal CTU boundaries to zero values, assume 4 rows of luma samples and 2 rows of chroma samples above horizontal CTU boundaries from the stages: 1) samples right before deblocking 2) prediction samples 3) samples right before SAO to collocated sample values from the stage samples right after SAO.

In the second method, according to current line buffer settings in VVC, it is proposed to assume 4 rows of luma samples and 2 rows of chroma samples above horizontal CTU boundaries from the stages: 1) samples right before deblocking 2) prediction samples 3) residual samples 4) samples right before SAO, etc. in a repetitive manner with the corresponding nearest sample values in the horizontal CTU boundaries.

In the third method, according to current line buffer settings in VVC, it is proposed to assume 4 rows of luma samples and 2 rows of chroma samples above horizontal CTU boundaries from the stages: 1) samples right before deblocking 2) prediction samples 3) residual samples 4) samples right before SAO, etc. in a mirrored manner, where the first row of luma samples and first row of chroma samples above horizontal CTU boundaries are assumed to the corresponding sample values in the horizontal CTU boundaries, the second row of luma samples and second row of chroma samples above horizontal CTU boundaries are assumed to the corresponding sample values in the first rows of samples below the horizontal CTU boundaries, and so on.

It should be noted that 4 rows of luma samples and 2 rows of chroma samples above horizontal CTU boundaries are current VVC line buffer settings, the specific values may be adjusted according to customized settings.

### Line Buffer Reduction for Additional CCALF Input

According to the one or more embodiments of the disclosure, when CCALF filter takes samples as additional input from the stages: 1) samples right before deblocking 2) prediction samples 3) residual samples 4) samples right before SAO, etc., there would be line buffers to save these samples, to reduce the line buffer requirements for these additional inputs, according to current line buffer settings in VVC, 4 rows of corresponding luma samples above horizontal CTU boundaries are assumed to default values, which may save these line buffers. Different methods may be used to achieve this goal.

In the first method, according to current line buffer settings in VVC, it is proposed to assume 4 rows of luma residual samples above horizontal CTU boundaries to zero values, assume 4 rows of luma samples above horizontal CTU boundaries from the stages: 1) samples right before deblocking 2) prediction samples 3) samples right before SAO to collocated sample values from the stage samples right after SAO.

In the second method, according to current line buffer settings in VVC, it is proposed to assume 4 rows of luma samples above horizontal CTU boundaries from the stages: 1) samples right before deblocking 2) prediction samples 3) residual samples 4) samples right before SAO, etc. in a repetitive manner with the corresponding nearest sample values in the horizontal CTU boundaries.

In the third method, according to current line buffer settings in VVC, it is proposed to assume 4 rows of luma samples above horizontal CTU boundaries from the stages: 1) samples right before deblocking 2) prediction samples 3) residual samples 4) samples right before SAO, etc. in a mirrored manner, where the first row of luma samples above horizontal CTU boundaries are assumed to the corresponding sample values in the horizontal CTU boundaries, the second row of luma samples above horizontal CTU boundaries are assumed to the corresponding sample values in the first row of samples below the horizontal CTU boundaries, and so on.

It should be noted that 4 rows of luma samples above horizontal CTU boundaries are current VVC line buffer settings, the specific values may be adjusted according to customized settings.

### Sample Padding for Additional ALF Input

According to the one or more embodiments of the disclosure, when online ALF filter takes samples as additional input from the stages: 1) samples right before deblocking 2) prediction samples 3) residual samples 4) samples right before SAO, etc., sample padding is conducted when the filter shape of the additional input with its central position aligned with the to be filtered sample crosses the virtual boundary (line buffer boundary) or picture (slice, tile) boundary. Different methods may be used to achieve this goal.

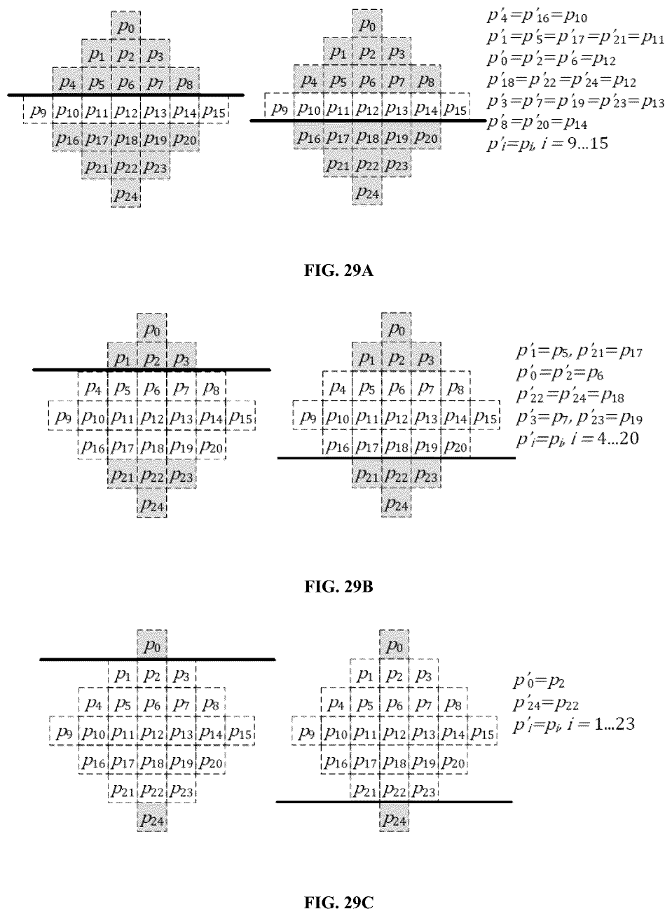

In the first method, symmetrical sample padding is applied when the filter shape of the additional input with its central position aligned with the to be filtered sample crosses the virtual boundary (line buffer boundary) or picture (slice, tile) boundary. For example, assume online ALF filter takes residual samples as additional input, the filter shape of the fixed filter to be applied to the residual signal or the filter shape of the online filter which directly applies to residual signal is 7×7, the filter shape of the residual signal with its central position aligned with the to be filtered sample crosses the line buffer boundary, the symmetrical sample padding is conducted as shown in FIGS. 29A-C, where p₁₂ masks the collocated residual pixel of the to be filtered sample, p₀ to p₂₄ are the original residual samples, p₀′ to p₂₄′ are the modified residual sample values, Bold lines are line buffer boundaries. Shaded samples represent padded residual samples. In a word, with symmetrical sample padding, the additional input samples which are not in the same boundary side with the collocated additional input sample of the to be filtered sample and the additional input symmetrical samples which are in the same boundary side with the collocated additional input sample of the to be filtered sample are both modified in a symmetry manner.

In the second method, repetitive sample padding is applied when the filter shape of the additional input with its central position aligned with the to be filtered sample crosses the virtual boundary (line buffer boundary) or picture (slice, tile) boundary. With repetitive padding, the additional input samples which are not in the same boundary side with the collocated additional input sample of the to be filtered sample are padded in the same manner with the symmetrical sample padding, the additional input samples which are in the same boundary side with the collocated additional input sample of the to be filtered sample remain unchanged.

FIG. 10 shows a computing environment 1610 coupled with a user interface 1650. The computing environment 1610 can be part of a data processing server. The computing environment 1610 includes a processor 1620, a memory 1630, and an Input/Output (I/O) interface 1640.

The processor 1620 typically controls overall operations of the computing environment 1610, such as the operations associated with display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a Graphical Processing Unit (GPU), or the like.

The memory 1630 is configured to store various types of data to support the operation of the computing environment 1610. The memory 1630 may include predetermined software 1632. Examples of such data includes instructions for any applications or methods operated on the computing environment 1610, video datasets, image data, etc. The memory 1630 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1640 provides an interface between the processor 1620 and peripheral interface modules, such as a keyboard, a click wheel, buttons, and the like. The buttons may include but are not limited to, a home button, a start scan button, and a stop scan button. The I/O interface 1640 can be coupled with an encoder and decoder.

In an embodiment, there is also provided a non-transitory computer-readable storage medium comprising a plurality of programs, for example, in the memory 1630, executable by the processor 1620 in the computing environment 1610, for performing the above-described methods and/or storing a bitstream generated by the encoding method described above or a bitstream to be decoded by the decoding method described above. In an embodiment, the plurality of programs may be executed by the processor 1620 in the computing environment 1610 to receive (for example, from the video encoder 20 in FIG. 1G) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 2B). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1620); and the non-transitory computer-readable storage medium or the memory 1630 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1630, executable by the processor 1620 in the computing environment 1610, for performing the above-described methods. For example, the computer program product may include the non-transitory computer-readable storage medium.

In an embodiment, the computing environment 1610 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

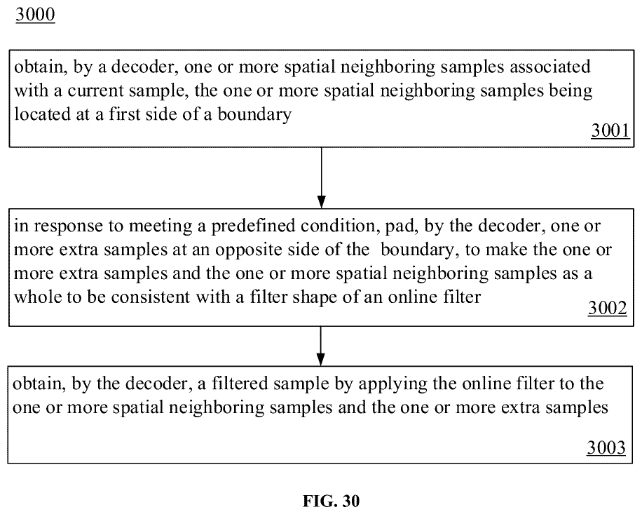

FIG. 30 is a flowchart illustrating a method for video decoding in accordance with some examples of the present disclosure. At step 3001, the method includes: obtaining, by a decoder, one or more spatial neighboring samples associated with a current sample, the one or more spatial neighboring samples being located at a first side of a boundary. At step 3002, the method includes: in response to meeting a predefined condition, padding, by the decoder, one or more extra samples at an opposite side of the boundary, to make the one or more extra samples and the one or more spatial neighboring samples as a whole to be consistent with a filter shape of an online filter. At step 3003, the method includes: obtaining, by the decoder, a filtered sample by applying the online filter to the one or more spatial neighboring samples and the one or more extra samples.

In an embodiment, padding, by the decoder, the one or more extra samples at the opposite side of the boundary includes: padding the one or more extra samples according to a first reference sample; wherein the first reference sample is a spatial neighboring sample located adjacent to the boundary and in a same column or a same row as each extra sample.

In an embodiment, padding the one or more extra samples according to the first reference sample includes: padding the one or more extra samples by making each extra sample equal to the first reference sample.

In an embodiment, the method further includes: modifying a spatial neighboring sample according to a second reference sample; wherein the second reference sample is a spatial neighboring sample located adjacent to a corresponding boundary, at a same boundary side of the corresponding boundary with the one or more extra samples, and in a same column or a same row as the spatial neighboring sample, and the corresponding boundary and the boundary are symmetrical about a center of a to-be-filtered area corresponding to the filter shape.

In an embodiment, modifying the spatial neighboring sample according to the second reference sample includes: modifying the spatial neighboring sample by making the spatial neighboring sample equal to the second reference sample.

In an embodiment, the one or more spatial neighboring samples are from at least one of: a prediction sample, a residual sample, a sample prior to sample adaptive offset (SAO) filtering, or a sample prior to deblocking.

In an embodiment, the boundary includes a virtual boundary, a line buffer boundary, a picture boundary, a slice boundary, or a tile boundary.

In an embodiment, the method further includes aligning, by the decoder, the filter shape of the online filter with the one or more spatial neighboring samples; wherein in response to meeting a predefined condition, padding, by the decoder, the one or more extra samples at the opposite side of the boundary includes: in response to determining that a filter shape of an online filter crosses the boundary, padding, by the decoder, the one or more extra samples at the opposite side of the boundary.

In an embodiment, aligning, by the decoder, the filter shape of the online filter with the one or more spatial neighboring samples comprises: aligning a central position of the filter shape with the one or more spatial neighboring samples.

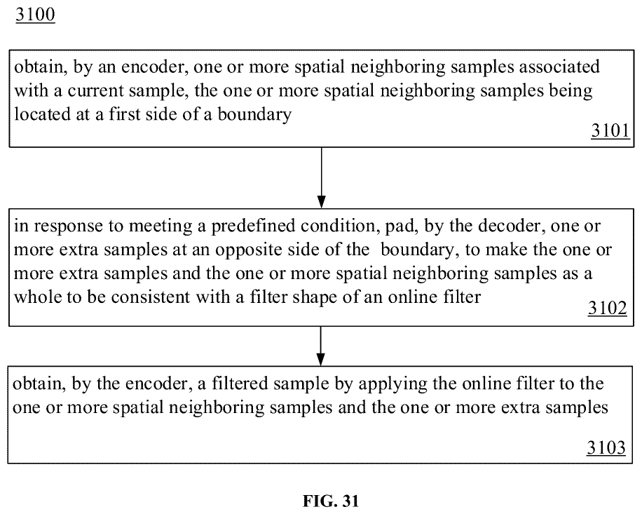

FIG. 31 is a flowchart illustrating a method for video encoding in accordance with some examples of the present disclosure. At step 3101, the method includes: obtaining, by an encoder, one or more spatial neighboring samples associated with a current sample, the one or more spatial neighboring samples being located at a first side of a boundary At step 3102, the method includes: in response to meeting a predefined condition, padding, by the encoder, one or more extra samples at an opposite side of the boundary, to make the one or more extra samples and the one or more spatial neighboring samples as a whole to be consistent with a filter shape of an online filter. At step 3103, the method includes: obtaining, by the encoder, a filtered sample by applying the online filter to the one or more spatial neighboring samples and the one or more extra samples.

In an embodiment, padding, by the encoder, the one or more extra samples at the opposite side of the boundary includes: padding the one or more extra samples according to a first reference sample; wherein the first reference sample is a spatial neighboring sample located adjacent to the boundary and in a same column or a same row as each extra sample.

In an embodiment, padding the one or more extra samples according to the first reference sample includes: padding the one or more extra samples by making each extra sample equal to the first reference sample.

In an embodiment, the method further includes: modifying a spatial neighboring sample according to a second reference sample; wherein the second reference sample is a spatial neighboring sample located adjacent to a corresponding boundary, at a same boundary side of the corresponding boundary with the one or more extra samples, and in a same column or a same row as the spatial neighboring sample, and the corresponding boundary and the boundary are symmetrical about a center of a to-be-filtered area corresponding to the filter shape.

In an embodiment, modifying the spatial neighboring sample according to the second reference sample includes: modifying the spatial neighboring sample by making the spatial neighboring sample equal to the second reference sample.

In an embodiment, the one or more spatial neighboring samples are from at least one of: a prediction sample, a residual sample, a sample prior to sample adaptive offset (SAO) filtering, or a sample prior to deblocking.

In an embodiment, the boundary includes a virtual boundary, a line buffer boundary, a picture boundary, a slice boundary, or a tile boundary.

In an embodiment, the method further includes aligning, by the encoder, the filter shape of the online filter with the one or more spatial neighboring samples; wherein in response to meeting a predefined condition, padding, by the encoder, the one or more extra samples at the opposite side of the boundary includes: in response to determining that a filter shape of an online filter crosses the boundary, padding, by the encoder, the one or more extra samples at the opposite side of the boundary.

In an embodiment, aligning, by the encoder, the filter shape of the online filter with the one or more spatial neighboring samples includes: aligning a central position of the filter shape with the one or more spatial neighboring samples.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

Various aspects of the present invention may be appreciated from the following Enumerated Example Embodiments (EEEs):

EEE 1. A method for video decoding, comprising: obtaining, by a decoder, one or more spatial neighboring samples associated with a current sample, wherein the one or more spatial neighboring samples are from at least one of prediction samples or reconstructed samples, and wherein the reconstructed samples are samples prior to sample adaptive offset (SAO) filtering; and obtaining, by the decoder and based on the one or more spatial neighboring samples, a filtered sample for the current sample.

EEE 2. The method of EEE 1, further comprising: obtaining, by the decoder, the filtered sample based on the one or more spatial neighboring samples and one or more filter coefficients, wherein the one or more filter coefficients are associated with different filter shapes.

EEE 3. The method of EEE 2, further comprising: obtaining, by the decoder, clipped difference based on the one or more spatial neighboring samples and the current sample; and obtaining, by the decoder, the filtered sample based on the clipped difference and the one or more filter coefficients.

EEE 4. The method of EEE 3, wherein the clipped difference comprises one of following difference: clipped difference between one or more surrounding samples and the current sample; or clipped difference between the one or more surrounding samples and a collocated sample, wherein the one or more surrounding samples and the collocated sample are from the one or more spatial neighboring samples.

EEE 5. The method of EEE 2, further comprising: obtaining, by the decoder, the one or more coefficients signaled by an encoder.

EEE 6. The method of EEE 1, further comprising: obtaining, by the decoder, one or more neighboring output samples after the SAO filtering, one or more fixed filter output samples, and one or more neighboring samples prior to deblocking filter (DBF); and obtaining, by the decoder and based on the one or more spatial neighboring samples including the one or more neighboring output samples after the SAO filtering, the one or more fixed filter output samples, and the one or more neighboring samples prior to the DBF, the filtered sample for the current sample.

EEE 7. A method for video encoding, comprising: obtaining, by an encoder, one or more spatial neighboring samples associated with a current sample, wherein the one or more spatial neighboring samples are from at least one of prediction samples or reconstructed samples, and wherein the reconstructed samples are samples prior to sample adaptive offset (SAO) filtering; and obtaining, by the encoder and based on the one or more spatial neighboring samples, a filtered sample for the current sample.

EEE 8. The method of EEE 7, further comprising: obtaining, by the encoder, the filtered sample based on the one or more spatial neighboring samples and one or more filter coefficients, wherein the one or more filter coefficients are associated with different filter shapes.

EEE 9. The method of EEE 8, further comprising: obtaining, by the encoder, clipped difference based on the one or more spatial neighboring samples and the current sample; and obtaining, by the encoder, the filtered sample based on the clipped difference and the one or more filter coefficients.

EEE 10. The method of EEE 9, wherein the clipped difference comprises one of following difference: clipped difference between one or more surrounding samples and the current sample; or clipped difference between the one or more surrounding samples and a collocated sample, wherein the one or more surrounding samples and the collocated sample are from the one or more spatial neighboring samples.

EEE 11. The method of EEE 8, further comprising: signaling, by the encoder, the one or more coefficients.

EEE 12. The method of EEE 7, further comprising: obtaining, by the encoder, one or more neighboring output samples after the SAO filtering, one or more fixed filter output samples, and one or more neighboring samples prior to deblocking filter (DBF); and obtaining, by the encoder and based on the one or more spatial neighboring samples including the one or more neighboring output samples after the SAO filtering, the one or more fixed filter output samples, and the one or more neighboring samples prior to the DBF, the filtered sample for the current sample.

EEE 13. A method for video decoding, comprising: obtaining, by a decoder, a first feature based on a first adaptive loop filter (ALF) classifier that is edge-based; obtaining, by the decoder, a second feature based on a second ALF classifier that is band-based; and deriving, by the decoder, a combined classifier for an online adaptive loop filter (ALF) based on the first feature and the second feature.

EEE 14. The method of EEE 13, further comprising: obtaining, by the decoder, the first feature based on the first ALF classifier by computing directionality of a sub-block of a luma component and obtaining a total number of the directionality; and obtaining, by the decoder, the second feature based on the second ALF classifier by calculating a sum of sample values of the sub-block and calculating an index referring to the second ALF classifier.

EEE 15. The method of EEE 13, further comprising: obtaining, by the decoder, the first feature based on the first ALF classifier by computing an activity value of a sub-block of a luma component and obtaining a total number of the activity value; and obtaining, by the decoder, the second feature based on the second ALF classifier by calculating a sum of sample values of the sub-block and calculating an index referring to the second ALF classifier.

EEE 16. The method of EEE 13, further comprising: obtaining, by the decoder, the first feature based on the first ALF classifier by computing an index of a sub-block of a luma component referring to the first ALF classifier and obtaining a total number of the index; and obtaining, by the decoder, the second feature based on the second ALF classifier by calculating a sum of sample values of the sub-block and calculating an index referring to the second ALF classifier.

EEE 17. A method for video encoding, comprising: obtaining, by an encoder, a first feature based on a first adaptive loop filter (ALF) classifier that is edge-based; obtaining, by the encoder, a second feature based on a second ALF classifier that is band-based; and deriving, by the encoder, a combined classifier for an online adaptive loop filter (ALF) based on the first feature and the second feature.

EEE 18. The method of EEE 17, further comprising: obtaining, by the encoder, the first feature based on the first ALF classifier by computing directionality of a sub-block of a luma component and obtaining a total number of the directionality; and obtaining, by the encoder, the second feature based on the second ALF classifier by calculating a sum of sample values of the sub-block and calculating an index referring to the second ALF classifier.

EEE 19. The method of EEE 17, further comprising: obtaining, by the encoder, the first feature based on the first ALF classifier by computing an activity value of a sub-block of a luma component and obtaining a total number of the activity value; and obtaining, by the encoder, the second feature based on the second ALF classifier by calculating a sum of sample values of the sub-block and calculating an index referring to the second ALF classifier.

EEE 20. The method of EEE 17, further comprising: obtaining, by the encoder, the first feature based on the first ALF classifier by computing an index of a sub-block of a luma component referring to the first ALF classifier and obtaining a total number of the index; and obtaining, by the encoder, the second feature based on the second ALF classifier by calculating a sum of sample values of the sub-block and calculating an index referring to the second ALF classifier.

EEE 21. A method for video decoding, comprising: obtaining, by a decoder, a bitstream from an encoder; and adjusting, by the decoder, a chroma adaptive loop filter (ALF) shape associated with the bitstream based on a luma ALF shape associated with the bitstream.

EEE 22. The method of EEE 22, further comprising: adjusting, by the decoder, the chroma ALF shape associated with the bitstream by changing the chroma ALF shape from a diamond shape to a long cross shape, wherein the luma ALF shape is the long cross shape.

EEE 23. A method for video encoding, comprising: signaling, by an encoder, a syntax element that indicates a luma adaptive loop filter (ALF) in a bitstream; and adjusting, by the encoder, a chroma ALF shape associated with the bitstream based on the luma ALF shape.

EEE 24. The method of EEE 22, further comprising: adjusting, by the encoder, the chroma ALF shape associated with the bitstream by changing the chroma ALF shape from a diamond shape to a long cross shape, wherein the luma ALF shape is the long cross shape.

EEE 25. An apparatus for video decoding, comprising: one or more processors; and a memory coupled to the one or more processors and configured to store instructions executable by the one or more processors, wherein the one or more processors, upon execution of the instructions, are configured to perform the method in any one of EEE 1-6, 13-16, and 21-22.

EEE 26. An apparatus for video encoding, comprising: one or more processors; and a memory coupled to the one or more processors and configured to store instructions executable by the one or more processors, wherein the one or more processors, upon execution of the instructions, are configured to perform the method in any one of EEE 7-12, 17-20, and 23-24.

EEE 27. A non-transitory computer-readable storage medium for storing computer-executable instructions that, when executed by one or more computer processors, cause the one or more computer processors to receive a bitstream, and perform the method in any of EEE 1-6, 13-16, and 21-22 based on the bitstream.

EEE 28. A non-transitory computer-readable storage medium for storing computer-executable instructions that, when executed by one or more computer processors, cause the one or more computer processors to perform the method in any of EEE 7-12, 17-20, and 23-24 to encode the current sample into a bitstream, and transmit the bitstream.

EEE 29. A non-transitory computer-readable storage medium for storing a bitstream to be decoded by the method in any of EEE 1-6, 13-16, and 21-22.

EEE 30. A non-transitory computer-readable storage medium for storing a bitstream generated by the method in any of EEE 7-12, 17-20, and 23-24.

EEE 31. A method for video decoding, comprising: obtaining, by a decoder, one or more spatial neighboring samples associated with a current chroma sample, wherein the one or more spatial neighboring samples are from at least one of following signals: (i) a chroma prediction signal, (ii) a chroma residual signal, (iii) a pre-chroma sample adaptive offset (SAO) signal, or (iv) a pre-chroma deblocking signal; and obtaining, by the decoder, a filtered chroma sample, based on the one or more spatial neighboring samples associated with the current chroma sample.

EEE 32. The method for video decoding of EEE 31, further comprising: obtaining, by the decoder, an adaptive loop filter (ALF) filtered chroma sample based on the one or more spatial neighboring samples associated with the chroma prediction signal and one or more filter coefficients, wherein the one or more filter coefficients are associated with different filter shapes.

EEE 33. The method for video decoding of EEE 32, further comprising: obtaining, by the decoder, clipped results based on differences between one or more spatial neighboring samples from the chroma prediction signal and the current chroma sample; and deriving, by the decoder, a chroma ALF input based on the clipped results.

EEE 34. The method for video decoding of EEE 32, further comprising: obtaining, by the decoder, clipped results based on differences between surrounding samples in the chroma prediction signal and collocated samples in the chroma prediction signal, and clipped results based on differences between collocated samples in chroma prediction signal and current chroma sample; and deriving, by the decoder, a chroma ALF input based on the clipped results.

EEE 35. The method for video decoding of EEE 31, further comprising: obtaining, by the decoder, an adaptive loop filter (ALF) filtered chroma sample based on the one or more spatial neighboring samples associated with the chroma residual signal and one or more filter coefficients, wherein the one or more filter coefficients are associated with different filter shapes.

EEE 36. The method for video decoding of EEE 35, further comprising: obtaining, by the decoder, clipped results of one or more spatial neighboring samples in the chroma residual signal; and deriving, by the decoder, a chroma ALF input based on the clipped results.

EEE 37. The method for video decoding of EEE 31, further comprising: obtaining, by the decoder, an adaptive loop filter (ALF) filtered chroma sample based on the one or more spatial neighboring samples associated with the pre-chroma SAO signal and one or more filter coefficients, wherein the one or more filter coefficients are associated with different filter shapes.

EEE 38. The method for video decoding of EEE 37, further comprising: obtaining, by the decoder, clipped results based on differences between one or more spatial neighboring samples from the pre-chroma SAO signal and the current chroma sample; and deriving, by the decoder, a chroma ALF input based on the clipped results.

EEE 39. The method for video decoding of EEE 37, further comprising: obtaining, by the decoder, clipped results based on differences between surrounding samples from the pre-chroma SAO signal and collocated samples from the pre-chroma SAO signal, and clipped results based on differences between collocated samples in pre-chroma SAO signal and current chroma sample; and deriving, by the decoder, a chroma ALF input based on the clipped results.

EEE 40. The method for video decoding of EEE 31, further comprising: obtaining, by the decoder, an adaptive loop filter (ALF) filtered chroma sample based on the one or more spatial neighboring samples associated with the pre-chroma deblocking signal and one or more filter coefficients, wherein the one or more filter coefficients are associated with different filter shapes.

EEE 41. The method for video decoding of EEE 40, further comprising: obtaining, by the decoder, clipped results based on differences between one or more spatial neighboring samples in the pre-chroma deblocking signal and the current chroma sample; and deriving, by the decoder, a chroma ALF input based on the clipped results

EEE 42. The method for video decoding of EEE 40, further comprising: obtaining, by the decoder, clipped results based on differences between one or more spatial neighboring samples from the pre-chroma deblocking signal and collocated samples from the pre-chroma deblocking signal, and clipped results based on differences between collocated samples in pre-chroma deblocking signal and current chroma sample; and deriving, by the decoder, a chroma ALF input based on the clipped results.

EEE 43. The method for video decoding of EEE 31, wherein one or more surrounding samples are from a combination of following signals: (i) the chroma prediction signal, (ii) the chroma residual signal, (iii) the pre-chroma sample adaptive offset (SAO) signal, or (iv) the pre-chroma deblocking signal.

EEE 44. A method for video encoding, comprising: obtaining, by an encoder, one or more spatial neighboring samples associated with a current chroma sample, wherein the one or more spatial neighboring samples are from a chroma sample, wherein the one or more spatial neighboring samples are from at least one of following signals: (i) a chroma prediction signal (ii) a chroma residual signal (iii) a pre-chroma sample adaptive offset (SAO) signal, or (iv) a pre-chroma deblocking signal; and obtaining, by the encoder, a filtered chroma sample, based on the one or more spatial neighboring samples associated with the current chroma sample.

EEE 45. The method for video encoding of EEE 44, further comprising: obtaining, by the encoder, an adaptive loop filter (ALF) filtered chroma sample based on the one or more spatial neighboring samples associated with the chroma prediction signal and one or more filter coefficients, wherein the one or more filter coefficients are associated with different filter shapes.

EEE 46. The method for video encoding of EEE 45, further comprising: obtaining, by the encoder, clipped results based on differences between one or more spatial neighboring samples in the chroma prediction signal and the current chroma sample; and deriving, by the encoder, a chroma ALF input based on the clipped results.

EEE 47. The method for video encoding of EEE 45, further comprising: obtaining, by the encoder, clipped results based on differences between surrounding samples in the chroma prediction signal and collocated samples in the chroma prediction signal, and clipped results based on differences between collocated samples in chroma prediction signal and current chroma sample; and deriving, by the encoder, a chroma ALFinput based on the clipped results.

EEE 48. The method for video encoding of EEE 44, further comprising: obtaining, by the encoder, an adaptive loop filter (ALF) filtered chroma sample based on the one or more spatial neighboring samples associated with the chroma residual signal and one or more filter coefficients, wherein the one or more filter coefficients are associated with different filter shapes.

EEE 49. The method for video encoding of EEE 48, further comprising: obtaining, by the encoder, clipped results of one or more spatial neighboring samples from the chroma residual signal; and deriving, by the encoder, a chroma ALF input based on the clipped results.

EEE 50. The method for video encoding of EEE 44, further comprising: obtaining, by the encoder, an adaptive loop filter (ALF) filtered chroma sample based on the one or more spatial neighboring samples associated with the pre-chroma SAO signal and one or more filter coefficients, wherein the one or more filter coefficients are associated with different filter shapes.

EEE 51. The method for video encoding of EEE 50, further comprising: obtaining, by the encoder, clipped results based on differences between one or more spatial neighboring samples from the pre-chroma SAO signal and the current chroma sample; and deriving, by the encoder, a chroma ALF input based on the clipped results.

EEE 52. The method for video encoding of EEE 50, further comprising: obtaining, by the encoder, clipped results based on differences between surrounding samples from the pre-chroma SAO signal and collocated samples from the pre-chroma SAO signal, and clipped results based on differences between collocated samples in pre-chroma SAO signal and current chroma sample; and deriving, by the encoder, a chroma ALF input based on the clipped results.

EEE 53. The method for video encoding of EEE 44, further comprising: obtaining, by the encoder, an adaptive loop filter (ALF) filtered chroma sample based on the one or more spatial neighboring samples associated with the pre-chroma deblocking signal and one or more filter coefficients, wherein the one or more filter coefficients are associated with different filter shapes.

EEE 54. The method for video encoding of EEE 53, further comprising: obtaining, by the encoder, clipped results based on differences between one or more spatial neighboring samples in the pre-chroma deblocking signal and the current chroma sample; and deriving, by the encoder, a chroma ALF input based on the clipped results.

EEE 55. The method for video encoding of EEE 53, further comprising: obtaining, by the encoder, clipped results based on differences between one or more spatial neighboring samples in the pre-chroma deblocking signal and collocated samples in pre-chroma deblocking signal, and clipped results based on differences between collocated samples in pre-chroma deblocking signal and current chroma sample; and deriving, by the encoder, a chroma ALF input based on the clipped results.

EEE 56. The method for video encoding of EEE 44, wherein one or more surrounding samples are from a combination of following signals: (i) the chroma prediction signal, (ii) the chroma residual signal, (iii) the pre-chroma SAO signal, or (iv) the pre-chroma deblocking signal.

EEE 57. A method for video decoding, comprising: obtaining, by a decoder, one or more spatial neighboring samples associated with a current chroma sample, wherein the one or more spatial neighboring samples are from at least one of following signals: (i) a luma prediction signal, (ii) a luma residual signal, (iii) a pre-luma sample adaptive offset (SAO) signal, or (iv) a pre-luma deblocking signal; and obtaining, by the decoder, a filtered chroma sample, based on the one or more spatial neighboring samples associated with the current chroma sample.

EEE 58. The method for video decoding of EEE 57, further comprising: obtaining, by the decoder, a cross-component adaptive loop filter (CCALF) filtered chroma sample based on the one or more spatial neighboring samples associated with the luma prediction signal and one or more filter coefficients, wherein the one or more filter coefficients are associated with different filter shapes.

EEE 59. The method for video decoding of EEE 58, further comprising: obtaining, by the decoder, clipped results based on differences between one or more spatial neighboring samples from the luma prediction signal and the current corresponding luma sample; and deriving, by the decoder, the CCALF input based on the clipped results.

EEE 60. The method for video decoding of EEE 58, further comprising: obtaining, by the decoder, clipped results based on differences between surrounding samples in the luma prediction signal and collocated samples in the luma prediction signal, and clipped results based on differences between collocated samples in the luma prediction signal and current corresponding luma sample; and deriving, by the decoder, the CCALF input based on the clipped results.

EEE 61. The method for video decoding of EEE 57, comprising: obtaining, by the decoder, a cross-component adaptive loop filter (CCALF) filtered chroma sample based on the one or more spatial neighboring samples associated with the luma residual signal and one or more filter coefficients, wherein the one or more filter coefficients are associated with different filter shapes.

EEE 62. The method for video decoding of EEE 61, further comprising: obtaining, by the decoder, clipped results of one or more spatial neighboring samples in the luma residual signal; and deriving, by the decoder, the CCALF input based on the clipped results.

EEE 63. The method for video decoding of EEE 57, comprising: obtaining, by the decoder, a cross-component adaptive loop filter (CCALF) filtered chroma sample based on the one or more spatial neighboring samples associated with the pre-luma SAO signal and one or more filter coefficients, wherein the one or more filter coefficients are associated with different filter shapes.

EEE 64. The method for video decoding of EEE 63, further comprising: obtaining, by the decoder, clipped results based on differences between one or more spatial neighboring samples in the pre-luma SAO signal and the current corresponding luma sample; and deriving, by the decoder, the CCALF input based on the clipped results.

EEE 65. The method for video decoding of EEE 63, further comprising: obtaining, by the decoder, clipped results based on differences between surrounding samples from the pre-luma SAO signal and collocated samples from the pre-luma SAO signal, and clipped results based on differences between collocated samples in the pre-luma SAO signal and current corresponding luma sample; and deriving, by the decoder, the CCALF input based on the clipped results.

EEE 66. The method for video decoding of EEE 57, comprising: obtaining, by the decoder, a cross-component adaptive loop filter (CCALF) filtered chroma sample based on the one or more spatial neighboring samples associated with the pre-luma deblocking signal and one or more filter coefficients, wherein the one or more filter coefficients are associated with different filter shapes.

EEE 67. The method for video decoding of EEE 66, further comprising: obtaining, by the decoder, clipped results based on differences between one or more spatial neighboring samples from the pre-luma deblocking signal and the current corresponding luma sample; and deriving, by the decoder, the CCALF input based on the clipped results.

EEE 68. The method for video decoding of EEE 66, further comprising: obtaining, by the decoder, clipped results based on differences between one or more spatial neighboring samples from the pre-luma deblocking signal and collocated samples from the pre-luma deblocking signal, and clipped results based on differences between collocated samples in the pre-luma deblocking signal and current corresponding luma sample; and deriving, by the decoder, the CCALF input based on the clipped results.

EEE 69. The method for video decoding of EEE 57, wherein one or more spatial neighboring samples are from a combination of following signals: (i) the luma prediction signal; (ii) the luma residual signal; (iii) the pre-luma SAO signal; or (iv) the pre-luma deblocking signal.

EEE 70. A method for video encoding, comprising: obtaining, by an encoder, one or more spatial neighboring samples associated with a current chroma sample, wherein the one or more spatial neighboring samples are from at least one of following signals: (i) a luma prediction signal, (ii) a luma residual signal, (iii) a pre-luma sample adaptive offset (SAO) signal, or (iv) a pre-luma deblocking signal; and obtaining, by the encoder, a filtered chroma sample, based on the one or more spatial neighboring samples associated with the current chroma sample.

EEE 71. The method for video encoding of EEE 70, further comprising: obtaining, by the encoder, a cross-component adaptive loop filter (CCALF) filtered chroma sample based on the one or more spatial neighboring samples associated with the luma prediction signal and one or more filter coefficients, wherein the one or more filter coefficients are associated with different filter shapes.

EEE 72. The method for video encoding of EEE 71, further comprising: obtaining, by the encoder, clipped results based on differences between one or more spatial neighboring samples from the luma prediction signal and the current corresponding luma sample; and deriving, by the encoder, the CCALF input based on the clipped results.

EEE 73. The method for video encoding of EEE 71, further comprising: obtaining, by the encoder, clipped results based on differences between surrounding samples the luma prediction signal and collocated samples in the luma prediction signal, and clipped results based on differences between collocated samples in the luma prediction signal and current corresponding luma sample; and deriving, by the encoder, the CCALF input based on the clipped results.

EEE 74. The method for video encoding of EEE 70, further comprising: obtaining, by the encoder, a cross-component adaptive loop filter (CCALF) filtered chroma sample based on the one or more spatial neighboring samples associated with the luma residual signal and one or more filter coefficients, wherein the one or more filter coefficients are associated with different filter shapes.

EEE 75. The method for video encoding of EEE 74, further comprising: obtaining, by the encoder, clipped results of one or more spatial neighboring samples from the luma residual signal; and deriving, by the encoder, the CCALF input based on the clipped results.

EEE 76. The method for video encoding of EEE 70, comprising: obtaining, by the encoder, a cross-component adaptive loop filter (CCALF) filtered chroma sample based on the one or more spatial neighboring samples associated with the pre-luma SAO signal and one or more filter coefficients, wherein the one or more filter coefficients are associated with different filter shapes.

EEE 77. The method for video encoding of EEE 76, further comprising: obtaining, by the encoder, clipped results based on differences between one or more spatial neighboring samples from the pre-luma SAO signal and the current corresponding luma sample; and deriving, by the encoder, the CCALF input based on the clipped results.

EEE 78. The method for video encoding of EEE 76, further comprising: obtaining, by the encoder, clipped results based on differences between surrounding samples from the pre-luma SAO signal and collocated samples from the pre-luma SAO signal, and clipped results based on differences between collocated samples in the pre-luma SAO signal and current corresponding luma sample; and deriving, by the encoder, the CCALF input based on the clipped results.

EEE 79. The method for video encoding of EEE 70, further comprising: obtaining, by the encoder, a cross-component adaptive loop filter (CCALF) filtered chroma sample based on the one or more spatial neighboring samples associated with the pre-luma deblocking signal and one or more filter coefficients, wherein the one or more filter coefficients are associated with different filter shapes.

EEE 80. The method for video encoding of EEE 79, further comprising: obtaining, by the encoder, clipped results based on differences between one or more spatial neighboring samples from the pre-luma deblocking signal and the current corresponding luma sample; and deriving, by the encoder, the CCALF input based on the clipped results.

EEE 81. The method for video encoding of EEE 79, further comprising: obtaining, by the encoder, clipped results based on differences between one or more spatial neighboring samples from the pre-luma deblocking signal and collocated samples from the pre-luma deblocking signal, and clipped results based on differences between collocated samples in the pre-luma deblocking signal and current corresponding luma sample; and deriving, by the encoder, the CCALF input based on the clipped results.

EEE 82. The method for video encoding of EEE 70, wherein one or more spatial neighboring samples are from a combination of following signals: (i) the luma prediction signal; (ii) the luma residual signal; (iii) the pre-luma SAO signal; or (iv) the pre-luma deblocking signal.

EEE 83. A method for video decoding, comprising: obtaining, by a decoder, coding information associated with a coding block, wherein the coding information includes a first flag indicating that the coding block is coded with a skip mode and a second flag indicating that the coding block is coded with at least one of the following modes: an intra mode, an inter P mode, or an inter B mode, to derive new classifiers for an online adaptive loop filter (ALF) process; and generating, by the decoder, a new classifier for the online adaptive ALF process based on the coding information.

EEE 84. The method for video decoding of EEE 83, further comprising: using the first flag to derive the new classifier for the online ALF process.

EEE 85. The method for video decoding of EEE 84, wherein the new classifier includes two classes corresponding to whether the coding block is coded with the skip mode.

EEE 86. The method for video decoding of EEE 84, wherein the new classifier combines skip mode information with at least one of: edge offset(EO) (edge-based classifier) information, or band offset (BO) (band-based classifier) information.

EEE 87. The method for video decoding of EEE 83, further comprising: recording, at the decoder, that the coding block is coded with at least one of following modes: (i) intra mode, (ii) inter P mode, or (iii) inter B mode; and generating, at the decoder, the new classifier for the online ALF process based on the recording.

EEE 88. The method for video decoding of EEE 87, wherein the new classifier includes three classes corresponding to the coding block is coded with intra mode, inter P mode, or inter B mode.

EEE 89. The method for video decoding of EEE 87, wherein the new classifier combines: information that the coding block is coded with at least one of: intra mode, inter P mode, or inter B mode, with at least one of: edge offset (EO) (edge based classifier) information, or band offset(BO) (band based classifier) information.

EEE 90. The method for video decoding of EEE 83, further comprising: determining, at the decoder, that whether the coding block is coded with skip mode; determining, at the decoder, that the coding block is coded with one of the following modes: (i) intra mode; (ii) inter P mode; or (iii) inter B mode; and generating, at the decoder, the new classifier based on the determined modes.

EEE 91. A method for video encoding, comprising: obtaining, by an encoder, coding information associated with a coding block, wherein the coding information includes information whether the coding block is coded with a skip mode and information that the coding block is coded with at least one of the following: an intra mode, an inter P mode, or an inter B mode, to derive new classifiers for an online adaptive loop filter (ALF) process; and generating, by the encoder, a new classifier for the online ALF process based on the coding information.

EEE 92. The method for video encoding of EEE 91, wherein whether the coding block is coded with the skip mode during an encoding process is utilized to derive the new classifier for the online ALF process.

EEE 93. The method for video encoding of EEE 92, wherein the new classifier includes two classes corresponding to whether the coding block is coded with the skip mode.

EEE 94. The method for video encoding of EEE 92, wherein the new classifier combines skip mode information with edge offset (EO) (edge based classifier) information or band offset (BO) (band based classifier) information.

EEE 95. The method for video encoding of EEE 91, further comprising: recording, at the encoder, that the coding block is coded with at least one of: (i) intra mode, (ii) inter P mode, or (iii) inter B mode; and generating, by the encoder, the new classifier for the online ALF process based on the recording.

EEE 96. The method for video encoding of EEE 95, wherein the new classifier includes three classes corresponding to the coding block is coded with intra mode, inter P mode, or inter B mode.

EEE 97. The method for video encoding of EEE 95, wherein the new classifier combines: information that the coding block is coded with at least one of: intra mode, inter P mode, or inter B mode, with at least one of: edge offset (EO) (edge based classifier) information, or (BO) (band based classifier) information.

EEE 98. The method for video encoding of EEE 95, further comprising: determining, at the encoder, whether the coding block is coded with skip mode; determining, at the encoder, that the coding block is coded with one of the following modes: (i) intra mode; (ii) inter P mode; or (iv) inter B mode; and generating the new classifier based on the modes.

EEE 99. An apparatus for video decoding, comprising: one or more processors; and a memory coupled to the one or more processors and configured to store instructions executable by the one or more processors, wherein the one or more processors, upon execution of the instructions are configured to perform a method in any one of EEE: 31-43, 57-69, and 83-90.

EEE 100. An apparatus for video encoding, comprising: one or more processors; and a memory coupled to the one or more processors and configured to store instructions executable by the one or more processors, wherein the one or more processors, upon execution of the instructions are configured to perform a method in any one of EEE: 44-56, 70-82, and 91-98.

EEE 101. A non-transitory computer readable storage medium for storing computer-executable instructions that, when executed by one or more computer processors, cause the one or more computer processors to receive a bitstream and perform a method in any one of EEE: 31-43, 57-69, and 83-90.

EEE 102. A non-transitory computer readable storage medium for storing computer-executable instructions that, when executed by one or more computer processors, cause the one or more computer processors to perform a method in any one of EEE: 44-56, 70-82, and 91-98 to generate and transmit a bitstream.

EEE 103. A bitstream to be decoded by a decoding method in any one of EEE: 31-43, 57-69, and 83-90.

EEE 104. A bitstream generated by an encoding method in any one of EEE 44-56, 70-82, and 91-98.

EEE 105. A method for video decoding, comprising: obtaining, by a decoder, one or more spatial neighboring samples associated with a current sample, the one or more spatial neighboring samples being located at a first side of a boundary; in response to meeting a predefined condition, padding, by the decoder, one or more extra samples at an opposite side of the boundary, to make the one or more extra samples and the one or more spatial neighboring samples as a whole to be consistent with a filter shape of an online filter; and obtaining, by the decoder, a filtered sample by applying the online filter to the one or more spatial neighboring samples and the one or more extra samples.

EEE 106. The method of EEE 105, wherein padding, by the decoder, the one or more extra samples at the opposite side of the boundary comprises: padding the one or more extra samples according to a first reference sample; wherein the first reference sample is a spatial neighboring sample located adjacent to the boundary and in a same column or a same row as each extra sample.

EEE 107. The method of EEE 106, wherein padding the one or more extra samples according to the first reference sample comprises: padding the one or more extra samples by making each extra sample equal to the first reference sample.

EEE 108. The method of EEE 106, further comprising: modifying a spatial neighboring sample according to a second reference sample; wherein the second reference sample is a spatial neighboring sample located adjacent to a corresponding boundary, at a same boundary side of the corresponding boundary with the one or more extra samples, and in a same column or a same row as the spatial neighboring sample, and the corresponding boundary and the boundary are symmetrical about a center of a to-be-filtered area corresponding to the filter shape.

EEE 109. The method of EEE 108, wherein modifying the spatial neighboring sample according to the second reference sample comprises: modifying the spatial neighboring sample by making the spatial neighboring sample equal to the second reference sample.

EEE 110. The method of EEE 105, wherein the one or more spatial neighboring samples are from at least one of: a prediction sample, a residual sample, a sample prior to sample adaptive offset (SAO) filtering, or a sample prior to deblocking.

EEE 111. The method of EEE 105, wherein the boundary comprises a virtual boundary, a line buffer boundary, a picture boundary, a slice boundary, or a tile boundary.

EEE 112. The method of EEE 105, further comprising: aligning, by the decoder, the filter shape of the online filter with the one or more spatial neighboring samples; wherein in response to meeting the predefined condition, padding, by the decoder, the one or more extra samples at the opposite side of the boundary comprises: in response to determining that a filter shape of an online filter crosses the boundary, padding, by the decoder, the one or more extra samples at the opposite side of the boundary.

EEE 113. The method of EEE 112, wherein aligning, by the decoder, the filter shape of the online filter with the one or more spatial neighboring samples comprises: aligning a central position of the filter shape with the one or more spatial neighboring samples.

EEE 114. A method for video encoding, comprising: obtaining, by an encoder, one or more spatial neighboring samples associated with a current sample, the one or more spatial neighboring samples being located at a first side of a boundary; in response to meeting a predefined condition, padding, by the encoder, one or more extra samples at an opposite side of the boundary, to make the one or more extra samples and the one or more spatial neighboring samples as a whole to be consistent with a filter shape of an online filter; and obtaining, by the encoder, a filtered sample by applying the online filter to the one or more spatial neighboring samples and the one or more extra samples.

EEE 115. The method of EEE 114, wherein padding, by the encoder, the one or more extra samples at the opposite side of the boundary comprises: padding the one or more extra samples according to a first reference sample; wherein the first reference sample is a spatial neighboring sample located adjacent to the boundary and in a same column or a same row as each extra sample.

EEE 116. The method of EEE 115, wherein padding the one or more extra samples according to the first reference sample comprises: padding the one or more extra samples by making each extra sample equal to the first reference sample.

EEE 117. The method of EEE 115, further comprising: modifying a spatial neighboring sample according to a second reference sample; wherein the second reference sample is a spatial neighboring sample located adjacent to a corresponding boundary, at a same boundary side of the corresponding boundary with the one or more extra samples, and in a same column or a same row as the spatial neighboring sample, and the corresponding boundary and the boundary are symmetrical about a center of a to-be-filtered area corresponding to the filter shape.

EEE 118. The method of EEE 117, wherein modifying the spatial neighboring sample according to the second reference sample comprises: modifying the spatial neighboring sample by making the spatial neighboring sample equal to the second reference sample.

EEE 119. The method of EEE 114, wherein the one or more spatial neighboring samples are from at least one of: a prediction sample, a residual sample, a sample prior to sample adaptive offset (SAO) filtering, or a sample prior to deblocking.

EEE 120. The method of EEE 114, wherein the boundary comprises a virtual boundary, a line buffer boundary, a picture boundary, a slice boundary, or a tile boundary.

EEE 121. The method of EEE 114, further comprising: aligning, by the encoder, the filter shape of the online filter with the one or more spatial neighboring samples; wherein in response to meeting a predefined condition, padding, by the encoder, the one or more extra samples at the opposite side of the boundary comprises: in response to determining that a filter shape of an online filter crosses the boundary, padding, by the encoder, the one or more extra samples at the opposite side of the boundary.

EEE 122. The method of EEE 121, wherein aligning, by the encoder, the filter shape of the online filter with the one or more spatial neighboring samples comprises: aligning a central position of the filter shape with the one or more spatial neighboring samples.

EEE 123. An apparatus for video decoding, comprising: one or more processors; and a memory coupled to the one or more processors and configured to store instructions executable by the one or more processors, wherein the one or more processors, upon execution of the instructions, are configured to perform the method in any one of EEE 105-113.

EEE 124. A non-transitory computer-readable storage medium for storing computer-executable instructions that, when executed by one or more computer processors, cause the one or more computer processors to perform the method in any of EEE 105-113.

EEE 125. An apparatus for video encoding, comprising: one or more processors; and a memory coupled to the one or more processors and configured to store instructions executable by the one or more processors, wherein the one or more processors, upon execution of the instructions, are configured to perform the method in any one of EEE 114-122.

EEE 126. A non-transitory computer-readable storage medium for storing computer-executable instructions that, when executed by one or more computer processors, cause the one or more computer processors to perform the method in any of EEE 114-122.

EEE 127. A non-transitory computer-readable storage medium for storing a bitstream to be decoded by the method in any of EEE 105-113.

EEE 128. A non-transitory computer-readable storage medium for storing a bitstream generated by the method in any of EEE 114-122.

What is claimed is:

1. A method for video decoding, comprising:
obtaining, by a decoder, one or more spatial neighboring samples associated with a current sample; and
obtaining, by the decoder and based on the one or more spatial neighboring samples, a filtered sample for the current sample.

2. The method of claim 1, wherein the one or more spatial neighboring samples are from at least one of prediction samples or reconstructed samples, and wherein the reconstructed samples are samples prior to sample adaptive offset (SAO) filtering.

3. The method of claim 2, further comprising:
obtaining, by the decoder, the filtered sample based on the one or more spatial neighboring samples and one or more filter coefficients, wherein the one or more filter coefficients are associated with different filter shapes.

4. The method of claim 3, further comprising:
obtaining, by the decoder, clipped difference based on the one or more spatial neighboring samples and the current sample; and
obtaining, by the decoder, the filtered sample based on the clipped difference and the one or more filter coefficients.

5. The method of claim 4, wherein the clipped difference comprises:
clipped difference between one or more surrounding samples and the current sample; or
clipped difference between the one or more surrounding samples and a collocated sample, wherein the one or more surrounding samples and the collocated sample are from the one or more spatial neighboring samples.

6. The method of claim 2, further comprising:
obtaining, by the decoder, one or more neighboring output samples after the SAO filtering, one or more fixed filter output samples, and one or more neighboring samples prior to deblocking filter (DBF); and
obtaining, by the decoder and based on the one or more spatial neighboring samples including the one or more neighboring output samples after the SAO filtering, the one or more fixed filter output samples, and the one or more neighboring samples prior to the DBF, the filtered sample for the current sample.

7. The method of claim 1, further comprising:
obtaining, by the decoder, a first feature based on a first adaptive loop filter (ALF) classifier that is edge-based;
obtaining, by the decoder, a second feature based on a second ALF classifier that is band-based; and
deriving, by the decoder, a combined classifier for an online adaptive loop filter (ALF) based on the first feature and the second feature.

8. The method of claim 1, further comprising:
obtaining, by the decoder, a bitstream from an encoder; and
adjusting, by the decoder, a chroma adaptive loop filter (ALF) shape associated with the bitstream based on a luma ALF shape associated with the bitstream.

9. The method of claim 1, wherein the current sample is a current chroma sample, and
the one or more spatial neighboring samples are from at least one of following signals: (i) a chroma prediction signal, (ii) a chroma residual signal, (iii) a pre-chroma sample adaptive offset (SAO) signal, or (iv) a pre-chroma deblocking signal, or
at least one of following signals: (i) a luma prediction signal, (ii) a luma residual signal, (iii) a pre-luma sample adaptive offset (SAO) signal, or (iv) a pre-luma deblocking signal.

10. The method of claim 1, further comprising:
obtaining, by the decoder, coding information associated with a coding block, wherein the coding information includes a first flag indicating that the coding block is coded with a skip mode and a second flag indicating that the coding block is coded with at least one of the following modes: an intra mode, an inter P mode, or an inter B mode, to derive new classifiers for an online adaptive loop filter (ALF) process; and
generating, by the decoder, a new classifier for the online adaptive ALF process based on the coding information.

11. The method of claim 10, further comprising:
determining, at the decoder, that whether the coding block is coded with skip mode;
determining, at the decoder, that the coding block is coded with one of the following modes: (i) intra mode; (ii) inter P mode; or (iii) inter B mode; and
generating, at the decoder, the new classifier based on the determined modes.

12. The method of claim 1, wherein the one or more spatial neighboring samples are located at a first side of a boundary, and the method further comprises:
in response to meeting a predefined condition, padding, by the decoder, one or more extra samples at an opposite side of the boundary, to make the one or more extra samples and the one or more spatial neighboring samples as a whole to be consistent with a filter shape of an online filter; and
obtaining, by the decoder, the filtered sample by applying the online filter to the one or more spatial neighboring samples and the one or more extra samples.

13. An apparatus for video decoding, comprising:
one or more processors; and
a memory coupled to the one or more processors and configured to store instructions executable by the one or more processors,
wherein the one or more processors, upon execution of the instructions, are configured to perform operations comprising:
obtaining, by a decoder, one or more spatial neighboring samples associated with a current sample; and
obtaining, by the decoder and based on the one or more spatial neighboring samples, a filtered sample for the current sample.

14. The apparatus of claim 13, wherein the one or more spatial neighboring samples are from at least one of prediction samples or reconstructed samples, and wherein the reconstructed samples are samples prior to sample adaptive offset (SAO) filtering.

15. The apparatus of claim 13, wherein the operations further comprise:
obtaining, by the decoder, a first feature based on a first adaptive loop filter (ALF) classifier that is edge-based;
obtaining, by the decoder, a second feature based on a second ALF classifier that is band-based; and
deriving, by the decoder, a combined classifier for an online adaptive loop filter (ALF) based on the first feature and the second feature.

16. The apparatus of claim 13, wherein the operations further comprise:
obtaining, by the decoder, a bitstream from an encoder; and
adjusting, by the decoder, a chroma adaptive loop filter (ALF) shape associated with the bitstream based on a luma ALF shape associated with the bitstream.

17. The apparatus of claim 13, wherein the current sample is a current chroma sample, and
the one or more spatial neighboring samples are from at least one of following signals: (i) a chroma prediction signal, (ii) a chroma residual signal, (iii) a pre-chroma sample adaptive offset (SAO) signal, or (iv) a pre-chroma deblocking signal, or
at least one of following signals: (i) a luma prediction signal, (ii) a luma residual signal, (iii) a pre-luma sample adaptive offset (SAO) signal, or (iv) a pre-luma deblocking signal.

18. The apparatus of claim 13, wherein the operations further comprise:
obtaining, by the decoder, coding information associated with a coding block, wherein the coding information includes a first flag indicating that the coding block is coded with a skip mode and a second flag indicating that the coding block is coded with at least one of the following modes: an intra mode, an inter P mode, or an inter B mode, to derive new classifiers for an online adaptive loop filter (ALF) process; and
generating, by the decoder, a new classifier for the online adaptive ALF process based on the coding information.

19. The apparatus of claim 13, wherein the one or more spatial neighboring samples are located at a first side of a boundary, and the operations further comprise:
in response to meeting a predefined condition, padding, by the decoder, one or more extra samples at an opposite side of the boundary, to make the one or more extra samples and the one or more spatial neighboring samples as a whole to be consistent with a filter shape of an online filter; and
obtaining, by the decoder, the filtered sample by applying the online filter to the one or more spatial neighboring samples and the one or more extra samples.

20. A non-transitory computer-readable storage medium storing a bitstream to be decoded by a decoding method comprising:
obtaining, by a decoder, one or more spatial neighboring samples associated with a current sample; and
obtaining, by the decoder and based on the one or more spatial neighboring samples, a filtered sample for the current sample.
